(19) United States
(12) Patent Application Publication
(10) Pub. No.: US 2013/0063407 A1
(43) Pub. Date: Mar. 14, 2013

(54) DISPLAY DEVICE

(71) Applicants: Naru Usukura, Osaka (JP); Yasuhiro Sugita, Osaka (JP); Kohei Tanaka, Osaka (JP); Hiromi Katoh, Osaka (JP); Tadashi Nemoto, Osaka (JP)

(72) Inventors: Naru Usukura, Osaka (JP); Yasuhiro Sugita, Osaka (JP); Kohei Tanaka, Osaka (JP); Hiromi Katoh, Osaka (JP); Tadashi Nemoto, Osaka (JP)

(73) Assignee: SHARP KABUSHIKI KAISHA, Osaka (JP)

(21) Appl. No.: 13/698,749

(22) PCT Filed: May 12, 2011
(86) PCT No.: PCT/JP2011/060921

§ 371 Date: Nov. 19, 2012

(30) Foreign Application Priority Data
May 20, 2010 (JP) 2010-116511

(51) Int. Cl. G06F 3/038

(52) U.S. Cl. 345/207

(57) ABSTRACT

Disclosed is a display device that can compensate for variations of light-detecting element while securing a wide dynamic range of light sensors. This is a display device equipped with light sensors having operation modes for one frame period, which are: a sensor driving mode for obtaining sensor signals, a first correction data acquisition mode for obtaining a first correction data, and a second correction data acquisition mode for obtaining a second correction data. This display device further includes a memory that stores light sensor signal levels obtained, under a controlled ambient environmental condition, by driving the light sensors in the above-mentioned three modes as offset elimination data. A signal-processing circuit uses the first correction data and the second correction data, and the light sensor signal level corrected with the offset elimination data to correct the light sensor signal obtained in the sensor driving mode.

### TECHNICAL FIELD

The present invention relates to a display device equipped with light sensors including a light-detecting element such as a photodiode. More particularly, the present invention relates to a display device equipped with light sensors disposed in the pixel region.

### BACKGROUND ART

Conventionally, display devices equipped with light sensors that can detect the brightness of external light and capture the image of an object in proximity to the display by including light-detecting elements such as photodiodes within pixels have been proposed. Such display devices equipped with light sensors are intended to be used as display devices for bidirectional communication and as display devices with a touch panel function.

In the case of conventional display devices equipped with light sensors, photodiodes and the like are formed on an active matrix substrate at the time when known constituting elements such as signal lines and scan lines, TFT (Thin Film Transistor), and pixel electrodes are formed on the active matrix substrate through semiconductor processes (see Japanese Patent Application Laid-Open Publication No. 2006-3857).

Also known is display devices equipped with light sensors in which a first light-detecting element that detects the intensity of the incoming light and a second light-detecting element for compensation are provided on an active matrix substrate to eliminate the influence of the light projected from the backlight light source (see Japanese Patent Application Laid-Open Publication No. 2009-134066). The display device disclosed in this publication includes a light-shielding film that overlaps a first light-detecting element on the lower side of the first light-detecting element, and a second light-detecting element that overlaps the light-shielding film on the lower side of the light-shielding film and is disposed such that it receives the light projected from the light source. Also, based on the intensity of the light projected from the light source determined by the second light-detecting element, the intensity of incoming light determined by the first light-detecting element, is subjected to compensation to eliminate the noise component detected due to the light from the light source.

The conventional display device disclosed in Japanese Patent Application Laid-Open Publication No. 2009-134066 can compensate for regular variations caused by external factors (temperature, light, aging, and the like), based on the light intensity determined by the second light-detecting element that is shielded from the light. However, these conventional display devices cannot compensate for variations of individual light-detecting elements. The conventional display devices also have a problem that the variation can be increased by taking the difference between the output of the first light-detecting element and the output of the second light-detecting element.

### SUMMARY OF THE INVENTION

The present invention was devised in consideration of the problems described above, and is aiming at providing a display device that can secure a wide dynamic range of the light sensors while compensating for the variation of the individual light-detecting elements.

The display device disclosed herein is a display device equipped with an active matrix substrate, including: light sensors provided in a pixel region of the active matrix substrate; a sensor driving wiring connected to the light sensors; a sensor driver circuit that supplies a sensor driver signal to the light sensors through the sensor driving wiring; an amplifier circuit that amplifies a signal read out from the light sensors when instructed by the sensor driving signal and outputs the signal as a light sensor signal; a signal-processing circuit that processes the light sensor signal outputted from the amplifier circuit; and a light source for the light sensors. The light sensors each has a first sensor pixel circuit that, when instructed by the sensor driving signal, accumulates electrical charges in accordance with the amount of light received during an accumulation period when the light source is ON, and outputs a sensor signal representing the accumulated charge when a reading-out period arrives; and a second sensor pixel circuit that, when instructed by the sensor driving signal, accumulates electrical charges in accordance with the amount of light received during an accumulation period when the light source is OFF, and outputs a sensor signal representing the accumulated charge when the reading-out period arrives. Operation modes of the sensor driver circuit during a single frame period are: a sensor driving mode for obtaining sensor signals from the first sensor pixel circuit and from the second sensor pixel circuit of the light sensor; a first correction data acquisition mode for obtaining a first correction data for correcting a sensor signal obtained from the first sensor pixel circuit, where a sensor driving signal that is different from the one used in the sensor driving mode is used; and a second correction data acquisition mode for obtaining a second correction data for correcting a sensor signal obtained from the second sensor pixel circuit, where a sensor driving signal that is different from the one used in the sensor driving mode is used. The accumulation period when the light source is ON in the first correction data acquisition mode is shorter than the accumulation period when the light source is ON in the sensor driving mode. The accumulation period when the light source is OFF in the second correction data acquisition mode is shorter than the accumulation period when the light source is OFF in the sensor driving mode. The display device further includes a memory that stores light sensor signal levels obtained, under a controlled ambient environmental condition, by driving the light sensors in the sensor driving mode, in the first correction data acquisition mode, and in the second correction data acquisition mode as offset elimination data for the light sensor signal level subjected to correction. Also, the signal-processing circuit uses the first and second correction data and the light sensor signal level subjected to correction corrected with the offset elimination data read out from the memory to correct the light sensor signal obtained in the sensor driving mode.

According to the present invention, a display device that can secure a wide dynamic range for light sensors while compensating for variations of individual light-detecting elements can be provided.

### BRIEF DESCRIPTION OF THE DRAWINGS

FIG. 1 is a block diagram showing the configuration of a display device according to an embodiment of the present invention.

FIG. 2 shows the arrangement of sensor pixel circuits included in the display device shown in FIG. 1.

FIG. 3 shows the backlight ON and OFF timings and the reset and the read-out timings of the sensor pixel circuit when the display device shown in FIG. 1 is driven.

FIG. 4 shows signal waveforms of the display panel when the display device shown in FIG. 1 is driven.

FIG. 5 schematically shows the configuration of a sensor pixel circuit included in the display device shown in FIG. 1.

FIG. 6 shows circuit diagrams of sensor pixel circuits according to Embodiment 1 of the present invention.

FIG. 7 shows a layout of the sensor pixel circuits shown in FIG. 6.

FIG. 8 shows the operation of the sensor pixel circuits shown in FIG. 6.

FIG. 9 shows signal waveforms of the sensor pixel circuits shown in FIG. 6.

FIG. 10 is a timing chart showing an example of the driving signal during one frame period in the sensor driving mode, an example of the driving signal during one frame period in the first correction data acquisition mode, and an example of the driving signal during one frame period in the second correction data acquisition mode.

FIG. 11 is a timing chart showing another example of the driving signal during one frame period in the sensor driving mode, another example of the driving signal during one frame period in the first correction data acquisition mode, and another example of the driving signal during one frame period in the second correction data acquisition mode.

FIG. 12 is a schematic cross-sectional view of a diode.

FIG. 13 shows the distribution of diodes in mode A, mode B, and mode C, presented in the relationship between the anode potential V_{A} and the potential V_{LS} of the light-shielding film LS.

FIG. 14A schematically shows the electrical charge distribution of a diode in the state of mode B.

FIG. 14B schematically shows the electrical charge distribution of a diode in the state of mode A.

FIG. 15 is a flowchart showing an example of the updating timing of the first correction data and the second correction data.

FIG. 16 is a flowchart showing an example of the updating timing of the first correction data and the second correction data.

FIG. 17 is a flowchart showing an example of the updating timing of the first correction data and the second correction data.

FIG. 18 is a flowchart showing an example of the updating timing of the first correction data and the second correction data.

FIG. 19 is a diagram of an equivalent circuit of the light-shielded reference pixel circuit included in the display device according to Embodiment 2.

FIG. 20 shows timing charts of the waveform of a reset signal supplied from a reset signal wiring RST to a light sensor and of the waveform of a read-out signal supplied from a read-out signal wiring RWS to a light sensor.

FIG. 21 is a block diagram schematically showing a compensating circuit included in the display device of Embodiment 2.

FIG. 22 is a waveform diagram showing an example of the read-out signal adjusted by the compensating circuit.

FIG. 23 is a signal waveform diagram showing the change in the V_{INT} potential when a high-level V_{RWS.H} potential of the read-out signal is V_{DDD} (broken line) and the change in the V_{INT} potential when a high-level V_{RWS.H} potential of the read-out signal is (V_{DDD}+α) (solid line).

FIG. 24A is an equivalent circuit diagram of the sensor pixel circuit included in the display device according to a modification of Embodiment 2.

FIG. 24B is an equivalent circuit diagram of the light-shielded reference pixel circuit included in the display device according to a modification of Embodiment 2.

FIG. 25 shows C-V characteristics of the variable capacitance C_{INT} of the light sensor according to a modification of Embodiment 2.

FIG. 26 is a waveform diagram showing the relationship between input signals (the reset signal and the read-out signal) and V_{INT} of the light sensor according to a modification of Embodiment 2.

FIG. 27 is a waveform diagram showing the change in the potential V_{INT} at the accumulation node during the time from the end of the accumulation period to the reading-out period.

FIG. 28A is a cross-sectional view showing the movement of electrical charges in a variable capacitance when the potential of the gate electrode is lower than the threshold voltage.

FIG. 28B is a cross-sectional view schematically showing the movement of electrical charges in the variable capacitance when the potential of the gate electrode is higher than the threshold voltage.

FIG. 29 is a block diagram schematically showing the configuration of a compensating circuit according to a modification of Embodiment 2.

FIG. 30 is a signal waveform diagram showing the change in V_{INT} potential before the adjustment by the compensating circuit (broken line), and the change in V_{INT} potential when the low-level V_{RWS.L} of the read-out signal is lowered by α (solid line).

FIG. 31 is a block diagram schematically showing the configuration of a compensating circuit included in the display device according to a modification of Embodiment 2.

FIG. 32 is a waveform diagram showing an example of the reset signal adjusted by the compensating circuit.

FIG. 33 is a signal waveform diagram showing the change in V_{INT} potential when the high-level V_{RST.H} potential of the reset signal is V_{SSS} (broken line), and the change in V_{INT} potential when the high-level V_{RST.H} potential of the reset signal is (V_{SSS}+α) (solid line).

FIG. 34 is an equivalent circuit diagram showing the configuration of the sensor pixel circuit according to a modification of Embodiment 2.

FIG. 35 is a timing chart showing the waveform of the reset signal supplied to the light sensor from the reset line RST and the waveform of the read-out signal supplied to the light sensor from the read-out line RWS in the display device according to a modification of Embodiment 2.

FIG. 36 is a waveform diagram showing the change in V_{INT} of a display device according to a modification of Embodiment 2.

FIG. 37 is an equivalent circuit diagram showing the configuration of the sensor pixel circuit included in a display device according to a modification of Embodiment 2.

FIG. 38 is a block diagram schematically showing the configuration of a compensating circuit according to a modification of Embodiment 2.

FIG. 39 is a signal waveform diagram showing the change in the V_{INT} potential before the adjustment of the reset level potential V_{REF} (broken line) and the change in the V_{INT} potential after the adjustment of the reset level potential V_{REF} by increasing the V_{REF} by α (solid line).

FIG. 40 is an equivalent circuit diagram showing the configuration of the sensor pixel circuit included in a display device according to a modification of Embodiment 2.

FIG. 41 is a signal waveform diagram showing the change in V_{INT} potential before the adjustment of the reset level potential V_{REF} (broken line) and the change in V_{INT} potential after the adjustment of the reset level potential V_{REF} (solid line) by increasing the V_{REF} by α.

FIG. 42 is a circuit diagram of a sensor pixel circuit according to Embodiment 3 of the present invention.

FIG. 43 is a layout diagram of the sensor pixel circuit shown in FIG. 42.

FIG. 44 shows the operation of the sensor pixel circuit shown in FIG. 42.

FIG. 45 shows signal waveform diagrams of the sensor pixel circuit shown in FIG. 42.

FIG. 46A is a circuit diagram of a sensor pixel circuit according to Modification 1 of Embodiments 1 and 2.

FIG. 46B is a circuit diagram of a sensor pixel circuit according to Modification 2 of Embodiments 1 and 2.

FIG. 46C is a circuit diagram of a sensor pixel circuit according to Modification 3 of Embodiments 1 and 2.

FIG. 46D is a circuit diagram of a sensor pixel circuit according to Modification 4 of Embodiments 1 and 2.

FIG. 46E is a circuit diagram of the sensor pixel circuit of Modification 5 of Embodiment 1 and of Modification 5 of Embodiment 2.

FIG. 47 shows the operation of the sensor pixel circuit shown in FIG. 46C.

FIG. 48 shows signal waveforms of the sensor pixel circuit shown in FIG. 46C.

FIG. 49 shows the operation of the sensor pixel circuit shown in FIG. 46D.

FIG. 50 shows the operation of the sensor pixel circuit shown in FIG. 46E.

FIG. 51A is a circuit diagram of the sensor pixel circuit of Modification 1 of Embodiment 3.

FIG. 51B is a circuit diagram of the sensor pixel circuit of Modification 2 of Embodiment 3.

FIG. 51C is a circuit diagram of the sensor pixel circuit of Modification 3 of Embodiment 3.

FIG. 51D is a circuit diagram of the sensor pixel circuit of Modification 4 of Embodiment 3.

FIG. 51E is a circuit diagram of the sensor pixel circuit of Modification 5 of Embodiment 3.

### DETAILED DESCRIPTION OF EMBODIMENTS

A display device according to an embodiment of the present invention is equipped with an active matrix substrate, including: light sensors provided in a pixel region of the active matrix substrate; a sensor driving wiring connected to the light sensors; a sensor driver circuit that supplies a sensor driving signal to the light sensors through the sensor driving wiring; an amplifier circuit that, when instructed by the sensor driving signal, amplifies the signal read out from the light sensors and outputs the signal as a light sensor signal; a signal-processing circuit that processes the light sensor signal outputted from the amplifier circuit; and a light source for the light sensors. The light sensors each has a first sensor pixel circuit that, when instructed by the sensor driving signal, accumulates electrical charges representing the amount of light received during an accumulation period when the light source is ON, and outputs a sensor signal representing the accumulated charge when a reading-out period arrives; and a second sensor pixel circuit that, when instructed by the sensor driving signal, accumulates electrical charges representing the amount of light received during an accumulation period when the light source is OFF, and outputs a sensor signal representing the accumulated charge when the reading-out period arrives. The accumulation period may also be referred to as integration period. Operation modes of the sensor driver circuit during a single frame period are: a sensor driving mode for obtaining the sensor signals from the first sensor pixel circuit and from the second sensor pixel circuit of the light sensor; a first correction data acquisition mode for obtaining a first correction data for correcting a sensor signal obtained from the first sensor pixel circuit, where a sensor driving signal that is different from the one used in the sensor driving mode is used; and a second correction data acquisition mode for obtaining the second correction data for correcting a sensor signal obtained from the second sensor pixel circuit, where a sensor driving signal that is different from the one used in the sensor driving mode is used. The accumulation period when the light source is ON in the first correction data acquisition mode is shorter than the accumulation period when the light source is ON in the sensor driving mode. The accumulation period when the light source is OFF in the second correction data acquisition mode is shorter than the accumulation period when the light source is OFF in the sensor driving mode. The display device further includes a memory that stores light sensor signal levels obtained, under a controlled ambient environmental condition, by driving the light sensor in the sensor driving mode, in the first correction data acquisition mode, and in the second correction data acquisition mode as offset elimination data for the light sensor signal levels subjected to correction. The signal-processing circuit uses the first correction data and the second correction data, and the light sensor signal level subjected to correction, which is corrected with the offset elimination data read out from the memory, to correct the light sensor signal obtained in the sensor driving mode. The configuration described above is hereinafter referred to as Configuration 1.

In Configuration 1, the display device may be configured such that the light sensor further includes a reference sensor having a light-shielding film added to the first sensor pixel circuit, and the display device may further include: an offset comparison circuit that determines the discrepancy level between a sensor signal outputted from the reference sensor and a standard offset value; and a driving signal generating circuit that adjusts the potential of the driving signal of the light sensor in accordance with the discrepancy level determined by the offset comparison circuit (Configuration 2).

In the Configuration 1 or in Configuration 2, the display device may further include a memory that temporarily stores the first correction data and the second correction data, and the display device may be configured such that the first correction data and the second correction data stored in the memory is updated in the first correction data acquisition mode and in the second correction data acquisition mode at least when the display device is turned ON, when the cycle of reading-out from the light sensor is changed, or when the ambient environment changes beyond a prescribed range (Configuration 3).

In Configuration 2, the display device may further include a memory that temporarily stores the first correction data and the second correction data, and the display device may be configured such that, at least when the display device is turned ON, when the cycle of reading-out from the light sensor is changed, or when the ambient environment changes beyond a prescribed range, the first correction data and the second correction data stored in the memory is updated in the first correction data acquisition mode and in the second correction data acquisition mode after the potential of the driving signal is adjusted by the offset comparison circuit and the driving signal generating circuit (Configuration 4).

In Configuration 2 or Configuration 4, the display device may be configured such that the light sensor includes: a light-receiving element; a capacitance that charges and discharges an output current from the light-receiving element; a switching element connected between one end of the light-receiving element and one end of the capacitance; a reset signal wiring that is connected to the other end of the light-receiving element and that supplies a reset signal; and a read-out signal wiring that is connected to the other end of the capacitance and that supplies a read-out signal, and the driving signal generating circuit adjusts at least either a high-level potential or a low-level potential of the read-out signal (Configuration 5).

In Configuration 2 or Configuration 4, the display device may be configured such that the light sensor includes: a light-receiving element; a capacitance that charges and discharges an output current from the light-receiving element; a switching circuit connected between one end of the light-receiving element and one end of the capacitance; a reset signal wiring that is connected to the other end of the light-receiving element and that supplies a reset signal; and a read-out signal wiring that supplies a read-out signal to the light sensor, and the driving signal generating circuit adjusts a high-level potential of the reset signal (Configuration 6).

In Configuration 6, the display device may be configured such that the switching circuit includes one transistor, and the read-out signal wiring is connected to the other end of the capacitance (Configuration 7).

In Configuration 6, the display device may be configured such that the switching circuit includes a first transistor and a second transistor, a control electrode of the first transistor is connected between one end of the light-receiving element and one end of the capacitance, one of two electrodes other than the control electrode of the first transistor is connected to a wiring that supplies a constant voltage, the other of the two electrodes other than the control electrode of the first transistor is connected to one of two electrodes other than a control electrode of a second transistor, the other of the two electrodes other than the control electrode of the second transistor is connected to an output wiring of the sensor signal, the read-out signal wiring is connected to the control electrode of the second transistor, and the other end of the capacitance is connected to a wiring that supplies a constant voltage (Configuration 8).

In Configuration 1, the display device may be configured such that the light sensor includes: a light-receiving element; a capacitance that charges and discharges an output current from the light-receiving element; a switching circuit connected between one end of the light-receiving element and one end of the capacitance; a reset signal wiring that is connected to the other end of the light-receiving element and that supplies a reset signal; and a read-out signal wiring that supplies a read-out signal to the light sensor, wherein the switching circuit includes a first transistor, a second transistor, and a third transistor, a control electrode of the first transistor is connected between one end of the light-receiving element and one end of the capacitance, one of two electrodes other than the control electrode of the first transistor is connected to a wiring that supplies a constant voltage, the other of the two electrodes other than the control electrode of the first transistor is connected to one of two electrodes other than a control electrode of a second transistor, the other of the two electrodes other than the control electrode of the second transistor is connected to an output wiring of the sensor signal, the other end of the capacitance is connected to a wiring that supplies a constant voltage, the read-out signal wiring is connected to the control electrode of the second transistor, the reset signal wiring is connected to a control electrode of the third transistor, one of two electrodes other than the control electrode of the third transistor is connected to one end of the light-receiving element, the other of the two electrodes other than the control electrode of the third transistor is connected to a wiring that supplies a reference voltage, and the driving signal generating circuit adjusts the potential of the reference voltage of the third transistor (Configuration 9).

In Configuration 1, the display device may be configured such that the light sensor includes: a light-receiving element; a capacitance that charges and discharges an output current from the light-receiving element; a switching circuit connected between one end of the light-receiving element and one end of the capacitance; a reset signal wiring that is connected to the other end of the light-receiving element and that supplies a reset signal; and a read-out signal wiring that supplies a read-out signal to the light sensor, wherein the switching circuit includes a first transistor and a second transistor, a control electrode of the first transistor is connected between one end of the light-receiving element and one end of the capacitance, one of two electrodes other than the control electrode of the first transistor is connected to a wiring that supplies a constant voltage, the other of the two electrodes other than the control electrode of the first transistor is connected to an output wiring of the sensor signal, the other end of the capacitance is connected to the read-out signal wiring, the reset signal wiring is connected to a control electrode of the second transistor, one of two electrodes other than the control electrode of the second transistor is connected to one end of the light-receiving element, the other of the two electrodes other than the control electrode of the second transistor is connected to a wiring that supplies a reference voltage, and the driving signal generating circuit adjusts at least either a high-level potential or a low-level potential of the read-out signal (Configuration 10).

In Configuration 1, the display device may be configured such that the light sensor includes: a light-receiving element; a capacitance that charges and discharges an output current from the light-receiving element; a switching circuit connected between one end of the light-receiving element and one end of the capacitance; a reset signal wiring that is connected to the other end of the light-receiving element and that supplies a reset signal; and a read-out signal wiring that supplies a read-out signal to the light sensor, wherein the switching circuit includes a first transistor and a second transistor, a control electrode of the first transistor is connected between one end of the light-receiving element and one end of the capacitance, one of two electrodes other than the control electrode of the first transistor is connected to a wiring that supplies a constant voltage, the other of the two electrodes other than the control electrode of the first transistor is connected to an output wiring of the sensor signal, the other end of the capacitance is connected to the read-out signal wiring, the reset signal wiring is connected to a control electrode of the second transistor, one of two electrodes other than the control electrode of the second transistor is connected to one end of the light-receiving element, the other of the two electrodes other than the control electrode of the second transistor is connected to a wiring that supplies a reference voltage, and the driving signal generating circuit adjusts the potential of the reference voltage (Configuration 11).

In Configuration 1, the light source ON period in the first correction data acquisition mode is preferably shorter than the light source ON period in the sensor driving mode (Configuration 12). In Configuration 12, furthermore, the light source ON start timing in a frame period in the first correction data acquisition mode may be the same as the timing in the sensor driving mode (Configuration 13). In Configuration 13, furthermore, a period from the start of the accumulation period to the end of the light source ON period in the first correction data acquisition mode may be shorter than a period from the start of the accumulation period to the end of the light source ON period in the sensor driving mode (Configuration 14). In Configuration 14, furthermore, a period from the end of the accumulation period to the end of the light source ON period in the first correction data acquisition mode may be equal to a period from the end of the accumulation period to the end of the light source ON period in the sensor driving mode (Configuration 15).

In Configuration 1, the light source ON period in the second correction data acquisition mode may be longer than the light source ON period in the first correction data acquisition mode (Configuration 16). In Configuration 16, furthermore, start and end timings of the light source ON period in a frame period in the second correction data acquisition mode may be equal to start and end timings of the light source ON period in a frame period in the sensor driving mode (Configuration 17).

In Configurations 1 to 17, when: a light sensor signal level obtained from the second sensor pixel circuit in the sensor driving mode is noted as B; a light sensor signal level obtained from the first sensor pixel circuit in the first correction data acquisition mode is noted as B₁ₛₜ; and a light sensor signal level obtained from the first sensor pixel circuit in the second correction data acquisition mode is noted as B_{2nd}, the signal-processing circuit may derive a corrected light sensor signal level R′ from a light sensor signal level R obtained from the first sensor pixel circuit in the sensor driving mode as follows.

R′=(R−B₁ₛₜ)−(B−B_{2nd})

### (Configuration 18)

In Configurations 1 to 17, alternatively, when: a gain correction light sensor signal level W₁ₛₜ is obtained by the sensor driver circuit supplying a read-out signal with zero amplitude in the first correction data acquisition mode; a gain correction light sensor signal level W_{2nd} is obtained by the sensor driver circuit supplying a read-out signal with zero amplitude in the second correction data acquisition mode; and the number of gradations of a light sensor signal is noted as L, the signal-processing circuit may derive a corrected light sensor signal level R′ from a light sensor signal level R obtained from the first sensor pixel circuit in the sensor driving mode as follows.

R′=L×R/(W₁ₛₜ−W_{2nd})

### (Configuration 19)

In Configurations 1 to 17, alternatively, when: a light sensor signal level obtained from the second sensor pixel circuit in the sensor driving mode is noted as B; a light sensor signal level obtained from the first sensor pixel circuit in the first correction data acquisition mode is noted as B₁ₛₜ; a light sensor signal level obtained from the first sensor pixel circuit in the second correction data acquisition mode is noted B_{2nd}; a gain correction light sensor signal level W₁ is obtained by the sensor driver circuit supplying a read-out signal with zero amplitude in the first correction data acquisition mode; a gain correction light sensor signal level W_{2nd} is obtained by the sensor driver circuit supplying a read-out signal with zero amplitude in the second correction data acquisition mode; and the number of gradations of a light sensor signal is noted as L, the signal-processing circuit may derive a corrected light sensor signal level R′ from a light sensor signal level R obtained from the first sensor pixel circuit in the sensor driving mode as follows.

R′=L×{(R−B₁ₛₜ)−(B−B_{2nd})}/(W₁ₛₜ−W_{2nd})

### (Configuration 20)

In Configurations 1 to 20, the first and second sensor pixel circuits may include: one light-receiving element; one accumulation node that accumulates electrical charges in accordance with a detected light amount; a read-out transistor having a control terminal electrically connectable to the accumulation node; and a holding switching element that is disposed on a path of a current that flows through the light-receiving element and that turns ON/OFF in accordance with the control signal (Configuration 21). In Configuration 21, furthermore, the first and second sensor pixel circuits may be configured such that the holding switching element is disposed between the accumulation node and one end of the light-receiving element, and the other end of the light-receiving element is connected to a reset line

### (Configuration 22).

In Configurations 1 to 20, alternatively, the display device may be configured such that the first and second sensor pixel circuits share one light-receiving element, and one end of the light-receiving element is connected to one end of the holding switching element included in the first and second sensor pixel circuits and the other end is connected to the reset line

### (Configuration 23).

Also, in Configurations 1 to 23, the display device preferably includes: an opposite substrate facing the active matrix substrate; and liquid crystals held between the active matrix substrate and the opposite substrate (Configuration 24).

### Embodiments

Embodiments of the present invention are described more specifically below with reference to figures. The embodiments described below are configuration examples when the display device of the present invention is a liquid crystal display device. The display device of the present invention, however, is not limited to a liquid crystal display device. The present invention is applicable to any display device where an active matrix substrate is used. The display device of the present invention is intended to be used as a display device equipped with a touch panel that includes light sensors to detect objects in proximity to the display, or as a display device for bidirectional communication having both the display function and the image capturing function.

For better understanding of the description, the figures below schematically show only the main members of all the constituting members of embodiments of the present invention, which are necessary to describe the present invention. Therefore, a display device of the present invention may include any constituting members that are not shown in the figures referenced herein. Dimensions of members shown in the figures do not necessarily faithfully represent dimensions of the actual constituting members, dimensional ratios among individual members, and the like.

### Embodiment 1

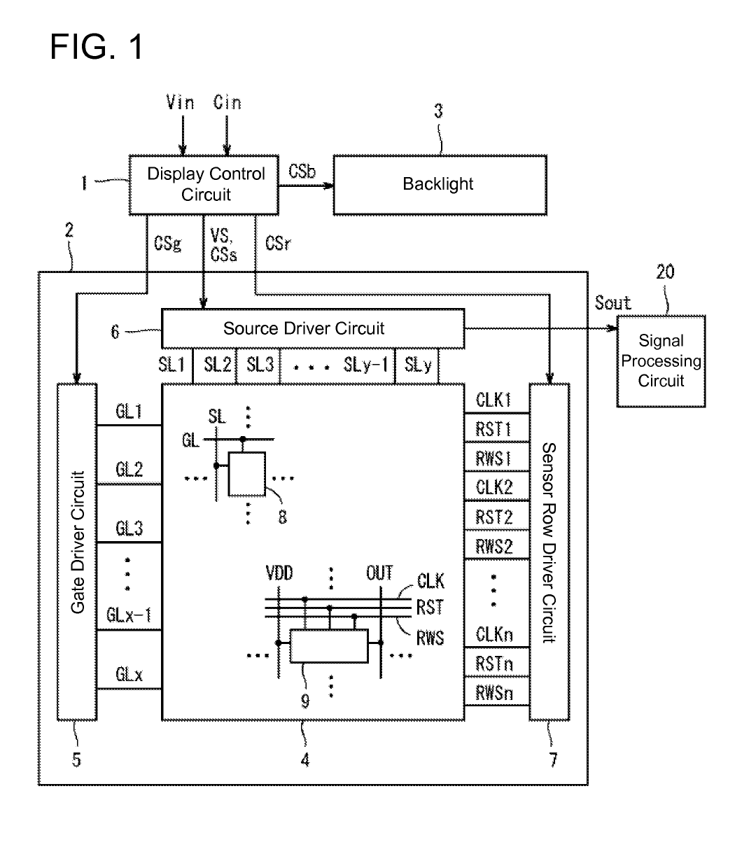

FIG. 1 is a block diagram showing the configuration of a display device according to Embodiment 1 of the present invention. The display device shown in FIG. 1 includes a display control circuit 1, a display panel 2, and a backlight 3. The display panel 2 includes a pixel region 4, a gate driver circuit 5, a source driver circuit 6, and a sensor row driver circuit 7 (sensor driver circuit). The pixel region 4 includes a plurality of display pixel circuits 8 and a plurality of sensor pixel circuits 9. This display device has a function of displaying images on the display panel 2, and a function of detecting the light entering the display panel 2. Hereinafter, x is an integer of at least 2, y is a multiple of 3, m and n are even numbers, and the display device frame rate is 60 frames/sec.

To the display device shown in FIG. 1, an image signal Vin and a timing control signal Cin are supplied from outside. Based on these signals, the display control circuit 1 outputs an image signal VS and control signals CSg, CSs, and CSr to the display panel 2, and outputs a control signal CSb to the backlight 3. The image signal VS may be the same as the image signal Vin, or may be the image signal Vin that has been processed.

The backlight 3 is a light source for sensing, and is provided separate from the light source for display. The backlight 3 projects light to the display panel 2. More specifically, the backlight 3 is provided on the back side of the display panel 2, and projects light to the back side of the display panel 2. The backlight 3 turns ON when a control signal CSb is at high level, and turns OFF when the control signal CSb is at low level. The backlight 3 may be an infrared light source, for example.

In a pixel region 4 of the display panel 2, (x×y) display pixel circuits 8 and (n×m/2) sensor pixel circuits 9 are disposed, which are both arranged two-dimensionally. More specifically, x gate lines GL1 to GLx and y source lines SL1 to SLy are disposed in the pixel region 4. The gate lines GL1 to GLx are arranged in parallel to each other, and the source lines SL1 to SLy are arranged in parallel to each other and to intersect the gate lines GL1 to GLx. The (x×y) display pixel circuits 8 are disposed near respective intersections of the gate lines GL1 to GLx and the source lines SL1 to SLy. The display pixel circuits 8 are each connected to one gate line GL and one source line SL. The display pixel circuits 8 are categorized into three types: for red display, for green display, and for blue display. Three display pixel circuits 8 of different types are arranged in the direction in which the gate lines GL1 to GLx extend, to constitute a color pixel.

In the pixel region 4, n clock lines CLK1 to CLKn, n reset lines RST1 to RSTn, and n read-out lines RWS1 to RWSn are disposed in parallel to the gate lines GL1 to GLx. Other signal lines and power supply lines (not shown) may also be disposed in the pixel region 4 in parallel to the gate lines GL1 to GLx. When signals are read from the sensor pixel circuit 9, m source lines selected among the source lines SL1 to SLy are used as power supply lines VDD1 to VDDm, and other m source lines are used as output lines OUT1 to OUTm.

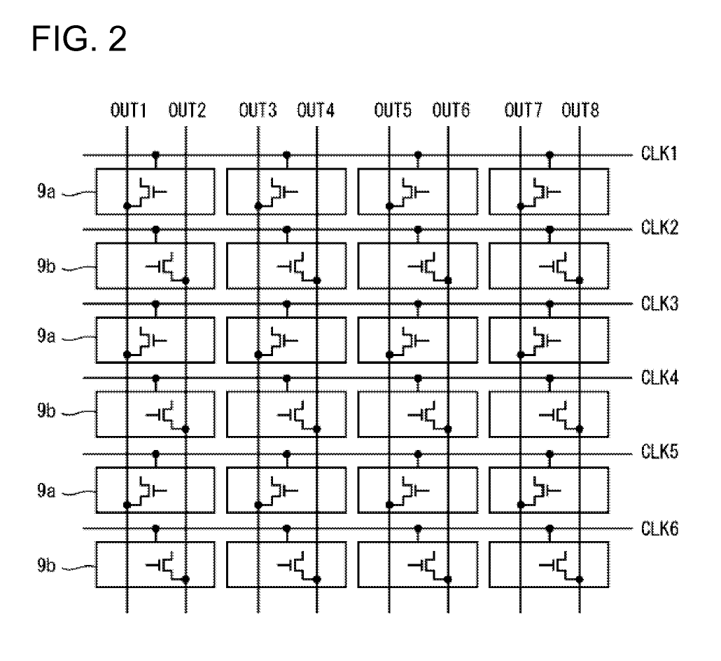

FIG. 2 shows the arrangement of sensor pixel circuits 9 in the pixel region 4. (n×m/2) sensor pixel circuits 9 include first sensor pixel circuits 9a that detect incoming light during the backlight 30N period, and second sensor pixel circuits 9b that detect incoming light during the backlight 3 OFF period. There are the same number of the first sensor pixel circuits 9a and the second sensor pixel circuits 9b. In FIG. 2, (n×m/4) first sensor pixel circuits 9a are disposed near respective intersections of odd-numbered clock lines CLK1 to CLKn-1 and odd-numbered output lines OUT1 to OUTm−1. (n×m/4) second sensor pixel circuits 9b are disposed near respective intersections of even-numbered clock lines CLK2 to CLKn and even-numbered output lines OUT2 to OUTm. As described above, the display panel 2 includes a plurality of output lines OUT1 to OUTm that carry output signals of the first sensor pixel circuits 9a and output signals of the second sensor pixel circuits 9b. The first sensor pixel circuits 9a and the second sensor pixel circuits 9b are connected to different output lines depending on their types.

A gate driver circuit 5 drives gate lines GL1 to GLx. More specifically, the gate driver circuit 5 sequentially selects one of the gate lines GL1 to GLx based on the a control signal CSg, and applies a high level potential to the selected gate line and applies a low level potential to the remaining gate lines. Consequently, y display pixel circuits 8 connected to the selected gate line are collectively selected.

A source driver circuit 6 drives source lines SL1 to SLy. More specifically, the source driver circuit 6 applies a potential representing an image signal VS to the source line SL1 to SLy based on a control signal CSs. At this time, the source driver circuit 6 may conduct driving in a linear sequential manner or in a dot sequential manner. The potential applied to the source lines SL1 to SLy is written to the y display pixel circuits 8 selected by the gate driver circuit 5. Thus, by writing potentials representing the image signal VS to all the display pixel circuits 8 using the gate driver circuit 5 and the source driver circuit 6, a desired image can be displayed on the display panel 2.

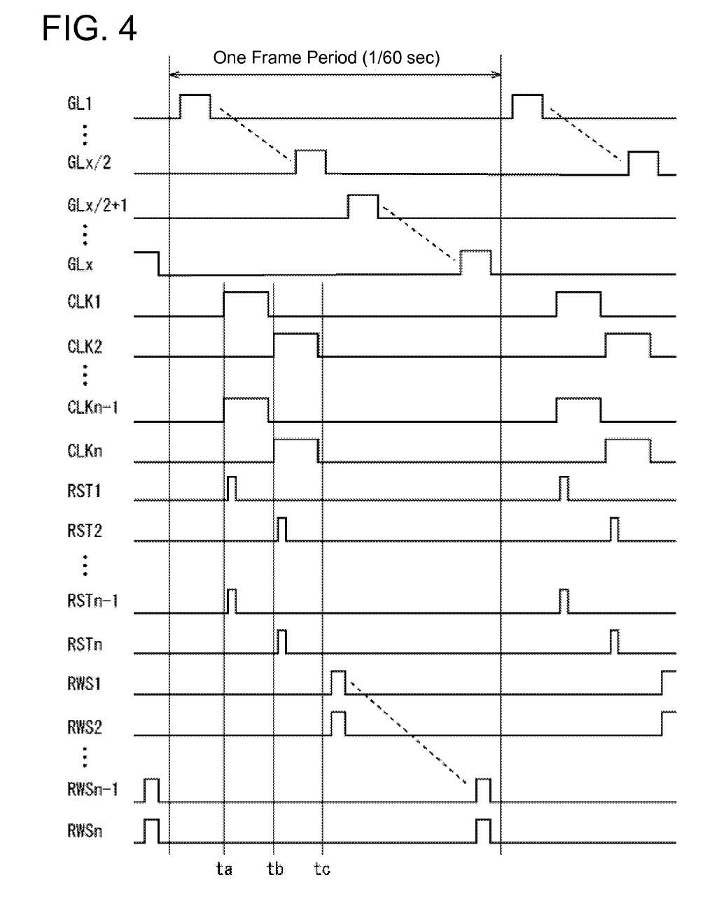

The sensor row driver circuit 7 drives clock lines CLK1 to CLKn, reset lines RST1 to RSTn, read-out lines RWS1 to RWSn, and the like. More specifically, the sensor row driver circuit 7 applies a high level potential and a low level potential to the clock lines CLK1 to CLKn with the timings shown in FIG. 4 based on a control signal CSr (described in details below). Also, based on the control signal CSr, the sensor row driver circuit 7 selects (n/2) or two of the reset lines RST1 to RSTn and applies a high-level potential for resetting to the selected reset lines and applies a low level potential to the remaining reset lines. Consequently, (n×m/4) or m sensor pixel circuits 9 connected to the reset lines to which a high-level potential is applied are collectively reset.

Also, based on the control signal CSr, the sensor row driver circuit 7 sequentially selects two adjacent read-out lines of read-out lines RWS1 to RWSn, and applies a high-level potential for reading-out to the selected read-out lines and a low-level potential to the remaining read-out lines. Consequently, m sensor pixel circuits 9 connected to the selected two read-out lines collectively become read-out enabled. At this time, the source driver circuit 6 applies a high-level potential to power supply lines VDD1 to VDDm. Consequently, from the m sensor pixel circuits 9, which are read-out enabled, signals representing the light amounts detected by the individual sensor pixel circuits 9 (hereinafter referred to as sensor signals) are outputted to output lines OUT1 to OUTm.

The source driver circuit 6 includes a difference circuit (not shown) that obtains the difference between the output signal of the first sensor pixel circuit 9a and the output signal of the second sensor pixel circuit 9b. The source driver circuit 6 includes an amplifier circuit (not shown) that amplifies the difference in the light amount obtained by the difference circuit. The source driver circuit 6 outputs the amplified signal as sensor output Sout to outside the display panel 2. The sensor output Sout is appropriately processed as necessary by a signal-processing circuit 20 disposed outside the display panel 2. Thus, light entering the display panel 2 can be detected by reading out the sensor signals from all the sensor pixel circuits 9 using the source driver circuit 6 and the sensor row driver circuit 7.

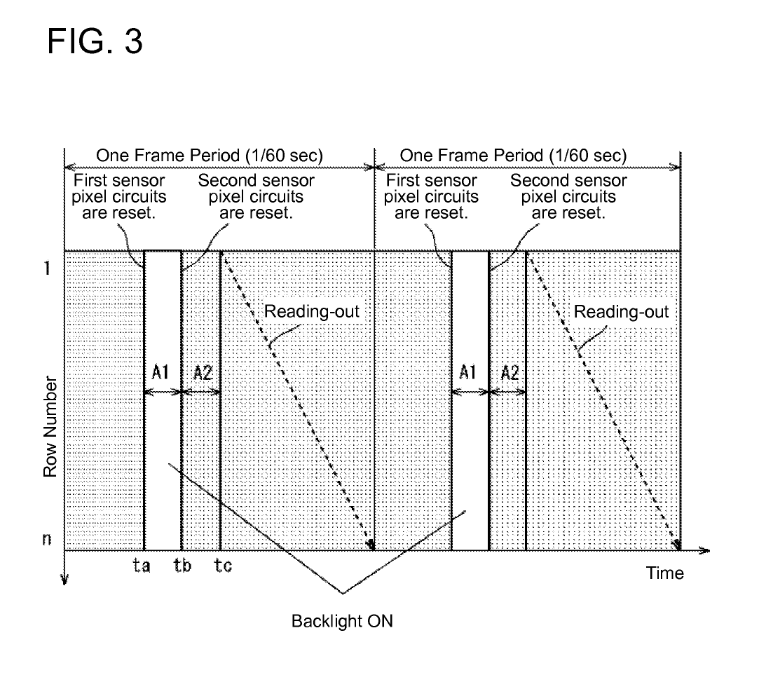

FIG. 3 shows the backlight 30N and OFF timings and the reset and the read-out timings of the sensor pixel circuits 9. FIG. 3 shows an example in which the backlight 3 turns ON once during one frame period for a prescribed time, and turns OFF the rest of the period. Specifically, the backlight 3 turns ON at time ta in each frame period, and turns OFF at time tb. Also, at time ta, all the first sensor pixel circuits 9a are reset, and at time tb, all the second sensor pixel circuits 9b are reset.

The first sensor pixel circuit 9a detects incoming light during period A1, which is from time ta to time tb (while the backlight 3 is ON). The second sensor pixel circuit 9b detects incoming light during period A2, which is from time tb to time tc (while the backlight 3 is OFF). Period A1 and period A2 are the same length. Reading out from the first sensor pixel circuits 9a and reading out from the second sensor pixel circuits 9b are conducted in parallel in a linear sequential manner after time tc. Also, even though reading-out from the sensor pixel circuits 9 is completed within a frame period in FIG. 3, alternatively it may be completed in the next frame period before the first sensor pixel circuit 9a is reset.

Also, even though FIG. 3 shows an example that reading-out from the sensor pixel circuits 9 is conducted once in each frame period, reading-out from the sensor pixel circuit 9 may be conducted twice or more in each frame period.

FIG. 4 shows signal waveforms of the display panel 2 for driving with the timings shown in FIG. 3. As shown in FIG. 4, the electrical potential of the gate lines GL1 to GLx sequentially becomes high level once in each frame period, for a prescribed time. The electrical potential of the odd-numbered clock lines CLK1 to CLKn-1 becomes high level once in each frame period, during period A1 (more specifically, from time ta to immediately before time tb). The electrical potential of the even-numbered clock lines CLK2 to CLKn becomes high level once in each frame period, during period A2 (more specifically, from time tb to immediately before time tc). The electrical potential of the odd-numbered reset lines RST1 to RSTn−1 becomes high level once in each frame period, for a prescribed time at the beginning of period A1. The electrical potential of the even-numbered reset lines RST2 to RSTn becomes high level once in each frame period, for a prescribed time at the beginning of period A2. The read-out lines RWS1 to RWSn are grouped in pairs, and the electrical potential of the (n/2) pairs of the read-out lines sequentially becomes high level for a prescribed time after time tc.

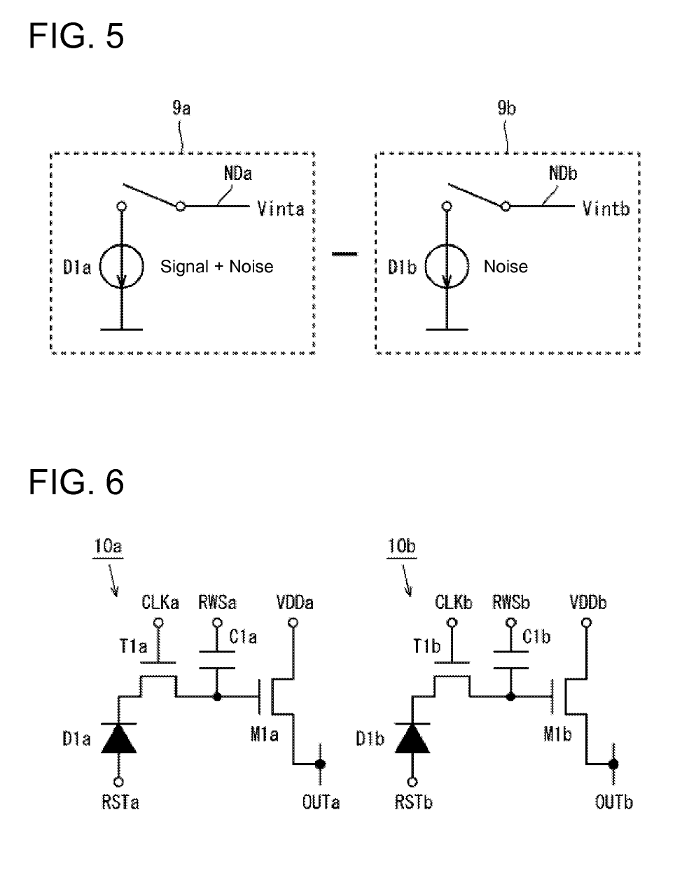

FIG. 5 schematically shows the configuration of the sensor pixel circuit 9. As shown in FIG. 5, the first sensor pixel circuit 9a includes a photodiode D1a and an accumulation node NDa. The photodiode D1a draws from the accumulation node NDa electrical charges in accordance with the amount of light entered (signal+noise) while the backlight 3 is ON. Like the first sensor pixel circuit 9a, the second sensor pixel circuit 9b includes a photodiode D1b and an accumulation node NDb. The photodiode D1b draws from the accumulation node NDb electrical charges representing the light amount entered (noise) while the backlight 3 is OFF. From the first sensor pixel circuit 9a, the sensor signal representing the amount of light entered during the detection period when the backlight 3 was ON is read out. From the second sensor pixel circuit 9b, the sensor signal representing the amount of light entered during the detection period when the backlight 3 was OFF is read out. As described above, by obtaining the difference between the output signal of the first sensor pixel circuit 9a and the output signal of the second sensor pixel circuit 9b using the difference circuit included in the source driver circuit 6, the difference between the light amount when the backlight is ON and the light amount when the backlight is OFF can be obtained.

Also, any number of sensor pixel circuits 9 can be provided in the pixel region 4. However, preferably the first sensor pixel circuits 9a and the second sensor pixel circuits 9b are connected to different output lines. For example, (n×m) sensor pixel circuits 9 can be provided in the pixel region 4 by connecting n first sensor pixel circuits 9a to each of the odd-numbered output lines OUT1 to OUTm−1, and by connecting n second sensor pixel circuits 9b to each of the even-numbered output lines OUT2 to OUTm. In this case, reading-out from the sensor pixel circuits 9 is conducted row by row. Alternatively, as many sensor pixel circuits 9 as the color pixels (i.e., (x×y/3) sensor pixel circuits 9) may be disposed in the pixel region 4. Yet alternatively, a smaller number of sensor pixel circuits 9 than the color pixels (for example, a few fractions or a few tens of fractions of the number of the color pixels) may be disposed in the pixel region 4.

As described above, a display device according to embodiments of the present invention includes: a plurality of photodiodes (light sensors) disposed in the pixel region 4; a display panel 2 having a plurality of display pixel circuits 8 and a plurality of sensor pixel circuits 9; and a sensor row driver circuit 7 (driver circuit) that outputs to the sensor pixel circuits 9 a clock signal CLK (control signal) indicating the detection period when the backlight is ON and the detection period when the backlight is OFF. The sensor pixel circuit 9 included in this display device is described in detail below. In the description below, the sensor pixel circuit is simply referred to as pixel circuit, and the same names as the signal lines are used for the signals to easily identify the signals that the signal lines carry (ex. the signal carried by the clock line CLKa is referred to as clock signal CLKa).

The first sensor pixel circuit 9a is connected to the clock line CLKa, reset line RSTa, read-out line RWSa, power supply line VDDa, and output line OUTa. The second sensor pixel circuit 9b is connected to the clock line CLKb, reset line RSTb, read-out line RWSb, power supply line VDDb, and output line OUTb. Because the second sensor pixel circuit 9b has the same configuration and operates in a similar manner as the first sensor pixel circuit 9a in these embodiments, description of the second sensor pixel circuit 9b is omitted as appropriate.

FIG. 6 shows circuit diagrams illustrating specific configuration examples of the first sensor pixel circuit 9a and the second sensor pixel circuit 9b. In this embodiment, a first pixel circuit 10a shown in FIG. 6 is a specific example of the first sensor pixel circuit 9a, and a second pixel circuit 10b is a specific example of the second sensor pixel circuit 9b. As shown in FIG. 6, the first pixel circuit 10a includes transistors T1a and M1a, a photodiode D1a, and a capacitor C1a. The second pixel circuit 10b includes transistors T1b and M1b, a photodiode D1b, and a capacitor C1b. Transistors T1a, M1a, T1b, and M1b are N-type TFTs (Thin Film Transistors).

In the first pixel circuit 10a, the anode of the photodiode D1a is connected to a reset line RSTa, and the cathode is connected to the source of the transistor T1a. The gate of the transistor T1a is connected to the clock line CLKa, and the drain is connected to the gate of the transistor M1a. The drain of the transistor M1a is connected to a power supply line VDDa, and the source is connected to an output line OUTa. The capacitor C1a is disposed between the gate of the transistor M1a and the read-out line RWSa. In the first pixel circuit 10a, the node connected to the gate of the transistor M1a serves as the accumulation node that accumulates the charge in accordance with the detected light amount, and the transistor M1a functions as the read-out transistor. The second pixel circuit 10b has the same configuration as the first pixel circuit 10a.

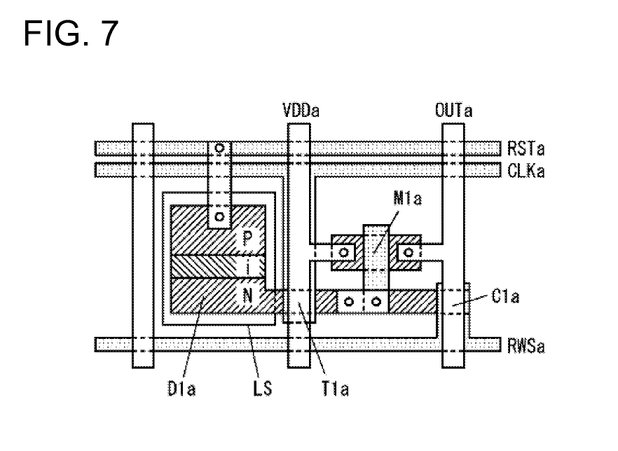

FIG. 7 shows the layout of the first pixel circuit 10a. As shown in FIG. 7, the first pixel circuit 10a is configured by sequentially forming on a glass substrate a light-shielding LS, a semiconductor layer (hatched), a gate wiring layer (dotted), and a source wiring layer (solid white). Contacts (indicated with white circles) are provided at locations at which the semiconductor layer and the source wiring layer are connected, the semiconductor layer and the source wiring layer are connected, and the gate wiring layer and the source wiring layer are connected. The transistors T1a and M1a are formed by disposing the semiconductor layer and the gate wiring layer in a crisscrossed manner. The photodiode D1a is formed by disposing the semiconductor layers, i.e., a P layer, an I layer, and an N layer, side by side. The capacitor C1a is formed by superimposing the semiconductor layer and the gate wiring layer. The light-shielding film LS is made of a metal, and prevents the light coming through the back side of the substrate from entering the photodiode D1a. The second pixel circuits 10b are laid out in the similar manner as the first pixel circuits 10a. Alternatively, the first and second pixel circuits 10a and 10b may be laid out in a manner that is different from the one described above.

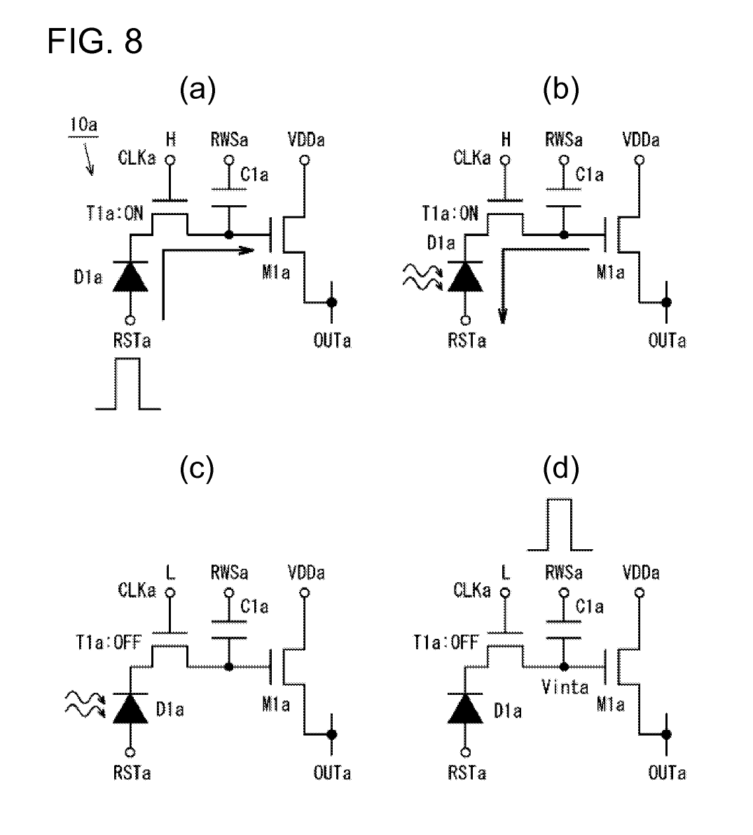

FIG. 8 illustrates the operation of the first pixel circuit 10a when driven by the signals shown in FIG. 4. As shown in FIG. 8, the first pixel circuit 10a conducts (a) resetting, (b) accumulating, (c) holding, and (d) reading-out during a frame period.

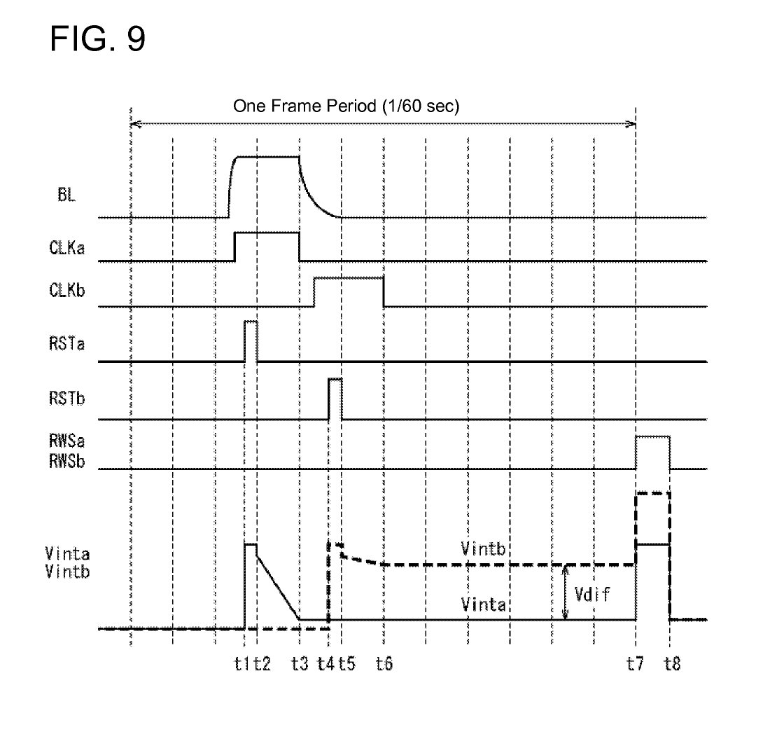

FIG. 9 shows signal waveforms of the first pixel circuit 10a and the second pixel circuit 10b when driven by the signals shown in FIG. 4. In FIG. 9, “BL” denotes the luminance of the backlight 3, “Vinta” denotes the potential at the accumulation node of the first pixel circuit 10a (gate potential of the transistor M1a), and “Vintb” is the potential at the accumulation node of the second pixel circuit 10b (gate potential of the transistor M1b). In the case of the first pixel circuit 10a, the resetting period is from time t1 to time t2, accumulation period is from time t2 to time t3, holding period is from time t3 to time t7, and reading-out period is from time t7 to time t8. In the case of the second pixel circuit 10b, the resetting period is from time t4 to time t5, accumulation period is from time t5 to time t6, holding period is from time t6 to time t7, and reading-out period is from time t7 to time t8.

During the resetting period of the first pixel circuit 10a, the clock signal CLKa becomes high level, the read-out signal RWSa becomes low level, and the reset signal RSTa becomes high level for resetting. At this time, the transistor T1a turns ON. As a result, current (forward current of the photodiode D1a) flows from the reset line RSTa to the accumulation node via the photodiode D1a and the transistor T1a (FIG. 8(a)), and the potential Vinta is reset to a prescribed level.

During the accumulation period of the first pixel circuit 10a, the clock signal CLKa becomes high level, and the reset signal RSTa and the read-out signal RWSa become low level. At this time, the transistor T1a turns ON. If light enters the photodiode D1a at this time, current (photo current of the photodiode D1a) flows from the accumulation node to the reset line RSTa via the transistor T1a and the photodiode D1a, and the charge is drawn from the accumulation node (FIG. 8(b)). As a result, the potential Vinta lowers in accordance with the amount of the light entering while the clock signal CLKa is at high level (while the backlight 3 is ON).

During the holding period of the first pixel circuit 10a, the clock signal CLKa, reset signal RSTa, and read-out signal RWSa become low level. At this time, the transistor T1a turns OFF. Here, because the transistor T1a stays OFF, the photodiode D1a and the gate of the transistor M1 are electrically insulated, and the potential Vinta does not change even if light enters the photodiode D1a (FIG. 8(c)).

During the reading-out period of the first pixel circuit 10a, the clock signal CLKa and the reset signal RSTa become low level, and the read-out signal RWSa becomes high level for reading-out. At this time, the transistor T1a turns OFF. Here, the potential Vinta increases (Cqa/Cpa) times as much as the increase in the potential of the read-out signal RWSa (where Cpa is the total capacitance value of the first pixel circuit 10a, and Cqa is the capacitance value of the capacitor C1a). The transistor M1a constitutes a source follower amplifier circuit where a transistor (not shown) included in the source driver circuit 6 is used as a load, and drives the output line OUTa in accordance with the potential Vinta (FIG. 8(d)).

The second pixel circuit 10b operates in a similar manner as the first pixel circuit 10a. Potential Vintb is reset to a prescribed level during the resetting period, goes down in accordance with the amount of light entering while the clock signal CLKb is at high level (while the backlight 3 is OFF) during the accumulation period, and does not change during the holding period. During the reading-out period, potential Vintb increases (Cqb/Cpb) times the increase in the potential of the read-out signal RWSb (Cpb is the total capacitance value of the second pixel circuit 10b, and Cqb is the capacitance value of the capacitor C1b), and the transistor M1b drives the output line OUTb in accordance with the potential Vintb.

As described above, the first pixel circuit 10a of this embodiment includes: one photodiode D1a (light sensor), one accumulation node that accumulates the charge in accordance with the light amount detected; a transistor M1a having a control terminal connected to the accumulation node (read-out transistor); and a transistor T1a that is disposed on the path of the current that flows through the photodiode D1a, and that turns ON/OFF in accordance with the clock signal CLK (holding switching element). The transistor T1a is disposed between the accumulation node and an end of the photodiode D1a, and the other end of the photodiode D1a is connected to the reset line RSTa. The transistor T1a turns ON when instructed by the clock signal CLKa during the detection period when the backlight is ON. The second pixel circuit 10b has a similar structure as the first pixel circuit 10a. The transistor T1b included in the second pixel circuit 10b turns ON during the detection period when the backlight is OFF.

Thus, with the transistor T1a, which turns ON during the detection period when the backlight is ON and is disposed on the path of the current flowing through the photodiode D1a, and with the transistor T1b, which turns ON during the detection period when the backlight is OFF and is disposed on the path of the current flowing through the photodiode D1b, a first pixel circuit 10a that detects light during the detection period and holds the detected light amount during the remaining period when the backlight is ON, and a second pixel circuit 10b that detects light during the detection period and holds the detected light amount during the remaining period when the backlight is OFF can be constituted.

### <Offset Error Correction>

In addition to the sensor driving mode described above with reference to FIG. 4 and FIG. 9, a display device of this embodiment has two correction data acquisition modes (the first correction data acquisition mode and the second correction data acquisition mode) for correcting the offset errors of the first pixel circuit 10a and the second pixel circuit 10b, respectively.

That is, in a display device of this embodiment, a first correction data Ofst_on for correcting the first pixel circuit 10a offset developed in the sensor driving mode is obtained by finding the difference between the sensor output Outa, which is sent from the first pixel circuit 10a, and a reference value ref_on in the first correction data acquisition mode. Also, a second correction data Ofst_off for correcting the second pixel circuit 10b offset developed in the sensor driving mode is obtained by finding the difference between the sensor output Outb, which is obtained from the second pixel circuit 10b, and a reference value ref_off in the second correction data acquisition mode.

The reference value ref_on and the reference value ref_off are factory-set values stored in the EEPROM of the display device for each of the sensors. For example, the same number of reference values ref_on as the first pixel circuits 10a may be associated with respective first pixel circuits 10a and stored in the EEPROM. In this case, the same number of reference values ref_off as the second pixel circuits 10b are associated with respective second pixel circuit 10b and stored in the EEPROM. This, however, is only an example. The method of storing the reference values can be designed as appropriate in consideration of the memory capacity and the like. Also, individual values of the reference value ref_on and the reference value ref_off can be set as appropriate.

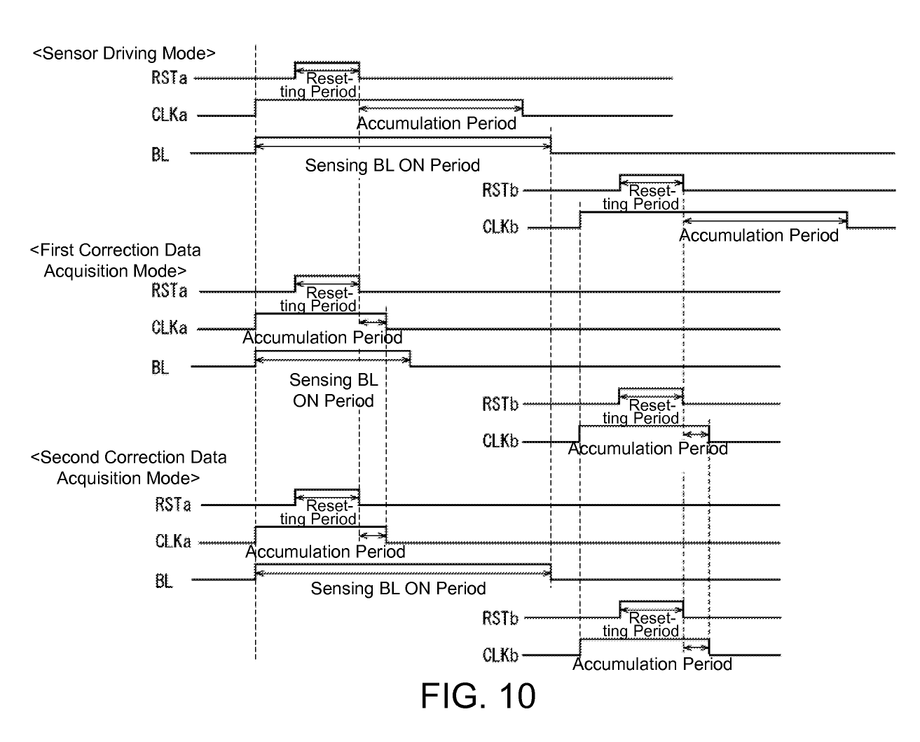

Here, with reference to FIG. 10, the sensor driving mode, the first correction data acquisition mode, and the second correction data acquisition mode are described. In the timing chart shown in FIG. 10, the top row shows the driving signal during a frame in the sensor driving mode, the middle row shows the driving signal during a frame in the first correction data acquisition mode, and the bottom row shows the driving signal during a frame in the second correction data acquisition mode.

In the first correction data acquisition mode and in the second correction data acquisition mode, the timings of the reset signal and the clock signal, and the backlight ON timing are different from those of the sensor driving mode, but the read-out signal timing is the same as that of the sensor driving mode shown in FIG. 4. Therefore, like in the sensor driving mode, sensor outputs are sequentially read out from all the sensor pixel circuits disposed in the pixel region 4 in the first correction data acquisition mode and in the second correction data acquisition mode.

As shown in FIG. 10, in the sensor driving mode, in the first correction data acquisition mode, and in the second correction data acquisition mode, the clock signals CLKa and CLKb rise at the same timing in a frame. Also, in all of these modes, the length of the period during which the clock signal CLKa is at high level and the length of the period during which the clock signal CLKb is at high level are the same.

Also, the periods in which the clock signal CLKa is at high level in the first correction data acquisition mode and the second correction data acquisition mode are shorter than the period in which the clock signal CLKa is at high level in the sensor driving mode. In other words, the accumulation periods in the first correction data acquisition mode and in the second correction data acquisition mode are shorter than the accumulation period in the sensor driving mode.

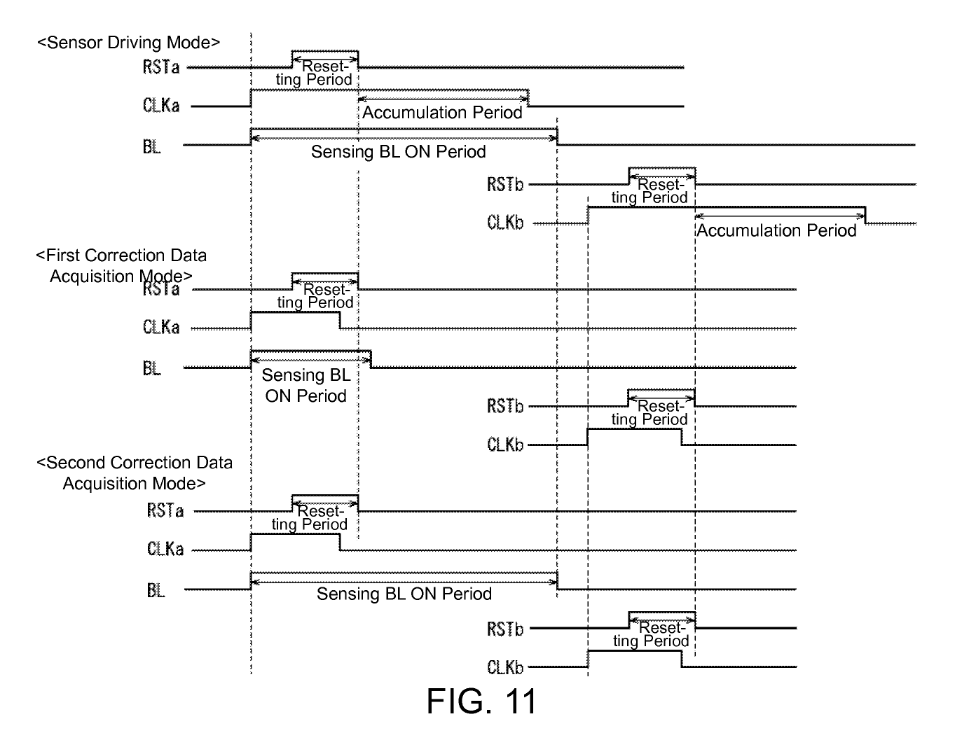

Also, preferably the length of the accumulation period in the first correction data acquisition mode and the accumulation period in the second correction data acquisition mode is substantially zero to avoid any influence of photo current caused by external light or the like. More specifically, as shown in FIG. 10, alternatively, after the reset signal RSTa switches from high level to low level, the clock signal CLKa may switch from high level to low level. However, in this case, the accumulation period in the data obtaining modes is deemed sufficiently long if it constitutes a prescribed margin period that prevents the order of occurrence between the fall (switching from high level to low level) of the reset signal RSTa and the fall of the clock signal CLKa from being reversed as a result of a variation in signal timings. Although it depends on the design, preferably the accumulation period in this case is, for example, as short as a few micro seconds. Alternatively, as shown in FIG. 11, RST signal RSTa may be set to fall after the fall of the clock signal CLKa. In this case, the length of the accumulation period is substantially zero.

In examples shown in FIG. 10 and FIG. 11, in all these modes, the backlight for sensing turns ON in sync with the clock signal CLKa. However, the timing is not limited to this. The clock signal CLKa may rise before or after the backlight ON period starts. In this case, however, preferably the length of period from the backlight turning ON to the rise of the clock signal CLKa is the same in the sensor driving mode and in the first correction data acquisition mode.

The length of the backlight ON period is preferably the same in the sensor driving mode and in the second correction data acquisition mode. On the other hand, the backlight ON period in the first correction data acquisition mode is shorter than the backlight ON period in the sensor driving mode or the second correction data acquisition mode. That is, the length of the period from the end of the accumulation period to the backlight OFF in the first correction data acquisition mode is shorter than the period from the end of the accumulation period to the backlight OFF in the sensor driving mode.

In the sensor driving mode, the backlight turns OFF when a prescribed time has elapsed after the fall of the clock signal CLKa (i.e., after the accumulation period ends). Also in the first correction data acquisition mode, the backlight preferably turns OFF when the same prescribed time stated above has elapsed after the fall of the clock signal CLKa.

The charging state during the accumulation period in the backlight ON period depends on the length of the backlight ON period preceding the resetting period. In this embodiment, as described above, the length of the backlight ON period preceding the resetting period is set to be the same in the sensor driving mode and in the first correction data acquisition mode. Thus, the influence of the length of the backlight ON period preceding the resetting period is made equal in the sensor driving mode and in the first correction data acquisition mode.

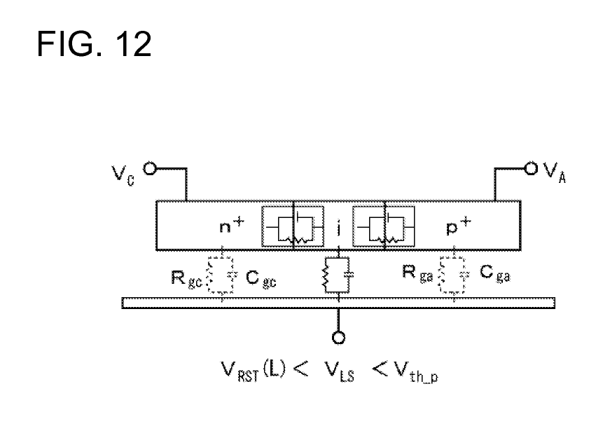

Here, with reference to FIG. 12 and other figures, the reason that the electrical charging state in the accumulation period during the backlight ON period is influenced by the length of the backlight ON period preceding the resetting period is explained.

FIG. 12 is a schematic cross-sectional view of a diode D1a. As shown in FIG. 12, if, like the diode D1a of this embodiment, a light-shielding film LS is disposed near a lateral-structured PIN diode, the diode functions as a three-terminal element due to the parasitic capacitances formed between the diode and the light-shielding film LS. That is, the light-shielding film LS becomes the gate, the p layer becomes the anode, and the n layer becomes the cathode. Depending on the relationship among the potential V_{LS} at the gate, i.e., the light-shielding film LS, the anode potential V_{A}, and cathode potential V_{C}, three different operating modes are created.

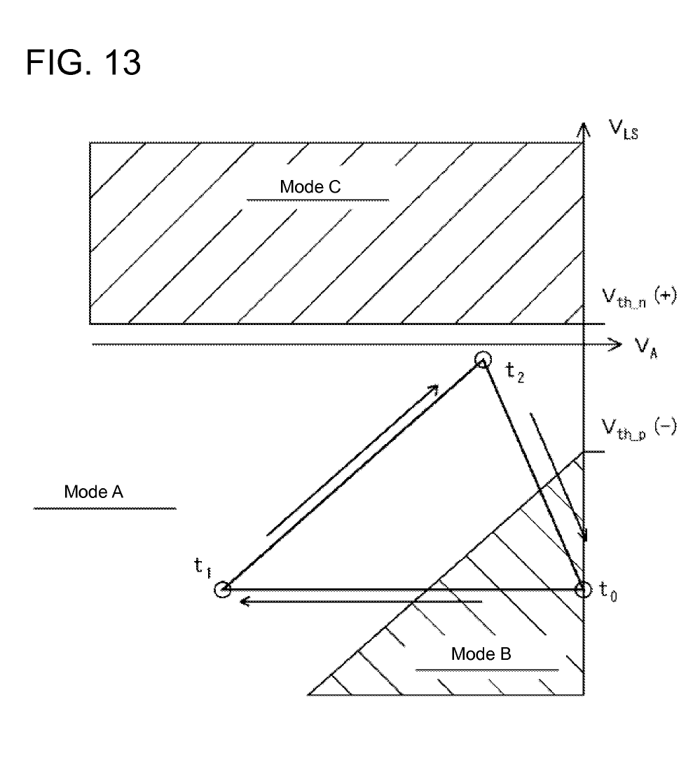

FIG. 13 illustrates the distribution of modes A, B, and C using the relationship between the anode potential V_{A} and the light-shielding film LS potential V_{LS}. In FIG. 13, the region that is not hatched is mode A, the region hatched with lines oriented to bottom right is mode B, and the region hatched with lines oriented to bottom left is mode C. As described above, mode A region can be expressed as follows.

V_{A}+Vₜₕ_{_{—}}ₚ≦V_{LS}≦V_{C}+Vₜₕ_{_{—}}ₙ

Mode B region can be expressed as follows.

V_{LS}≦V_{A}+Vₜₕ_{_{—}}ₚ

Mode C region can be expressed as follows.

V_{C}+Vₜₕ_{_{—}}ₙ≦V_{LS}

Of “t0”, “t1”, and “t2” shown in FIG. 13, “t0” represents the coordinates of V_{LS} and V_{A} when the reset signal RSTa becomes high level. “t1” corresponds to the time when the reset signal RSTa switches from high level to low level, and “t2” corresponds to the time when the clock signal CLKa switches from high level to low level.

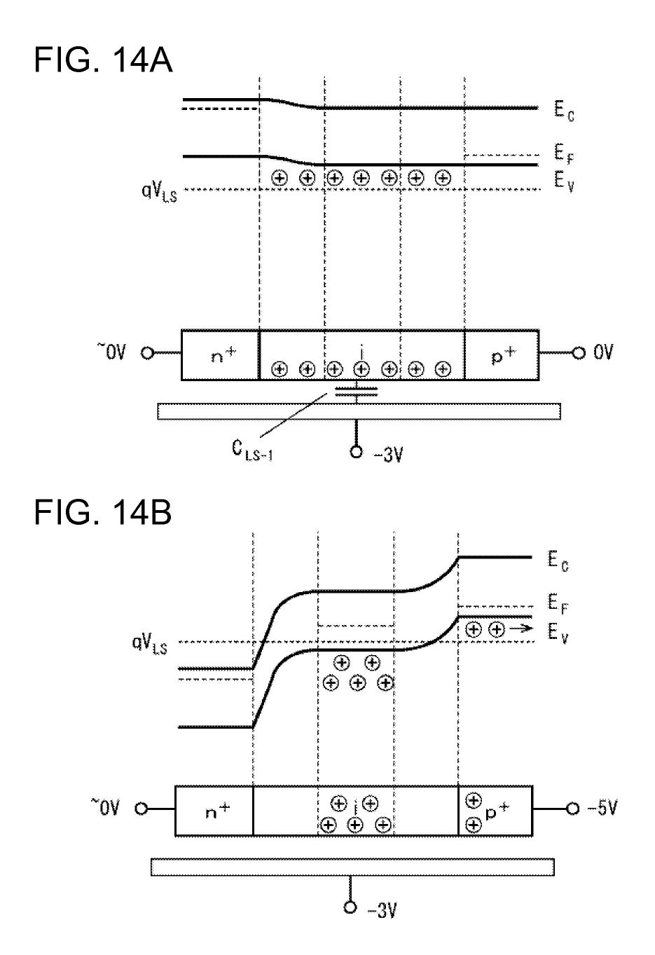

As understood from FIG. 13, when the reset signal RSTa becomes high level (when a resetting period starts, i.e., time t0), the diode D1a is in mode B. As shown in FIG. 14A, when in mode B, the i layer of the diode D1a is full of holes. When the reset signal RSTa switches to low level (at time t1), diode D1a is already in mode A, and, as shown in FIG. 14B, holes are trapped in the i layer. Consequently, during the resetting period, the diode D1a is in the state of mode B, which is shown in FIG. 14A, and therefore is subjected to the influence of the light from the backlight projected immediately prior to the resetting period. That is, the charge storage state at the diode D1a differs depending on the state of the transmitted light and reflected light from the backlight to the diode D1a immediately prior to the resetting period. Therefore, the reset level and the reset field through amount of the diode D1a depend on the backlight ON state immediately prior to the resetting period.

In consideration of these facts, in this embodiment, as shown in FIG. 10 and FIG. 11, the length of the backlight ON period preceding the resetting period is set to be equal in the sensor driving mode and in the first correction data acquisition mode. This way, under the condition that the reset level and the reset field through amount of the diode D1a are the same as those in the sensor driving mode, the first correction data Ofst_on for correcting the offset of the first pixel circuit 10a developed in the sensor driving mode can be obtained in the first correction data acquisition mode.

Also, in the examples shown in FIG. 10 and FIG. 11, the length of time from the end of the accumulation period to the backlight OFF is set to be equal in the sensor driving mode and in the first correction data acquisition mode. This is to make the influence of the leakage of the transistor T1a, which is caused by the entry of light from the backlight to the diode D1a during the time from the end of the accumulation period to the backlight turning OFF, consistent in the sensor driving mode and in the first correction data acquisition mode. That is, even after the clock signal CLKa becomes low level and the accumulation period ends, as long as the backlight is ON, there is a light component entering the transistor T1a, because some light from the backlight passes through the light-shielding film LS or is reflected by constituting members inside the panel. Therefore, as shown in FIG. 10 and FIG. 11, by setting the length of time from the end of the accumulation period to the backlight turning OFF to be equal in the sensor driving mode and in the first correction data acquisition mode, the influence of the transistor T1a leakage can be made the same in both modes. Thus, under the condition that the transistor T1a leakage is the same as in the sensor driving mode, the first correction data Ofst_on for correcting the offset of the first pixel circuit 10a developed in the sensor driving mode can be obtained in the first correction data acquisition mode.

Also, in this embodiment, as shown in FIG. 10 and FIG. 11, the backlight ON period in a frame in the second correction data acquisition mode is set to occur at the same timing and for the same length as the ON period in the sensor driving mode. Therefore, the backlight ON condition immediately prior to the resetting period (while the reset signal RSTb is at high level) of the second pixel circuit 10b is the same as that of the sensor driving mode. This way, as described above with reference to FIG. 12 to FIG. 14B, under the condition that the reset level and the reset field through amount of the diode D1b are consistent with those of the sensor driving mode, the second correction data Ofst_off for correcting the offset of the second pixel circuit 10b developed in the sensor driving mode can be obtained in the second correction data acquisition mode.

The first correction data Ofst_on and the second correction data Ofst_off obtained as described above are stored, for example, in RAM (Random Access Memory) in the signal-processing circuit 20. The signal-processing circuit 20 corrects the sensor output obtained in the sensor driving mode using the first correction data Ofst_on and the second correction data Ofst_off acquired as described above. A specific example of the correction process is described below. In the example, the correction process is conducted by the signal-processing circuit 20. However, alternatively, it may be conducted by an operational circuit disposed in the source driver circuit 6.

In the display device of this embodiment, the above-mentioned first correction data Ofst_on and the second correction data Ofst_off are obtained at an appropriate timing, and then stored in the RAM in the signal-processing circuit 20 so that they can be used later. The stored values are preferably updated with a prescribed timing. Examples of the preferable timing for updating such stored values are: (1) when the display device is turned ON; (2) when a normal mode is switched to a sensor standby mode; (3) when the sensor standby mode is switched to the normal mode; and (4) when the operating environment is verified.

“Normal mode” and “sensor standby mode” mentioned above are sub-modes of the sensor driving mode. The sensor standby mode is the state of operation in which the frequency of the sensor cycle (the cycle during which reading-out is conducted once from all sensor pixel circuits in the pixel region 4) is lower than that in the normal mode. For example, if, during the normal mode operation, no touch by a finger or the like is detected for a period longer than a prescribed threshold value, the operation mode is switched from the normal mode to the sensor standby mode to reduce energy consumption. For example, if a sensor cycle in the normal mode is 1/60 sec (one frame period), and if reading-out from the sensor pixel circuit is conducted in 1 out of 10 frames in the sensor standby mode, a sensor cycle in the sensor standby mode is ⅙ sec.

Switching from the sensor standby mode to the normal mode can be done in an opposite manner. For example, if a touch by a finger or the like is detected during the sensor standby mode operation with a sensor cycle of ⅙ sec, sensor reading-out can be conducted every 1/60 sec starting the next frame period.

Regarding the timing for updating the first correction data Ofst_on and the second correction data Ofst_off, cases (1) to (4) mentioned above are described as Example 1 to Example 4 below.

### Example 1

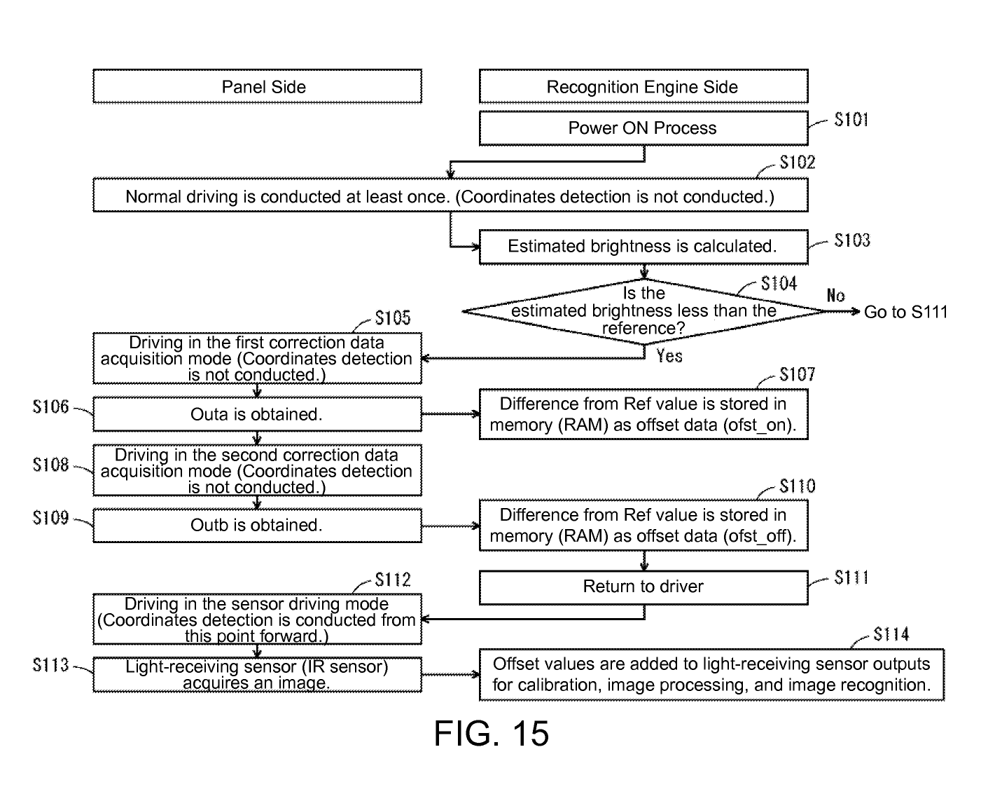

In Example 1, as shown in FIG. 15, the first correction data Ofst_on and the second correction data Ofst_off are updated when the display device is turned ON. In the flowchart shown in FIG. 15, “Panel Side” includes operations conducted inside the display panel 2, and “Recognition Engine Side” includes operations performed by the signal-processing circuit 20 and the control circuit for the entire display device (including the display control circuit 1). That is, the recognition engine refers to a higher-level device controlling the operation of the display panel 2 of the display device of this embodiment.

When the display device is turned ON (step S101), the sensor row driver circuit 7 and the compensating circuit 60 conducts the sensor read-out in the sensor driving mode for one sensor cycle or two or more sensor cycles (step S102). In step S102, sensor outputs Outa and Outb obtained from the first pixel circuit 10a and the second pixel circuit 10b, respectively, are not used for detecting coordinates of locations touched by a finger or the like.

Next, in step S103, ambient brightness is estimated. The ambient brightness estimation process is conducted based on the sensor output Outb (sensor output when the backlight 3 is OFF) obtained from the second pixel circuit 10b in step S102.

In step S104, if the estimated brightness obtained in step S103 is determined to be less than the prescribed reference value, the process proceeds to step S105 to obtain the first correction data Ofst_on and the second correction data Ofst_off, which will be used to correct offset errors (steps S105 to S110). In step S104, if the estimated brightness is determined to be exceeding the prescribed reference value, steps S105 to S110 are bypassed, and the process proceeds to step S111. The reference value in step S103 may be set to 30,000 lux, for example. In consideration of S/N of sensor images, this reference value is preferably set within a range where a favorable S/N can be secured. More preferably, this reference value is changeable as necessary to satisfy required specifications and user preferences.

The reason that the first correction data Ofst_on and the second correction data Ofst_off for correcting the offset errors are not obtained when the estimated brightness exceeds the reference value is the following. When the ambient brightness exceeds the reference value, intense external light entering the sensor pixel circuit when the sensor pixel circuit is reset causes noise, and, as a result, accurate data as the first correction data Ofst_on and the second correction data Ofst_off cannot be obtained.

In step S105, the sensor row driver circuit 7 supplies the driving signal of the first correction data acquisition mode shown in FIG. 10 or FIG. 11 to the sensor pixel circuit. Then, in step S106, the source driver circuit 6 obtains Outa outputted from the first pixel circuit 10a by the driving signal. The output Outa is outputted from the source driver circuit 6 to the signal-processing circuit 20. The signal-processing circuit 20 calculates the difference between the output Outa and the prescribed reference value ref_on, and stores the difference in RAM as the first correction data Ofst_on (step S107).

In step S108, the sensor row driver circuit 7 supplies the driving signal of the second correction data acquisition mode shown in FIG. 10 or FIG. 11 to the sensor pixel circuit. Then, in step S109, the source driver circuit 6 acquires Outb outputted from the second pixel circuit 10b when instructed by the driving signal. The output Outb is outputted from the source driver circuit 6 to the signal-processing circuit 20. The signal-processing circuit 20 calculates the difference between the output Outb and a prescribed reference value ref_off, and stores the difference in RAM as the second correction data Ofst_off (step S110).

In step S105 through step S110, preferably the first correction data Ofst_on and the second correction data Ofst_off are acquired over at least two cycles so that their average values are obtained. The sensor row driver circuit 7 and the like may be designed such that one cycle of reading-out from the sensor pixel circuit can be conducted during one frame (see FIG. 4, for example), but alternatively, the frequency of reading-out from the sensor pixel circuit may be increased such that multiple cycles of reading-out are conducted in one frame period. However, in that case, preferably the first correction data Ofst_on and the second correction data Ofst_off are acquired in the first read-out cycle in a frame period. In that case, preferably the period from time ta to time tc shown in FIG. 3 and FIG. 4, in particular, falls within the vertical retrace period. This is because resetting and reading-out from the sensor pixel circuit are not affected by the data writing to the display pixels.

In step S111, the sensor row driver circuit 7 starts driving sensor in the sensor driving mode shown in FIG. 10 or FIG. 11. After this, from the first pixel circuit 10a and the second pixel circuit 10b of the display panel 2, output Outa and output Outb are obtained when the backlight 3 is ON and when the backlight 3 for sensors is OFF, respectively (step S112).

Once sensor output Outa and sensor output Outb are obtained from all the sensor pixel circuits in the pixel region 4 during one sensor cycle (in the example shown in FIG. 4, one sensor cycle is one frame period), these sensor outputs are sent to the signal-processing circuit 20 through the source driver circuit 6 (step S113).

In step S114, the signal-processing circuit 20 conducts the offset correction on the sensor outputs Outa and Outb obtained in step S113 using the first correction data Ofst_on and the second correction data Ofst_off, respectively. The signal-processing circuit 20 further conducts given image processes such as coordinates detection for the location of a touch by a finger or the like and image recognition using the offset-corrected data.

As described above, in Example 1, when the display device is turned ON, the offset correction is conducted using the first correction data Ofst_on and the second correction data Ofst_off only if the ambient brightness is estimated to be lower than a prescribed value.

Examples 1 to 3 of the offset correction conducted by the signal-processing circuit 20 using the first correction data Ofst_on and the second correction data Ofst_off in step S114 are described below.

### Correction Example 1

In correction example 1, the corrected light sensor signal level R′ is expressed as below, where “B” is the light sensor signal level acquired from the second pixel circuit 10b in the sensor driving mode and “R” is the light sensor signal level acquired from the first pixel circuit 10a in the sensor driving mode.

R′=(R−Ofst_on)−(B−Ofst_off)

With this correction, the offset of the first pixel circuit 10a and the second pixel circuit 10b are cleared, and accurate sensor outputs can be obtained. An additional benefit of the offset elimination is that it expands the dynamic range of the sensor output.

### Correction Example 2

In correction example 2, in the first correction data acquisition mode, a read-out signal having zero amplitude is supplied to obtain a gain correction light sensor signal level W₁ₛₜ, and in the second correction data acquisition mode, a read-out signal having zero amplitude is supplied to obtain a gain correction light sensor signal level W_{2nd}.

Alternatively, in the first correction data acquisition mode, a read-out pulse having a smaller amplitude than the normal read-out signal may be applied to obtain the gain correction light sensor signal level W₁ₛₜ, and in the second correction data acquisition mode, a read-out pulse having a smaller amplitude than the normal read-out signal may be applied to obtain the gain correction light sensor signal level W_{2nd}.

Then, as shown below, corrected light sensor signal level R′ is obtained from the light sensor signal level R acquired from the first pixel circuit 10a in the sensor driving mode, where “L” is the number of gradations of the light sensor signal.

R′=L×{R/(W₁ₛₜ−Ofst_on)−B/(W_{2nd}−Ofst_off)}

Thus, gains of the first pixel circuit 10a and the second pixel circuit 10b can be corrected. An additional benefit of this is that it expands the dynamic range of the sensor output.

### Correction Example 3

In correction example 3, the corrected light sensor signal level R′ is obtained as shown below from the light sensor signal level R acquired from the first pixel circuit 10a in the sensor driving mode, using the light sensor signal level B acquired from the second pixel circuit 10b in the sensor driving mode, the gain correction light sensor signal level W₁ₛₜ and the gain correction light sensor signal level W_{2nd}, and the number of gradations “L” of the light sensor signal.

R′=L×{(R−Ofst_on)/(W₁ₛₜ−Ofst_on)−(B−Ofst_off)/(W_{2nd}−Ofst_off)}

Thus, both the offset and the gain are corrected, and therefore an accurate sensor output with a wide dynamic range can be obtained.

### Example 2

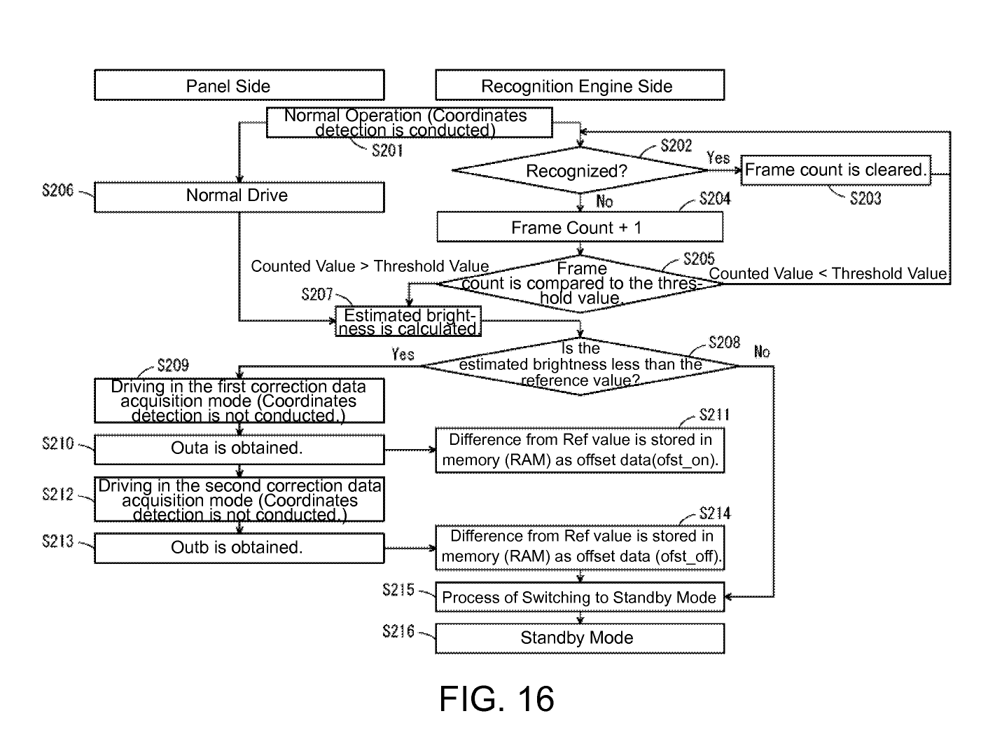

In Example 2, as shown in FIG. 16, the first correction data Ofst_on and the second correction data Ofst_off are updated when the sensor drive mode of the display device switches from the normal mode to the standby mode.

In the example shown in FIG. 16, when the coordinates detection process starts with the normal sensor cycle (step S201), on the display panel 2 side, the sensor row driver circuit 7 reads out the sensor outputs in the sensor driving mode (step S206). At the same time, on the recognition engine side, which includes the signal-processing circuit 20, whether a touch by a finger or the like is recognized or not is determined based on the sensor outputs read out in the step S206 (step S202). Here, if a touch is recognized, (“Yes” in step S202), the frame count is cleared (step S203) and the process returns to step S202. On the other hand, if no touch is recognized in step S202, the frame count is incremented by one (step S204), and the result is compared with a threshold value (step S205). If the frame count is below the threshold value, the process returns to step S202. On the other hand, if the frame count reaches or exceeds the threshold value, the process proceeds to step S207.

Steps S207 to S214 are the same as steps S103 to S110 of Example 1, and therefore descriptions of those steps are omitted.

In step S215, a process of switching from the normal mode to the standby mode is conducted. In step S216, sensor drive starts in the standby mode. In the standby mode, driving signal of the sensor driving mode shown in FIG. 10 and FIG. 11 is used. However, sensor reading-out is conducted less frequently than in the normal mode. Offset correction is performed on the sensor outputs obtained in the standby mode, as described above in correction examples 1 to 3 of Example 1.

In this embodiment, before the process of switching to the standby mode is conducted (step S215), the first correction data and the second correction data are stored in memory in step S214. This way, the correction data can be acquired outside the notice of the user.

### Example 3

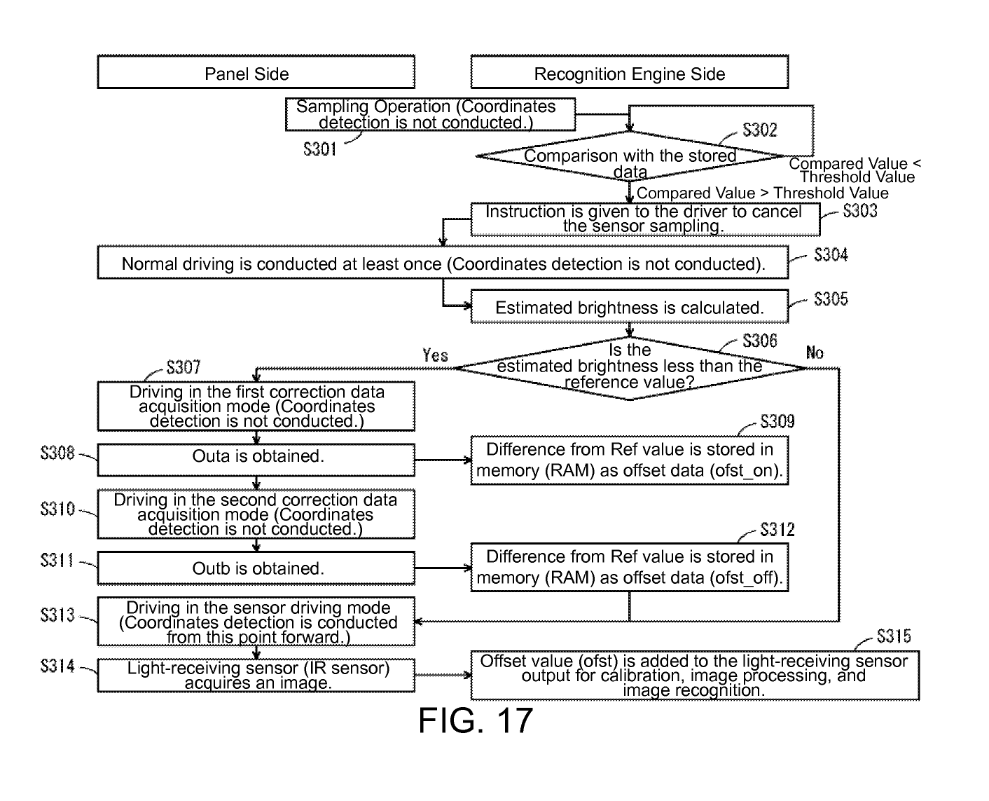

In Example 3, as shown in FIG. 17, the first correction data Ofst_on and the second correction data Ofst_off are updated when the sensor driving mode of the display device switches back from the standby mode to the normal mode.

In the example shown in FIG. 17, in step S301, sampling operation is conducted in the standby mode. Sampling operation refers to the state in which sensor reading out is conducted in, for example, only one out of ten frame periods. Sensor outputs obtained in step S301 are sent to the signal-processing circuit 20, and are compared with the stored data in the signal-processing circuit 20 (step S302). If the difference between the sensor output and the stored data is greater than the threshold value, the process proceeds to step S303. In step S303, the recognition engine instructs the sensor row driver circuit 7 to return from the standby mode to the normal mode.

Steps S304 to S312 are the same as steps S102 to S110 of Example 1, and therefore descriptions of them are omitted.

Next, in step S313, the sensor row driver circuit 7 resumes operation in the sensor driving mode with the normal sensor cycle. That is, reading-out from the sensors is conducted, for example, once in a frame period. Step S314 and step S315 are the same as step S113 and step S114 of Example 1, and therefore descriptions of them are omitted.

Thus, when the operation returns from the standby mode to the normal mode, the first correction data Ofst_on and the second correction data Ofst_off are updated, so that any offset caused by environmental changes occurred during the standby mode (temperature change, for example) can be corrected shortly after the return to the normal mode.

### Example 4

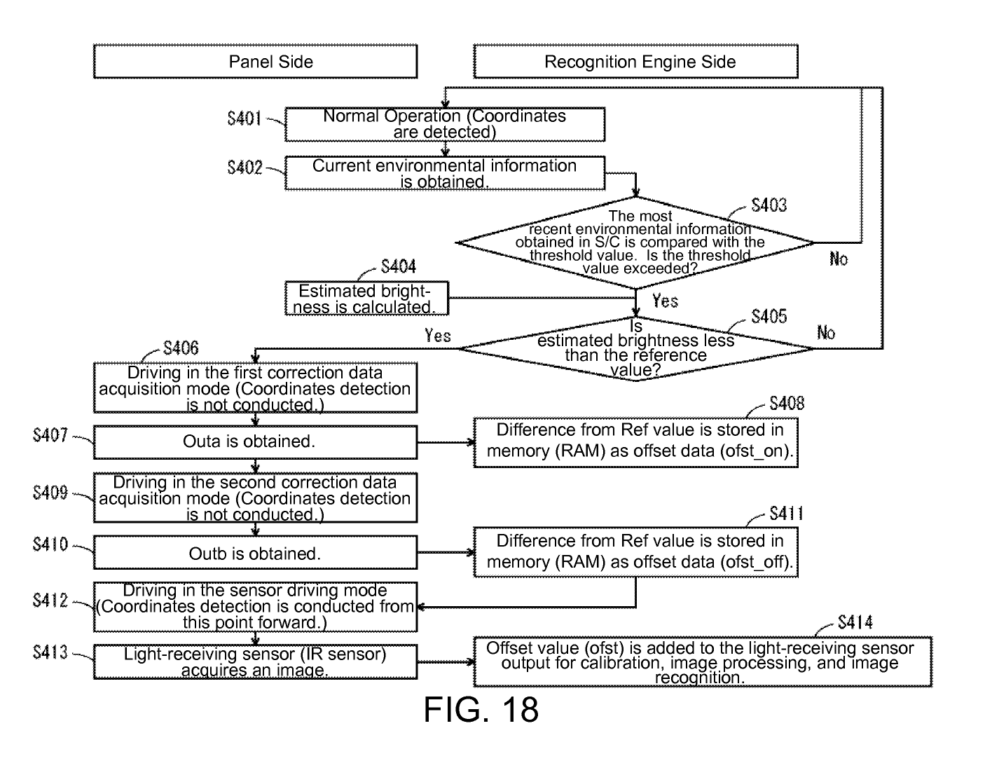

In Example 4, as shown in FIG. 18, operating environment is monitored for a change, and if a change in the operating environment that exceed the prescribed range is detected, the first correction data Ofst_on and the second correction data Ofst_off are updated.

In step S401, coordinates are detected in the sensor driving mode. Once one sensor cycle of the sensor read-out is completed, environmental information is obtained in step S402 by various sensors provided in the display device. The environmental information obtained includes temperature, brightness of the backlight, total usage time of the display device, and brightness of external light, for example. The environmental information, however, is not limited to the examples listed above. Any environmental information that can be detected with publicly known sensors can also be used. Also, only one kind of environmental information or more than one kinds of environmental information may be used.

In step S403, which is the next step, the value of the environmental information obtained in step S402 is compared to the value of the environmental information obtained and stored when steps S406 to S411, which are described below, were last conducted. If the difference between these values does not exceed the threshold value, the process returns to step S401, and if the difference exceeds the threshold value, the process proceeds to step S404.

Steps S404 to S411 are the same as steps S103 to S110 of Example 1, and therefore descriptions of them are omitted. Also, steps S412 to S414 are the same as steps S112 to S114 of Example 1, and therefore descriptions of them are omitted.

Thus, in Example 4, the offset resulted from the environmental change can be corrected quickly by updating the first correction data Ofst_on and the second correction data Ofst_off when there is a change in the environmental information that exceeds a prescribed range.

<Correction Using Correction Data Obtained Prior to Shipping from the Factory>

Prior to shipping from the factory, a liquid crystal display device according to this embodiment conducts the sensor driving in the sensor driving mode and the first correction data acquisition mode with the ambient environment controlled to provide a prescribed condition. The luminance data thus obtained is stored in memory. That is, with the temperature condition set to a prescribed temperature, the luminance of the display backlight set to a prescribed brightness, and the environmental light (external light) completely blocked, sensor driving is conducted in the sensor driving mode and in the first correction data acquisition mode. Luminance data obtained through A/D conversion of the panel output V_{Black} acquired during the sensor driving mode operation is noted as B_{1st.ini}. Luminance data obtained through A/D conversion of the panel output V_{Black} acquired during the first correction data acquisition mode operation is noted as B_{2nd.ini}. These luminance data is stored in a memory such as the memory in the signal-processing circuit 20.

Similarly, prior to the shipping from the factory, sensor driving is conducted in the sensor driving mode and in the second correction data acquisition mode with the ambient environment controlled to provide a prescribed condition, and the luminance data obtained is stored in the memory. That is, with the temperature condition set to a prescribed temperature, the luminance of the display backlight set to a prescribed brightness, and with the maximum illuminance light within the specification of the display device projected as the environmental light (external light), sensor driving is conducted in the sensor driving mode and in the second correction data acquisition mode. Luminance data obtained through A/D conversion of the panel output V_{White} acquired during the panel output sensor driving mode operation is noted as W_{1st.ini}. Luminance data obtained through A/D conversion of the panel output V_{White} acquired during the second correction data acquisition mode operation is noted as W_{3rd.ini}. These luminance data are also stored in a memory such as the memory in the signal-processing circuit 20.

Here, the correction process conducted on the light sensor signal obtained in the sensor driving mode by the signal-processing circuit 20 is described. The correction process is conducted pixel by pixel using the equation below. That is, corrected data R″, which is corrected with the correction data acquired prior to shipping from the factory, is obtained as follows, where R′ is the luminance data corrected with the first correction data Ofst_on and the second correction data Ofst_off as described above.

R″=L×[R′−{B−(B_{2nd.ini}−B_{1st.ini})}]/[(W_{3rd.ini}−W_{1st.ini})−{B−(B_{2nd.ini}−B_{1st.ini})}]

Here, “L” is the number of gradations of the luminance data. L=256 when the A/D converter output of the signal-processing circuit 20 is 8 bits.

Thus, offset errors can be cleared by further correcting the sensor output using the correction data obtained with the ambient environment controlled to provide a prescribed condition prior to shipping from the factory.

### Embodiment 2

Embodiment 2 of the display device of the present invention is described below.

The display device of Embodiment 2 includes a light-shielded reference pixel circuit, which is shielded from light and disposed in some pixels in the pixel region 4. In addition to the above-mentioned correction function in which the first correction data Ofst_on and the second correction data Ofst_off are used, the display device of Embodiment 2 also has a function of adjusting the potential of the sensor driving signal based on the discrepancy level between the sensor signal outputted from the light-shielded reference pixel circuit and the standard offset value.

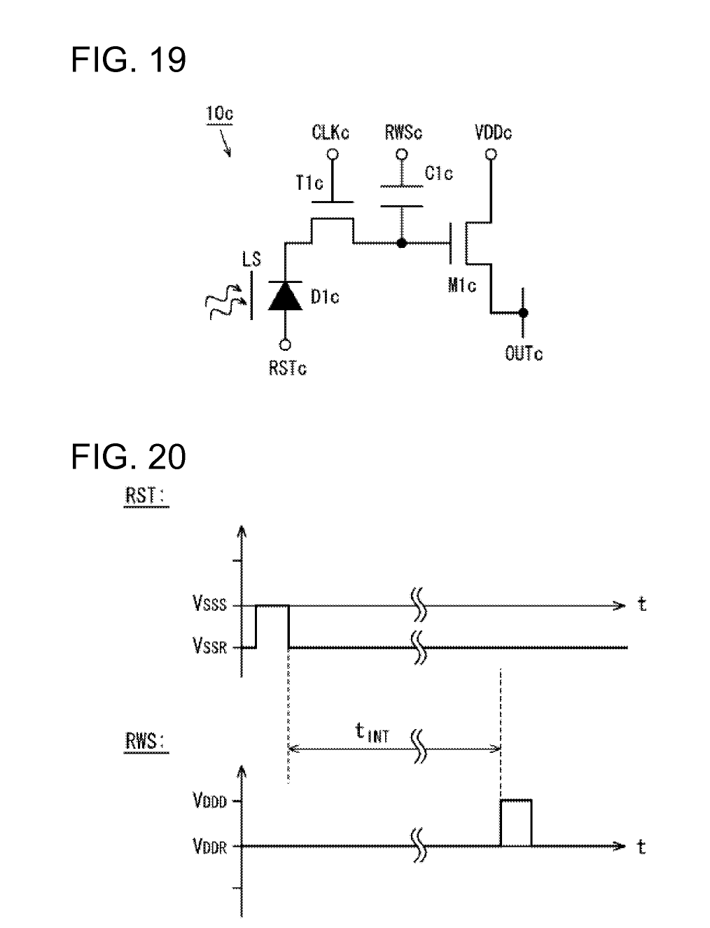

FIG. 19 is a diagram of an equivalent circuit of the light-shielded reference pixel circuit 10c. As understood by comparing FIG. 6 and FIG. 19, the light-shielded reference pixel circuit 10c has the same configuration as the first pixel circuit 10a and the second pixel circuit 10b except that the light-shielded reference pixel circuit 10c includes a light-shielding film LS. A photodiode D1c of the light-shielded reference pixel circuit 10c, a photodiode D1a of the first pixel circuit 10a, and a photodiode D1b of the second pixel circuit 10b are designed to have the same I-V characteristics. Also, the light-shielding film LS needs to be disposed to cover at least the light-detecting section of the photodiode D1c. The light-shielding film LS may also be disposed to cover the entire light-shielded reference pixel circuit 10c, or the entire pixel including the light-shielded reference pixel circuit 10c.

Any number of the light-shielded reference pixel circuits 10c may be disposed anywhere in the pixel region 4. For example, the light-shielded reference pixel circuits 10c may be disposed in pixels located in the frame section of the pixel region 4. Alternatively, the light-shielded reference pixel circuits 10c may be disposed in pixels arranged along one side or both sides of the pixel region 4 in the row direction or in the column direction. Another alternative configuration is that the first pixel circuits 10a, the second pixel circuits 10b, and the light-shielded reference pixel circuits 10c are arranged regularly over the entire pixel region 4.

FIG. 20 shows timing charts respectively illustrating the waveforms of a reset signal RST and a read-out signal RWS, which are supplied to the first pixel circuit 10a, the second pixel circuit 10b, and the light-shielded reference pixel circuit 10c in the default condition (before correction).

In the example shown in FIG. 20, a high-level V_{RST.H} of the reset signal RST is a constant voltage V_{SSS} (0V, for example), and a low-level V_{RST.L} is a constant voltage V_{SSR} (−4V, for example). Also, a high-level V_{RWS.H} of the read-out signal RWS is a constant voltage V_{DDD} (8V, for example), and a low-level V_{RWS.L} is a constant voltage V_{DDR} (0V, for example). Also in the example of FIG. 20, the high-level V_{RST.H} (V_{SSS}) of the reset signal and the low-level V_{RWS.L} (V_{DDR}) of the read-out signal are the same potential (0V). However, these voltages are only examples. Individual potential levels may be set as appropriate.

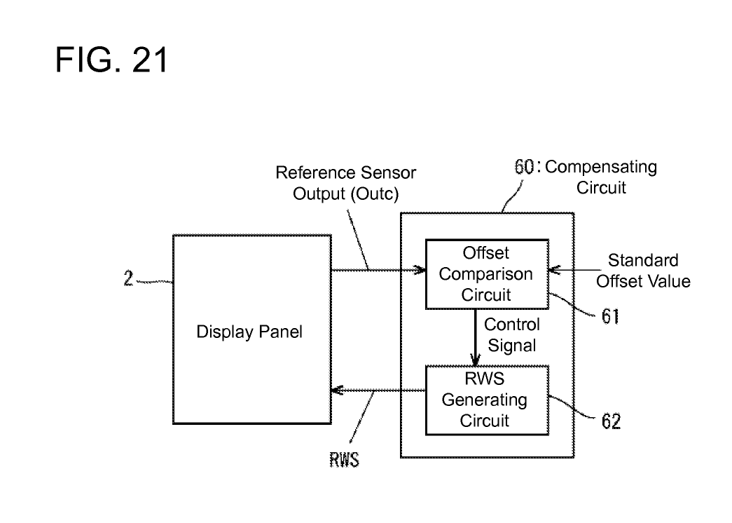

The display device of this embodiment includes a compensating circuit 60, which is shown in FIG. 21. Although in the example shown in FIG. 21, the compensating circuit 60 is disposed outside the display panel 2 (in the signal-processing circuit 20, for example), alternatively it may be disposed in the sensor row driver circuit 7. The compensating circuit 60 includes an offset comparison circuit 61 and an RWS generating circuit 62 (driving signal generating circuit). The offset comparison circuit 61 compares an output signal voltage Outc from the light-shielded reference pixel circuit 10c and a predetermined standard offset value to obtain the discrepancy level between them, and outputs a control signal appropriate for the obtained discrepancy level to the RWS generating circuit 62. Based on the control signal from the offset comparison circuit 61, the RWS generating circuit 62 controls the amplitude of the read-out signal (RWS).

A more specific example is described below. Prior to shipping from the factory, for example, a standard offset value is stored in the offset comparison circuit 61, which standard offset value is A/D converted value of the output signal voltage obtained from the light-shielded reference pixel circuit 10c when ambient environmental parameters including the temperature and illuminance, for example, were set to provide a prescribed condition. There is no particular limitation to the temperature and illuminance used to obtain the standard offset value. Regarding the illuminance, however, the sensor output characteristics against the illuminance is preferably linear (including 0 lux, at which there is no incoming light).

The offset comparison circuit 61 determines the discrepancy level between an A/D converted value (gradation data) of the inputted output signal voltage Outc (output from the light-shielded reference pixel circuit 10c) and the above-mentioned standard offset value. In this embodiment, the output signal voltage Outc from the light-shielded reference pixel circuit 10c is obtained without turning ON the backlight 3. Thus, data for the output signal voltage Outc is preferably obtained without turning the backlight 30N. Alternatively, however, the system may be configured such that the output signal voltage Outc obtained from the light-shielded reference pixel circuit 10c while the backlight 3 is ON is used.

The offset comparison circuit 61 stores a function or a look-up table that, when the discrepancy level between the above-mentioned gradation data and the standard offset value is inputted, for example, outputs an adjusted amplitude value of the read-out signal as a control signal. The offset comparison circuit 61 uses this function or the table to output a control signal (adjusted amplitude value of the read-out signal) appropriate for the discrepancy level between the gradation data of the output signal voltage Outc of the light-shielded reference pixel circuit 10c and the standard offset value.

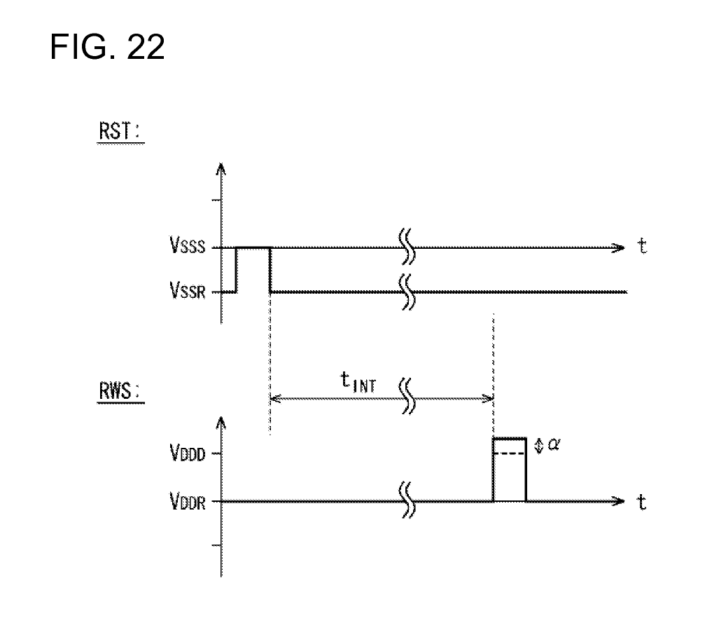

FIG. 22 is a waveform diagram showing an example of the read-out signal RWS that has been adjusted by the compensating circuit 60. As shown in FIG. 22, the RWS generating circuit 62 increases the amplitude of the read-out signal (V_{RWS.H}−V_{RWS} by α by increasing the potential of the high-level V_{RWS.H} of the read-out signal by α over V_{DDD}, which is the potential before correction (see FIG. 20). The offset potential a is the value determined by the offset comparison circuit 61 in accordance with the discrepancy level between the output signal voltage Outc of the light-shielded reference pixel circuit 10c and the standard offset value.

For example, α can be determined based on the equation shown below.

α=−(OF_{—}st−OF_mid)/Av×(SVDD/1024)

Here, SVDD is 5.3V±0.1V, for example. Av is an amplification factor, and may be 3.0, for example, but it is adjustable as a parameter. OF_mid is the center value of the outputs from the light-shielded reference pixel circuit (value at 50% from the top). OF_st may be 300/1024 gradations, for example, but it is adjustable as a parameter.

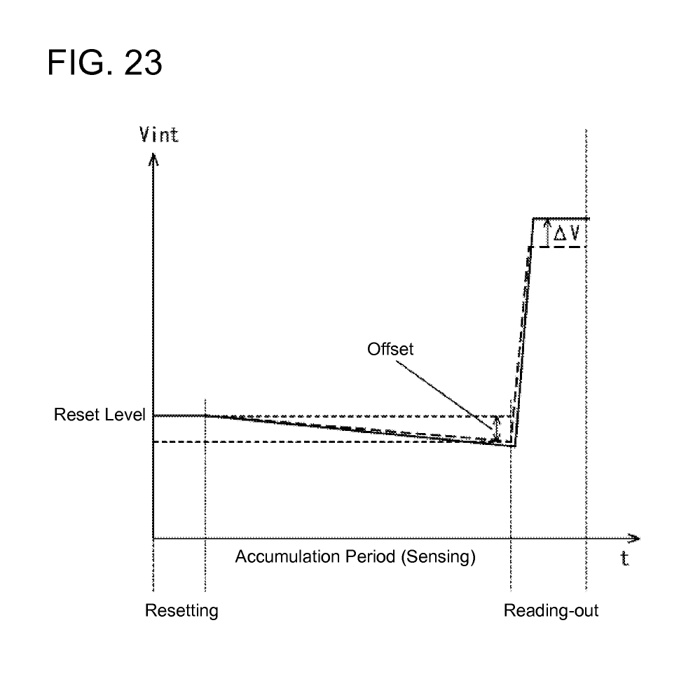

FIG. 23 is a signal waveform diagram showing the V_{INT} potential change in the first pixel circuit 10a and in the second pixel circuit 10b when the high-level V_{RWS.H} potential of the read-out signal is V_{DDD} (broken line), and the V_{INT} potential change in the first pixel circuit 10a and in the second pixel circuit 10b when the potential of the high-level V_{RWS.H} of the read-out signal is (V_{DDD}+α) (solid line). As shown in FIG. 23, by setting the high-level V_{RWS.H} potential of the read-out signal to (V_{DDD}+a), the V_{INT} potential in the first pixel circuit 10a and in the second pixel circuit 10b increases by voltage ΔV, which corresponds to the offset α.

As described above, by setting the high-level V_{RWS.H} potential of the read-out signal to (V_{DDD}+a) in accordance with the discrepancy level between the gradation data of the output signal voltage Outc of the light-shielded reference pixel circuit 10c and the standard offset value, signals whose offset has been cleared, where the offset is caused by dark current and the like, can be obtained as the output signal voltages Outa and Outb in the first pixel circuit 10a and the second pixel circuit 10b, respectively.

In the example of FIG. 22, by changing the high-level V_{RWS.H} potential of the read-out signal from V_{DDD} to (V_{DDD}+α), the amplitude of the read-out signal is increased by α. However, the same effect can also be obtained by changing the low-level V_{RWS.L} potential of the read-out signal from V_{SSR} to (V_{SSR}−α), because this too increases the amplitude of the read-out signal by α.

In Embodiment 1, correction of the amplitude of the read-out signal RWS based on the output signal voltage Outc of the light-shielded reference pixel circuit 10c, which is described above, is preferably conducted, for example, in step S102 of Example 1 shown in FIG. 15, in step S206 of Example 2 shown in FIG. 16, and in step S304 of Example 3 shown in FIG. 17.

Also, in step S103 shown in FIG. 15, in order to estimate an ambient brightness, preferably the output signal Outc obtained from light-shielded reference pixel circuit 10c in step S102 is subtracted from the sensor output Outb (sensor output when the backlight 3 is OFF) obtained from the second pixel circuit 10b in step S102. This way, the noise component caused by the dark current is eliminated, and therefore the ambient brightness can be estimated more accurately. The same applies to step S207 of FIG. 16 and step S305 of FIG. 17.

In Embodiment 2, as described above, the amplitude of the read-out signal is adjusted in accordance with the discrepancy level between the gradation data of the output signal voltage Outc of the light-shielded reference pixel circuit 10c and the standard offset value. As a result, a signal cleared of offset caused by dark current and the like can be obtained as the sensor output that is driven based on the adjusted read-out signal.

Also, this embodiment does not cause the problem of narrowed dynamic range of the sensor output, because the output of the light-shielded reference pixel circuit is not subtracted from the sensor output. As a result, a display device equipped with light sensors that can accurately detect the external light intensity without being influenced by the environmental temperature and that retain a wide dynamic range can be realized.

### Modification 1 of Embodiment 2

Modification 1 of Embodiment 2 of the present invention is described below.

Similar to Embodiment 2, a display device of this modification includes a light-shielded reference pixel circuit, which is shielded from light and disposed in some pixels in the pixel region 4. In addition to the correction function in which the above-mentioned first correction data Ofst_on and the second correction data Ofst_off are used, the display device of this modification has a function of adjusting the potential of the sensor driving signal based on the discrepancy level between the sensor signal outputted from the light-shielded reference pixel circuit and the standard offset value.

However, the display device of this modification is different from the display device of Embodiment 2 in that the display device of this modification uses a variable capacitance as the capacitance of the sensor pixel circuit, and the compensating circuit 60 adjusts the low-level potential of the read-out signal, instead of adjusting the amplitude of the read-out signal.

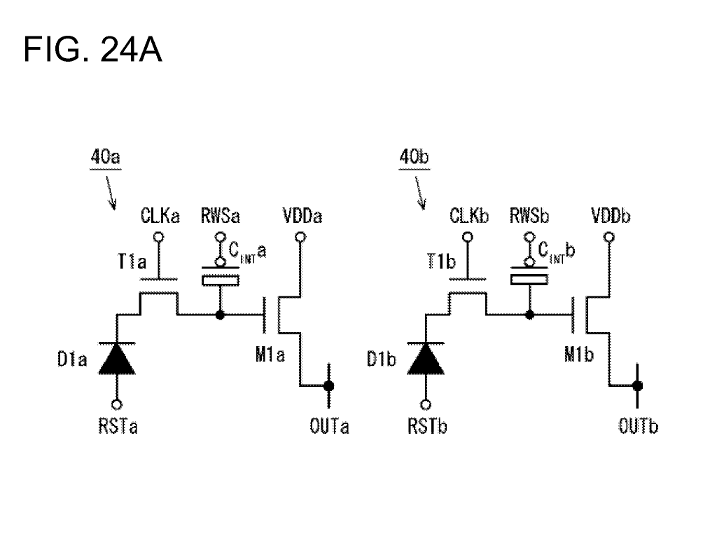

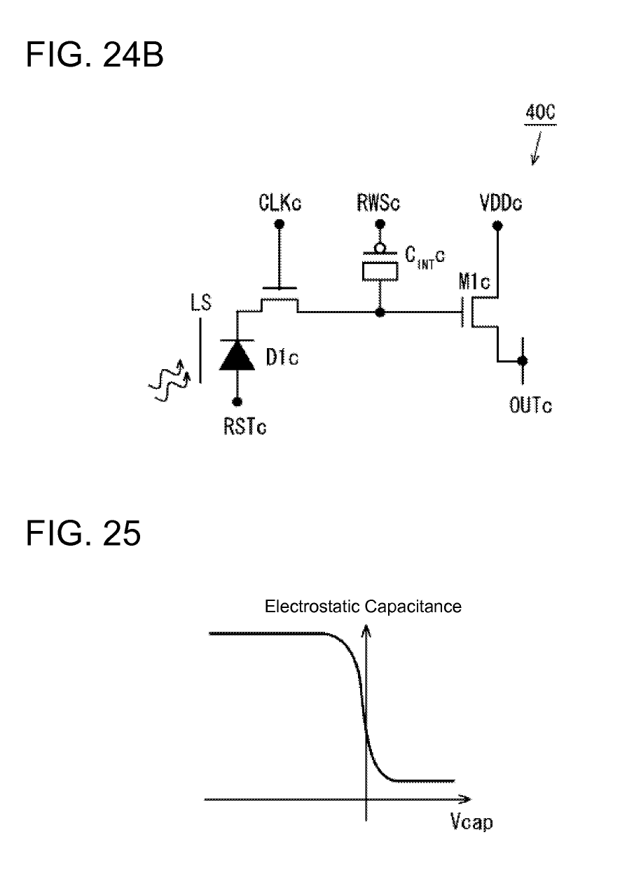

The display device of this modification includes a first pixel circuit 40a and a second pixel circuit 40b shown in FIG. 24A instead of the first pixel circuit 10a and the second pixel circuit 10b of Embodiment 2. It also includes a light-shielded reference pixel circuit 40c shown FIG. 24B instead of the light-shielded reference pixel circuit 10c of Embodiment 2. As shown in FIG. 24A and FIG. 24B, the sensor pixel circuit of Modification 2 includes variable capacitances C_{INT}a, C_{INT}b, and C_{INT}c. In the following description, unless particularly necessary, these variable capacitances are collectively noted as C_{INT}. As the variable capacitance C_{INT}, a p-channel MOS capacitor, an n-channel MOS capacitor, or the like may be used.

As understood by comparing FIG. 24A and FIG. 24B, the light-shielded reference pixel circuit 40c has the same configuration as the first pixel circuit 40a and the second pixel circuit 40b except that the light-shielded reference pixel circuit 40c includes a light-shielding film LS. A photodiode D1c of the light-shielded reference pixel circuit 40c, a photodiode D1a of the first pixel circuit 40a, and a photodiode D1b of the second pixel circuit 40b are designed to have the same I-V characteristics. Also, the light-shielding film LS needs to be disposed to cover at least the light-detecting section of the photodiode D1c. The light-shielding film LS may also be disposed to cover the entire light-shielded reference pixel circuit 40c, or the entire pixel including the light-shielded reference pixel circuit 40c.

Any number of the light-shielded reference pixel circuits 40c may be disposed anywhere in the pixel region 4. For example, the light-shielded reference pixel circuits 40c may be disposed in pixels located in the frame section of the pixel region 4. Alternatively, the light-shielded reference pixel circuits 40c may be disposed in pixels arranged along one side or both sides of the pixel region 4 in the row direction or in the column direction. Another alternative configuration is that the first pixel circuits 40a, the second pixel circuits 40b, and the light-shielded reference pixel circuits 40c are arranged regularly over the entire pixel region 4.

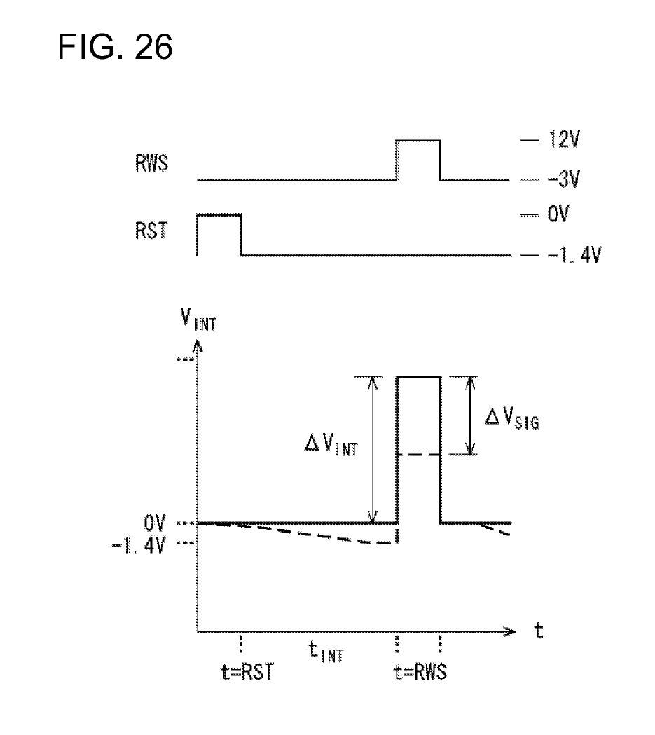

FIG. 25 shows the C-V characteristics of a variable capacitance C_{INT}. In FIG. 25, the horizontal axis represents the inter-electrode voltage V_{CAP} of the variable capacitance C_{INT}, and the vertical axis represents the electrostatic capacitance. As shown in FIG. 25, the variable capacitance C_{INT} maintains a stable electrostatic capacitance when the inter-electrode voltage V_{CAP} is small. The electrostatic capacitance, however, changes rapidly immediately before and immediately after the inter-electrode voltage V_{CAP} threshold. Therefore, the characteristics of the variable capacitance C_{INT} can be dynamically changed by the potential of the read-out signal supplied from the wiring RWS. By using the variable capacitance C_{INT} having such characteristics, the light sensor according to this modification can, as shown in FIG. 26, amplify and read out changes in potential at the accumulation node during the accumulation period t_{INT}.

In the example shown in FIG. 26, which is merely one specific example, the low-level V_{RST.L} of the reset signal is −1.4V, and the high-level V_{RST.H} of the reset signal is 0V. Also, the low-level V_{RWS.L} of the read-out signal is −3V, and the high-level V_{RWS.H} of the read-out signal is 12V. In FIG. 26, the waveform shown in solid lines represents the change in the potential V_{INT} when only a small amount of light enters the photodiode D1, and the waveform shown in broken lines represents the change in the potential V_{INT} when the saturating level of light enters the photodiode D1. ΔV_{SIG} is the difference in potential, which is proportional to the amount of light entering the photodiode D1. In the light sensor according to this modification, when the saturation level light enters the sensor, the change in the potential at the accumulation node during the accumulation period t_{INT} is relatively small, but during the reading-out period (while the potential of the read-out signal is high-level V_{RWS.H}), the potential V_{INT} of this accumulation node is amplified and read out.

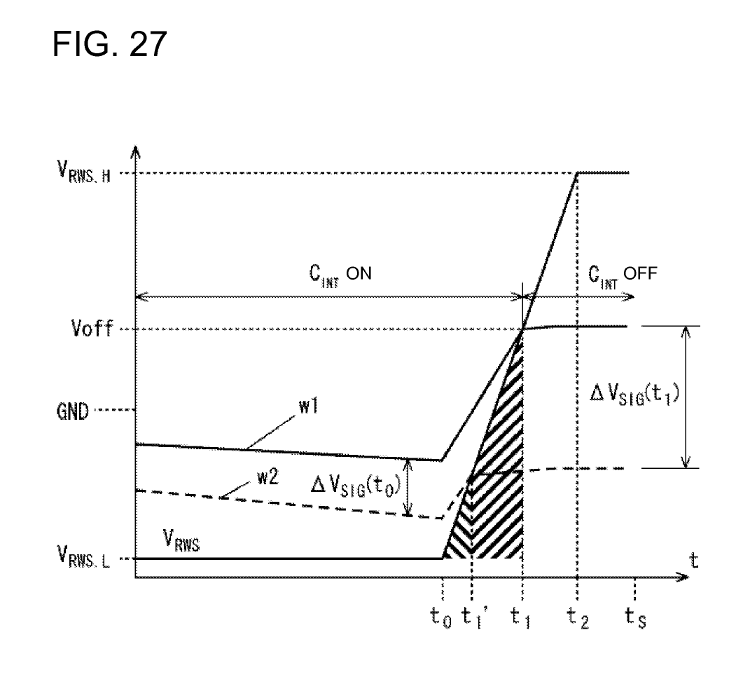

Here, with reference to FIG. 27, the reading-out operation by the sensor pixel circuit according to this modification is described in detail. FIG. 27 is a waveform diagram showing the change in the potential V_{INT} at the accumulation node over the time from the end of the accumulation period to the reading-out period. In FIG. 27, a waveform w1 of a solid line represents the change in the potential V_{INT} when only a small amount of light enters the photodiode D1, and a waveform w2 of a broken line represents the change in the potential V_{INT} when light enters the photodiode D1. Time t0 is the time at which the read-out signal supplied from the wiring RWS starts to rise from the low-level V_{RWS.L}, and time t2 is the time at which the read-out signal reaches the high-level V_{RWS.H}. Time tS is the time at which the transistor M2 turns ON and the sampling of the sensor output is conducted. Time t1 is the time at which the read-out signal reaches the threshold voltage V_{off} of the variable capacitance C_{INT}. Time t1′ is the time at which the read-out signal reaches the threshold voltage V_{off} of the variable capacitance C_{INT} when light enters the photodiode D1 (in the case of the waveform w2). That is, the operating characteristics of the variable capacitance C_{INT} change in accordance with the magnitude relationship between the potential supplied from the read-out wiring RWS and the threshold voltage V_{off}.

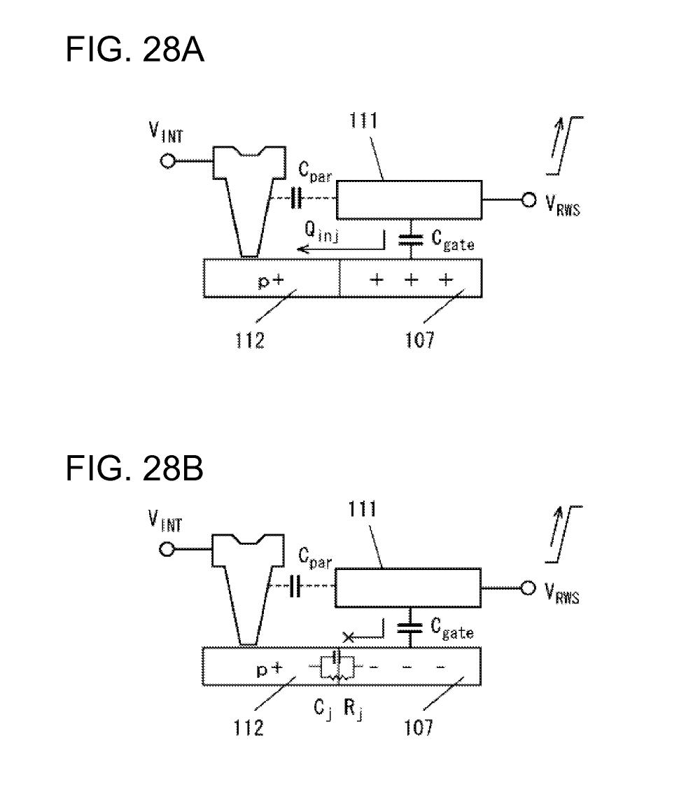

FIG. 28A and FIG. 28B are cross-sectional views showing different ways that electrical charges move depending on the potential of the gate electrode in a variable capacitance C_{INT} when the variable capacitance C_{INT} is constituted of a p-channel MOS capacitor. As shown in FIG. 28A and FIG. 28B, the variable capacitance C_{INT} is constituted of a gate electrode 111, an n− region 107 formed into a silicon film, and an insulating film (not shown) formed between them. A region 112 shown in FIG. 28A and FIG. 28B is a p+ region formed by doping a p-type impurity such as boron into an n-type silicon film.

As shown in FIG. 27, FIG. 28A, and FIG. 28B, the variable capacitance C_{INT} is always ON before time t1, and becomes OFF after time t1. That is, when the potential of the wiring RWS is not higher than the threshold voltage V_{off}, as shown in FIG. 28A, electrical charges Qᵢₙⱼ under the gate electrode 111 move. On the other hand, when the potential of the wiring RWS exceeds the threshold voltage V_{off}, as shown in FIG. 28B, charges Qᵢₙⱼ under the gate electrode 111 stop moving. Thus, the potential V_{INT} (ts) at the accumulation node at sample time ts after the potential of the read-out signal supplied from the read-out wiring RWS reaches the high-level V_{RWS.H} is obtained in the manner expressed by the equation below. ΔV_{INT} shown in FIG. 26 corresponds to the difference between V_{INT} (t0) and V_{INT} (ts), and is equal to Qᵢₙⱼ/C_{INT}.

$$\begin{matrix}{V}_{INT} ( {t}_{S} ) = {V}_{INT} ( {t}_{0} ) + \frac{{Q}_{inj}}{{C}_{TOTAL}} \\ = {V}_{INT} ( {t}_{0} ) + \int \frac{{C}_{INT}}{{C}_{TOTAL}} \cdot d V \\ = {V}_{INT} ( {t}_{0} ) + \\ [ \begin{matrix}{\int }_{{V}_{RWS} ( L )}^{Voff} \frac{{C}_{INT}}{{C}_{INT} + {C}_{TFT} + {C}_{DIODE}} \cdot d V + \\ {\int }_{{V}_{off}}^{{V}_{RWS} ( H )} \frac{{C}_{{INT}^{′}}}{{C}_{{INT}^{′}} + {C}_{TFT} + {C}_{DIODE}} - . d V\end{matrix} ] ,\end{matrix} \\ where \\ {C}_{INT} = {C}_{par} + {C}_{gate} \\ {C}_{{INT}^{′}} = {C}_{par} + \frac{{C}_{gate} \cdot {C}_{j}}{{C}_{gate} + {C}_{j}} . \qquad < Equation 1 >$$

As shown in FIG. 27, according to this modification, ΔV_{SIG} (t0) towards the end of the accumulation period is amplified to ΔV_{SIG} (t1). Thus, the difference in potential at the accumulation node after the sharp rise becomes larger than the difference in potential at the accumulation node at the end of the accumulation period due to the luminance difference on the light-receiving surface. For example, the difference between the potential at the accumulation node after the sharp rise during the reading-out period in a dark condition and the potential at the accumulation node after the sharp rise during the reading-out period when the saturation level light is received is larger than the difference between the potential at the accumulation node at the end of the accumulation period in the dark condition and the potential at the accumulation node at the end of the accumulation period when the saturation level light is received. As a result, a light sensor having a high sensitivity and a high S/N ratio can be realized.

The light-shielded reference pixel circuit 40c in this modification is blocked from the external light, and therefore detects only the dark current component generated by the temperature change, ambient light (backlight and the like), or aging.

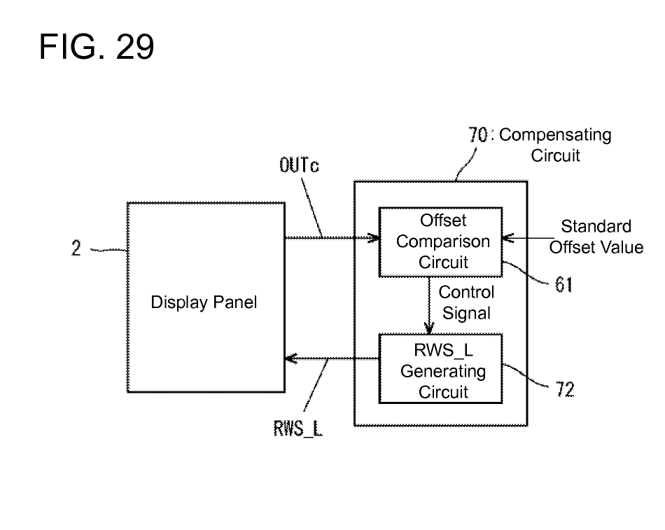

FIG. 29 is a block diagram schematically showing the configuration of the compensating circuit 70 of this modification. Although in the example shown in FIG. 29, the compensating circuit 70 is disposed outside the display panel 2 (in the signal-processing circuit 20, for example), alternatively it may be disposed in the sensor row driver circuit 7. The compensating circuit 70 includes an offset comparison circuit 61 and an RWS_L generating circuit 72. The offset comparison circuit 61 compares an output signal voltage OUTc from the light-shielded reference pixel circuit 40c and a predetermined standard offset value to obtain the discrepancy level between them, and outputs a control signal appropriate for the obtained discrepancy level to the RWS_L generating circuit 72. Based on the control signal from the offset comparison circuit 61, the RWS_L generating circuit 72 controls the low-level potential (V_{RWS.L}) of the read-out signal (RWS). More specifically, the V_{RWS.L} potential is lowered by α in accordance with the discrepancy level between the output signal OUTc of the light-shielded reference pixel circuit 40c and the standard offset value. That is, the offset potential a is the value determined by the offset comparison circuit 61 in accordance with the discrepancy level between the output signal OUTc of the light-shielded reference pixel circuit 40c and the standard offset value.

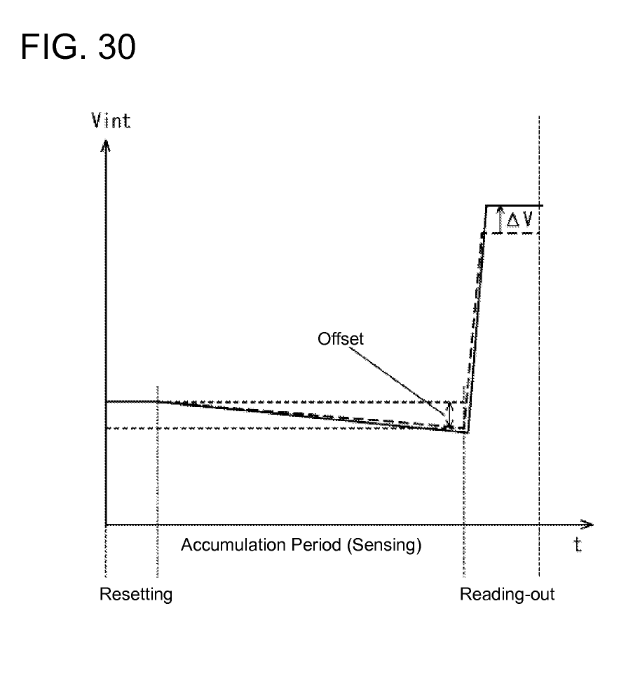

FIG. 30 is a signal waveform diagram showing V_{INT} potential change before correction by the compensating circuit 70 (broken line), and V_{INT} potential change when the potential of the low-level V_{RWS.L} of the read-out signal is lowered by α (solid line). As shown in FIG. 30, by lowering the potential of the low-level V_{RWS.L} of the read-out signal by α, the V_{INT} potential increases by voltage ΔV, which corresponds to the offset α.

As described above, in addition to the correction function in which the first correction data Ofst_on and the second correction data Ofst_off are used, this modification has a function of adjusting the low-level potential of the read-out signal in accordance with the discrepancy level between the gradation data of the output signal voltage OUTc of the light-shielded reference pixel circuit 40c and the standard offset value. Thus, in accumulation periods after this, signals whose offset has been cleared, where the offset is caused by dark current and the like, can be obtained as the output signal voltage from the first pixel circuit 40a and the second pixel circuit 40b driven based on the corrected read-out signal.

In Embodiment 1, correction of the low-level V_{RWS.L} of the read-out signal RWS based on the output signal voltage Outc of the light-shielded reference pixel circuit 40c, which is described above, is preferably conducted, for example, in step S102 of Example 1 shown in FIG. 15, in step S206 of Example 2 shown in FIG. 16, and in step S304 of Example 3 shown in FIG. 17.

Also, in step S103 shown in FIG. 15, in order to estimate an ambient brightness, preferably the output signal Outc obtained from the light-shielded reference pixel circuit 40c in step S102 is subtracted from the sensor output Outb obtained from the second pixel circuit 40b in step S102. As a result, because any noise component due to the dark current is eliminated this way, the ambient brightness can be estimated more accurately. The same applies to step S207 of FIG. 16 and step S305 of FIG. 17.

In Modification 1 of Embodiment 2, as described above, the amplitude of the read-out signal is adjusted in accordance with the discrepancy level between the gradation data of the output signal voltage Outc of the light-shielded reference pixel circuit 40c and the standard offset value. This way, a signal whose offset has been cleared, where the offset is caused by dark current and the like, can be obtained as the sensor output that is driven based on the adjusted read-out signal.

Also, this embodiment does not cause the problem of narrowed dynamic range of the sensor output, because the output of the light-shielded reference pixel circuit is not subtracted from the sensor output. As a result, a display device equipped with light sensors that can accurately detect the external light intensity without being influenced by the environmental temperature and that retain a wide dynamic range can be realized.

### Modification 2 of Embodiment 2

Modification 2 of Embodiment 2 of the present invention is described below.

In a display device according to this modification, the configuration of sensor pixel circuits (first pixel circuit 10a, second pixel circuit 10b, and light-shielded reference pixel circuit 10c) is similar to that of Embodiment 2. However, the display device of Modification 2 is different from Embodiment 2 regarding the configuration of the compensating circuit. That is, instead of the compensating circuit 60 that adjusts the amplitude of the read-out signal RWS of Embodiment 2, the display device of this modification includes a compensating circuit 80 that adjusts high-level potential of the reset signal.

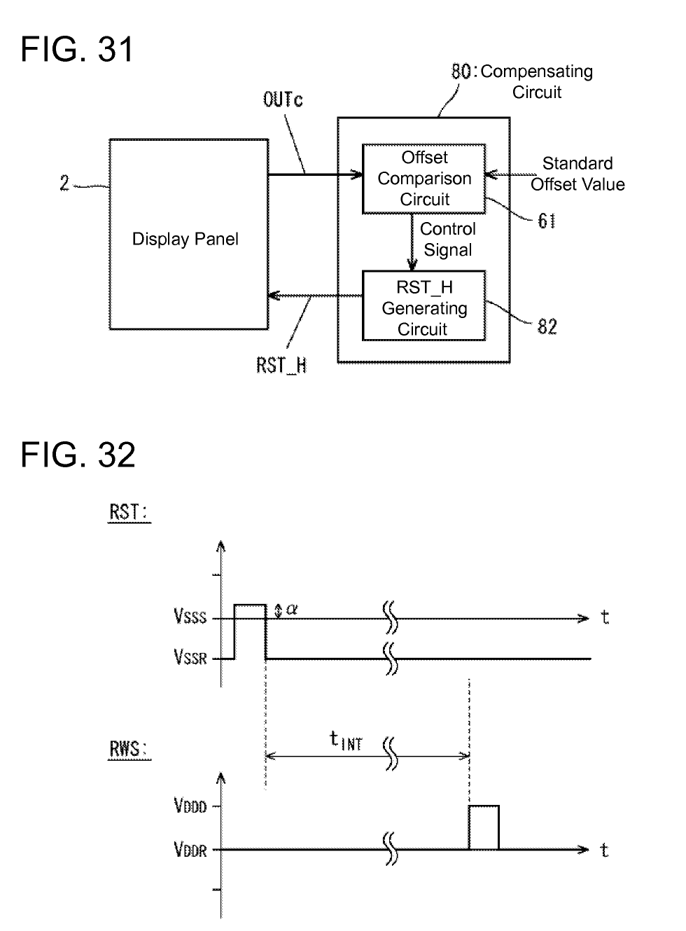

FIG. 31 is a block diagram schematically showing the configuration of the compensating circuit 80 of this modification. Although in the example shown in FIG. 31, the compensating circuit 80 is disposed outside the display panel 2 (in the signal-processing circuit 20, for example), alternatively it may be disposed in the sensor row driver circuit 7. The compensating circuit 80 includes an offset comparison circuit 61 and an RST_H generating circuit 82. The offset comparison circuit 61 compares the output signal voltage Outc from the light-shielded reference pixel circuit 10c and a predetermined standard offset value to obtain the discrepancy level between them, and outputs a control signal representing the obtained discrepancy level to the RST_H generating circuit 82. RST_H generating circuit 82 adjusts the high-level potential (V_{RST.H}) of the reset signal based on the control signal from the offset comparison circuit 61.

FIG. 32 is a waveform diagram showing an example of the read-out signal adjusted by the compensating circuit 80. As shown in FIG. 32, the RST_H generating circuit 82 increases the high-level potential V_{RST.H} of the reset signal by α over V_{SSS}, the potential before correction (see FIG. 20). The offset potential α is the value determined by the offset comparison circuit 61 in accordance with the discrepancy level between the output signal voltage Outc of the light-shielded reference pixel circuit 10c and the standard offset value.

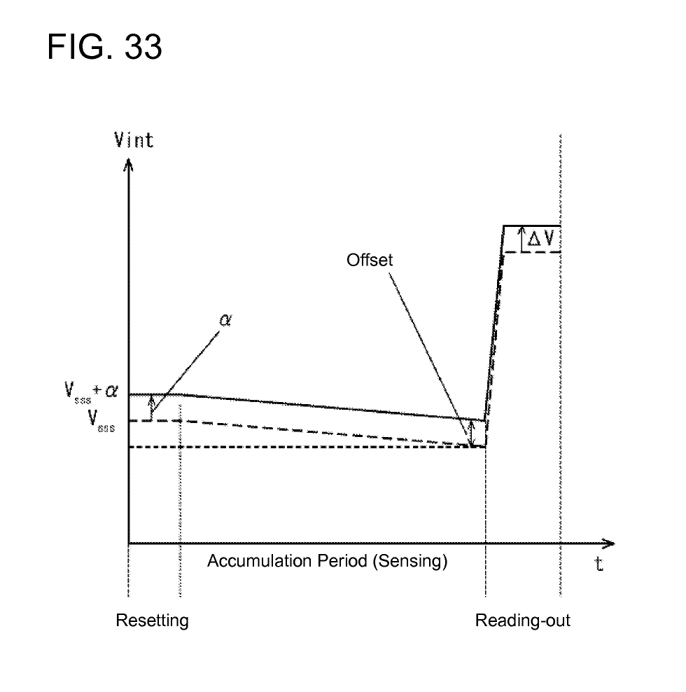

FIG. 33 is a signal waveform diagram showing the V_{INT} potential change when the high-level V_{RST.H} potential of the reset signal is V_{SSS} (broken line) and the V_{INT} potential change when the high-level V_{RST.H} potential of the reset signal is (V_{SSS}+α) (solid line). As shown in FIG. 33, by setting the high-level potential V_{RST.H} of the reset signal to (V_{SSS}+α), the V_{INT} potential increases by the voltage αV, which corresponds to the offset α.

As described above, by setting the potential of the high-level V_{RST.H} of the reset signal to (V_{SSS}+α) in accordance with the discrepancy level between the gradation data of the output signal voltage Outc of the light-shielded reference pixel circuit 10c and the standard offset value, signals whose offset has been cleared, where the offset is caused by dark current and the like, can be obtained as sensor outputs from the first pixel circuit 10a and the second pixel circuit 10b.

Also, unlike conventional technology, this embodiment does not cause the problem of narrowed dynamic range of the sensor output, because there is no need to subtract the output of the light-shielded reference pixel circuit from the sensor output. As a result, a display device equipped with light sensors that can accurately detect the external light intensity without being influenced by the environmental temperature and that retain a wide dynamic range can be realized.

### Modification 3 of Embodiment 2

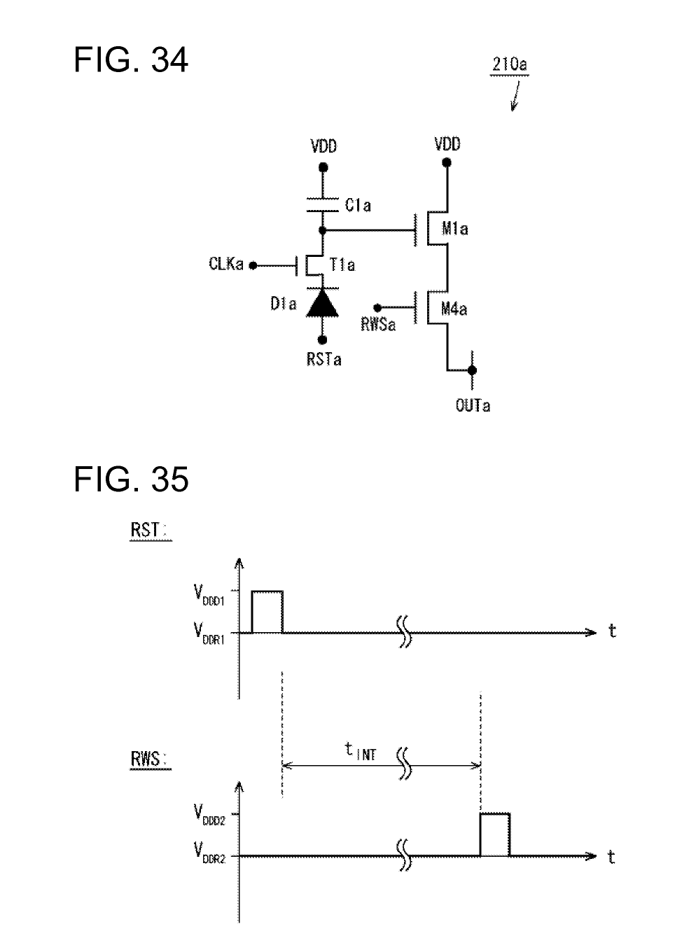

As yet another modification of Embodiment 2, a configuration described below is also possible. FIG. 34 is an equivalent circuit diagram showing the configuration of the sensor pixel circuit included in a display device of Modification 3 of Embodiment 2. The sensor pixel circuit of this modification includes a first pixel circuit 210a shown in FIG. 34 instead of the first pixel circuit 10a. The configuration of the second pixel circuit and the light-shielded reference pixel circuit of this modification is similar to the configuration shown in FIG. 34 except that a light-shielding film is provided for the light-shielded reference pixel circuit. As shown in FIG. 34, the first pixel circuit 210a according to this modification further includes a transistor M4a in addition to the photodiode D1a, capacitor C1a, and transistors M1a and T1a.

In the first pixel circuit 210a, one of the electrodes of the capacitor C1a is connected between the drain of the transistor T1a and the gate electrode of the transistor M1a, and the other electrode of the capacitor C1a is connected to the wiring VDD. The drain of the transistor M1a is connected to the wiring VDD, and the source is connected to the drain of the transistor M4a. The gate of the transistor M4a is connected to the read-out signal wiring RWSa. The source of the transistor M4a is connected to the wiring OUTa. Although in this example, a configuration in which one of the electrodes of the capacitor C1a and the drain of the transistor M1a are connected to a common constant voltage wiring (wiring VDD) is shown, alternatively these may be connected to different constant voltage wirings.

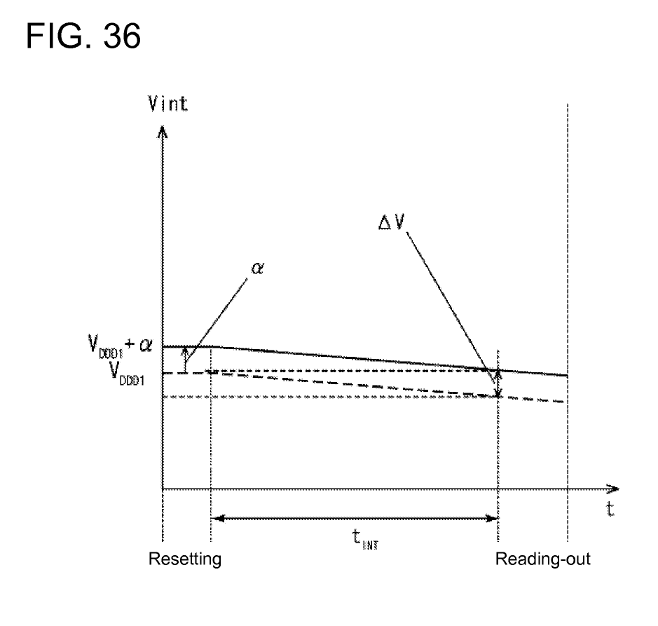

Here, the operation of the light sensor according to Modification 3 is described with reference to FIG. 35 and FIG. 36.

FIG. 35 is a timing chart showing the waveforms of the reset signal supplied from the reset line RST and the read-out signal supplied from the read-out line RWS. FIG. 36 is a waveform diagram showing the change in V_{INT} of the sensor pixel circuit according to Modification 3 during the resetting period, accumulation period, and reading-out period. In FIG. 36, the broken line shows the change in V_{INT} before the high-level potential of the reset signal is corrected, and the solid line shows the change in V_{INT} after the correction.

The high-level V_{RST.H} of the reset signal is set to the potential that turns ON the transistor M1. In the example shown in FIG. 35, the high-level V_{RST.H} of the reset signal is equal to V_{DDD1}, and the low-level V_{RST.L} is equal to V_{DDR1}. Also, the high-level V_{RWS.H} of the read-out signal is equal to V_{DDD2}, and the low-level V_{RWS.L} is equal to V_{DDR2}. However, these voltages are only examples. Individual potential levels may be set as appropriate.

First, when the reset signal supplied from the sensor row driver circuit 7 to the reset line RST rises from the low level to the high level, the photodiode D1 becomes forward biased. At this time, the transistor M1 turns ON, but there is no output to the wiring OUT, because the read-out signal is at the low level and the transistor M4 is OFF.

Next, when the reset signal returns to the low level V_{RST.L} (i.e., V_{DDR1}), the light current accumulation period (period t_{INT} shown in FIG. 35 and FIG. 36) begins. In the accumulation period, due to the photodiode, current flows from the capacitor C1 and the capacitor C1 is discharged. At this time, in the first pixel circuit and the second pixel circuit, the sum of the photo current I_{PHOTO}, which is generated due to the incoming light, and the dark current I_{DARK} flow out of the capacitor C1. On the other hand, in the light-shielded reference pixel circuit, only the dark current I_{DARK} flows out of the capacitor C1.

Also during the accumulation period, V_{INT} declines from the reset potential in accordance with the intensity of the incoming light. However, because the transistor M4 is OFF, there is no sensor output to the wiring OUT. The sensor circuit is preferably designed such that when the light with the maximum illuminance that can be detected is projected to the photodiode D1, the sensor output becomes the lowest value, i.e., the potential of the gate electrode (V_{INT}) of the transistor M1 slightly exceeds the threshold. Such a design ensures that when any light with an illuminance higher than the maximum illuminance that can be detected is projected to the photodiode D1, the value of V_{INT} falls below the threshold value of the transistor M1 and the transistor M1 turns OFF. This way, no sensor output is sent to the wiring OUT.

When the accumulation period ends, as shown in FIG. 35, the read-out signal rises and the reading-out period begins. The read-out signal becomes high level to turn ON the transistor M4. Then, the output from the transistor M1 is sent to the wiring OUT through the transistor M4. As a result, from the first pixel circuit 210a, a voltage representing the integral value of the sum of the photo current I_{PHOTO}, which is generated due to the light entering the photodiode D1a while the backlight 3 is ON, and the dark current I_{DARK} can be obtained as the output signal OUTa. From the second pixel circuit, a voltage representing the integral value of the sum of the photo current I_{PHOTO}, which is generated due to the light entering the photodiode while the backlight 3 is OFF, and the dark current I_{DARK} can be obtained. Also, from the light-shielded reference pixel circuit, a voltage representing the integral value of the dark current I_{DARK} generated during the accumulation period can be obtained.

In Modification 3, as in Embodiment 2, adjustment is conducted by the compensating circuit 80 such that the high-level potential of the reset signal is increased by the amount corresponding to the offset (α) based on the output signal voltage OUTc from the light-shielded reference pixel circuit. That is, as shown in FIG. 36, by setting the high-level potential V_{RST.H} of the reset signal to (V_{DDD1}+α), the V_{INT} potential increases by the voltage ΔV, which corresponds to the offset α.

As described above, by setting the high-level V_{RST.H} potential to (V_{DDD1}+α) of the reset signal in accordance with the discrepancy level between the gradation data of the output signal voltage OUTc from the light-shielded reference pixel circuit and the standard offset value, signals whose offset has been cleared, where the offset is caused by dark current and the like, can be obtained as output signal voltages Outa and Outb from the first pixel circuit and the second pixel circuit, respectively.

As a result, in Modification 3, similar to Embodiment 2, the external light intensity can accurately be detected without any influence of the environmental temperature, and light sensor outputs with a wide dynamic range can be obtained.

### Modification 4 of Embodiment 2

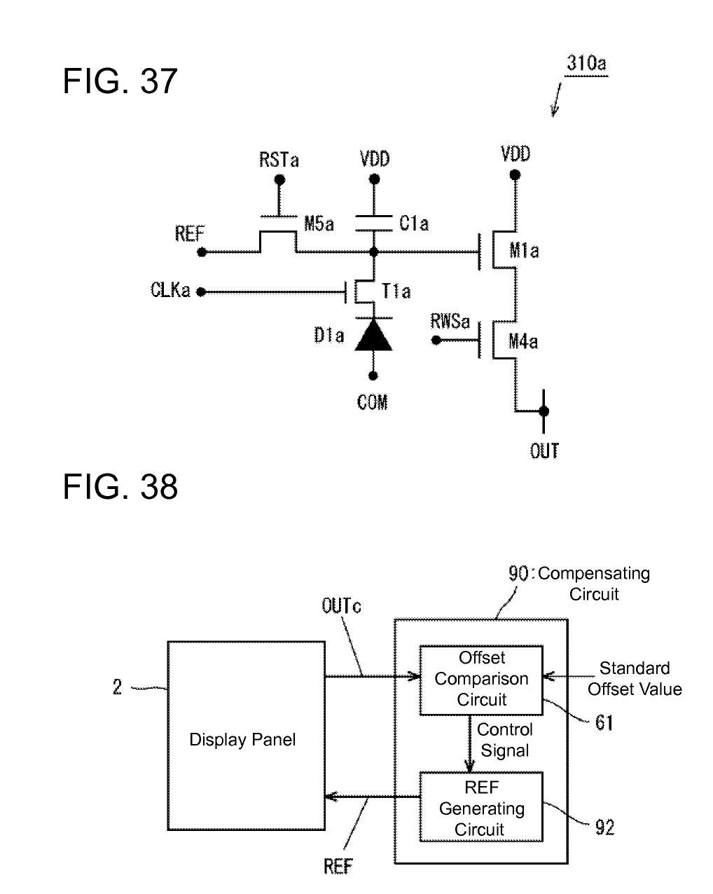

As yet another modification of Embodiment 2, the configuration described below is also possible. FIG. 37 is an equivalent circuit diagram showing the configuration of the sensor pixel circuit included in the display device of Modification 4 of Embodiment 2. That is, the sensor pixel circuit of this modification includes a first pixel circuit 310a shown in FIG. 37 instead of the first pixel circuit 10a. The configuration of the second pixel circuit and the light-shielded reference pixel circuit of this modification is similar to the configuration shown in FIG. 37 except that a light-shielding film is provided for the light-shielded reference pixel circuit. As shown in FIG. 37, the first pixel circuit 310a of this modification further includes transistors M4a and M5a in addition to the photodiode D1a, capacitor C1a, and transistors M1a and T1a.

The display device of Modification 4 is different from Embodiment 2 regarding the configuration of the compensating circuit. That is, as shown in FIG. 38, instead of the compensating circuit 60 that adjusts the amplitude of the read-out signal RWS of Embodiment 2, the display device of this modification includes a compensating circuit 90 that adjusts the reset level potential V_{REF} supplied to the transistor T1a.

In the first pixel circuit 310a, one of the electrodes of the capacitor C1a is connected between the drain of the transistor T1a and the gate of the transistor M1a. The other electrode of the capacitor C1a is connected to the wiring VDD. The drain of the transistor M1a is connected to the wiring VDD, and the source is connected to the drain of the transistor M4a. The gate of the transistor M4a is connected to the read-out line RWSa. The source of the transistor M4a is connected to the wiring OUT. The gate of the transistor M5a is connected to the reset signal wiring RSTa, the drain is connected to the wiring REF, and the source is connected to the drain of the transistor T1a. The wiring REF supplies the reset level potential V_{REF}.

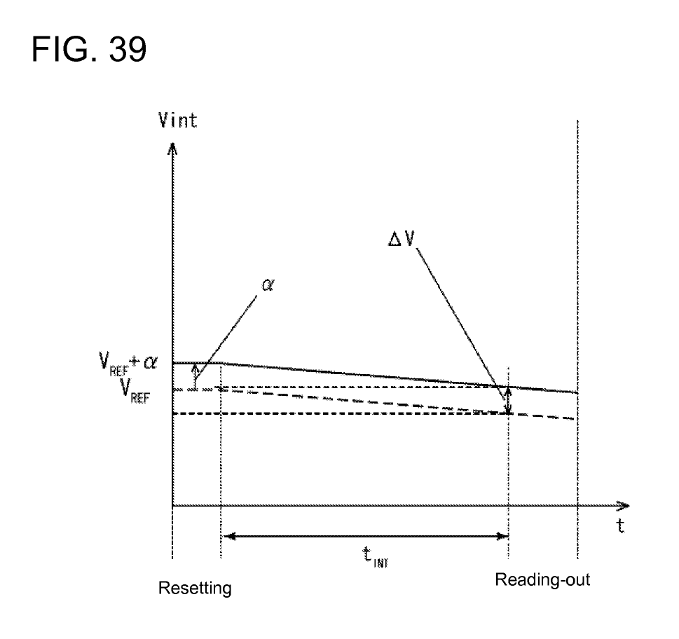

Here, the operation of the light sensor according to this embodiment is described. In the light sensor of this embodiment, the waveform of the reset signal supplied from the reset line RST and the waveform of the read-out signal supplied from the read-out line RWS are the same as the waveforms shown in FIG. 35, which figure is referenced in the description of Modification 3 of Embodiment 2. FIG. 39 is a waveform diagram showing the change in V_{INT} in the resetting period, accumulation period (t_{INT}), and the reading-out period of the light sensor of this embodiment. In FIG. 39, the broken line shows the change in V_{INT} before correction of the reset level potential V_{REF}, and the solid line shows the change in V_{INT} after correction.

The high-level V_{RST.H} of the reset signal is set to the potential at which the transistor M5 turns ON. In the example shown in FIG. 35, the high-level V_{RST.H} of the reset signal is equal to V_{DDD1}, and the low-level V_{RST.L} is equal to V_{DDR1}. Also, the high-level V_{RWS.H} of the read-out signal is equal to V_{DDD2}, and the low-level V_{RWS.L} is equal to V_{DDR2}. However, these voltages are only examples. Individual potential levels may be set as appropriate.

First, when the reset signal supplied from the sensor row driver 5 to the reset line RST rises from a low level to a high level, the transistor M5 turns ON. As a result, potential V_{INT} is reset to V_{REF}.

Next, when the reset signal returns to the low-level V_{RST.L} (i.e., V_{DDR1}), the accumulation period of photo current begins. At this time, because the reset signal becomes low level, the transistor M5 turns OFF. Here, because the anode potential of the photodiode D1 is GND, and the cathode potential is V_{INT}=V_{REF}, the photodiode D1 is reverse-biased. During the accumulation period, current flows from the capacitor C_{INT} because of the photodiode D1, and the capacitor C_{INT} is discharged. At this time, in the first pixel circuit and the second pixel circuit, the sum of the photo current I_{PHOTO}, which is generated due to the incoming light, and the dark current I_{DARK} flow out of the capacitor C1. On the other hand, in the light-shielded reference pixel circuit, only the dark current I_{DARK} flows out of the capacitor C1. In the first pixel circuit and the second pixel circuit, during the accumulation period, V_{INT} declines from the reset potential (V_{RST.H}=V_{REF} in this example) in accordance with the intensity of the incoming light. However, because the transistor M4 is OFF, there is no sensor output to the wiring OUT. The sensor circuit is preferably designed such that when the light with the maximum illuminance that can be detected is projected to the photodiode D1, the sensor output becomes the lowest value, i.e., the potential of the gate electrode (V_{INT}) of the transistor M1 slightly exceeds the threshold value. Such a design ensures that when light with an illuminance higher than the maximum illuminance that can be detected is projected to the photodiode D1, the value of V_{INT} falls below the threshold value of the transistor M1 and the transistor M1 turns OFF. This way, no sensor output is sent to the wiring OUT.

When the accumulation period ends, as shown in FIG. 35, the read-out signal rises and the reading-out period begins. The read-out signal becomes high level to turn ON the transistor M4. Then, the output from the transistor M1 is sent to the wiring OUT through the transistor M4. As a result, from the first pixel circuit 310a, a voltage representing the integral value of the sum of the photo current I_{PHOTO}, which is generated due to the light entering the photodiode D1a while the backlight 3 is ON, and the dark current I_{DARK} can be obtained as the output signal OUTa. From the second pixel circuit, a voltage representing the integral value of the sum of the photo current I_{PHOTO}, which is generated due to the light entering the photodiode while the backlight 3 is OFF, and the dark current I_{DARK} can be obtained. Also, from the light-shielded reference pixel circuit, a voltage representing the integral value of the dark current I_{DARK} generated during the accumulation period can be obtained.

FIG. 38 is a block diagram schematically showing the configuration of the compensating circuit 90. Although in the example shown in FIG. 38, the compensating circuit 90 is disposed outside the display panel 2 (in the signal-processing circuit 20, for example), alternatively it may be disposed in the sensor row driver circuit 7. The compensating circuit 90 includes an offset comparison circuit 61 and an REF generating circuit 92. The offset comparison circuit 61 compares the output signal voltage OUTc from the light-shielded reference pixel circuit to a predetermined standard offset value to find the discrepancy level between them, and outputs a control signal in accordance with the discrepancy level to the REF generating circuit 92. The REF generating circuit 92 adjusts the reset level potential V_{REF} supplied from the wiring REF based on the control signal from the offset comparison circuit 61. That is, the REF generating circuit 92 increases the setting of the reset-level potential V_{REF} by the amount corresponding to the offset (α).

FIG. 39 is a signal waveform diagram showing the change in the V_{INT} potential before the reset-level potential V_{REF} is adjusted (broken line) and the change in the V_{INT} potential after the reset level potential V_{REF} is increased by α (solid line). As shown in FIG. 39, by increasing the setting of the reset-level potential V_{REF} by α, the V_{INT} potential increases by voltage ΔV, which corresponds to the offset α.

As described above, by increasing the setting of the reset-level potential V_{REF} by α in accordance with the discrepancy level between the gradation data of the output signal voltage OUTc from the light-shielded reference pixel circuit and the standard offset, signals whose offset has been cleared, where the offset is caused by dark current and the like, can be obtained as the output signal voltage OUTa of the first pixel circuit 310a and the output signal voltage OUTb from the second pixel circuit.

Also, this modification does not cause the problem of narrowed dynamic range of the sensor output, because there is no need to subtract the output of the light-shielded reference pixel circuit from the output of the first pixel circuit and the second pixel circuit. As a result, a display device equipped with light sensors that can accurately detect the external light intensity without being influenced by the environmental temperature and that retain a wide dynamic range can be realized.

### Modification 5 of Embodiment 2

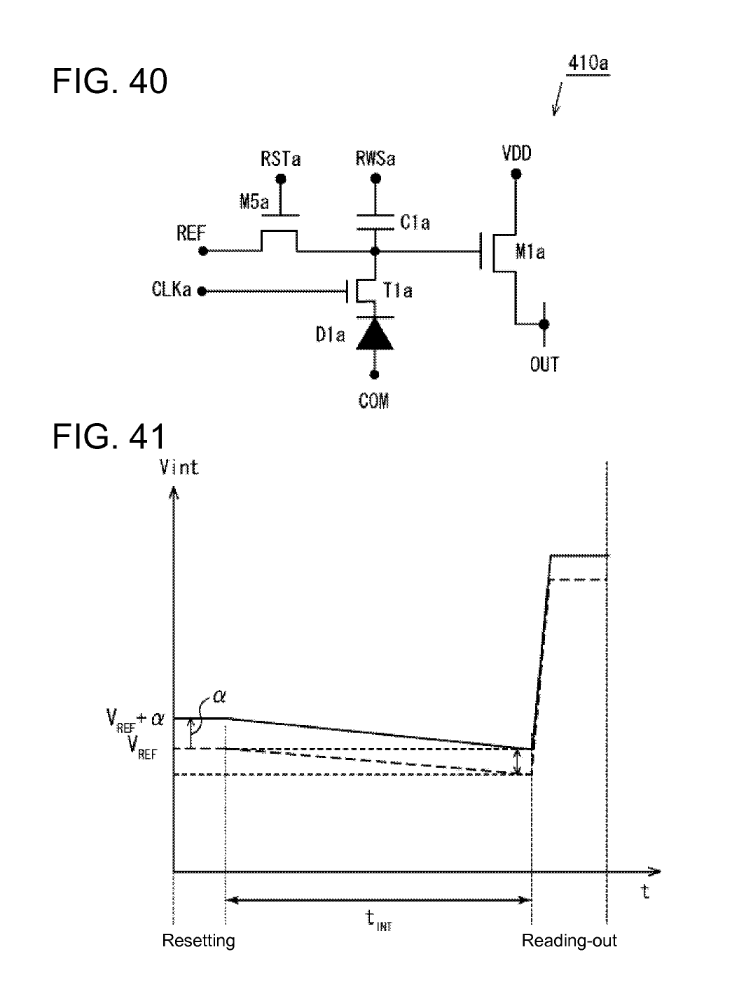

As yet another modification of Embodiment 2, a configuration described below is also possible. The sensor pixel circuit of this modification includes a first pixel circuit 410a shown in FIG. 40 instead of the first pixel circuit 10a. The configurations of the second pixel circuit and the light-shielded reference pixel circuit of this modification are similar to the configuration shown in FIG. 40 except that a light-shielding film is provided for the light-shielded reference pixel circuit. As shown in FIG. 40, the first pixel circuit 410a of this modification further includes a transistor M5a in addition to the photodiode D1a, capacitor C1a, and transistors M1a and T1a.

In the first pixel circuit 410a, one of the electrodes of the capacitor C1a is connected between the drain of the transistor T1a and the gate of the transistor M1a. The other electrode of the capacitor C1a is connected to the read-out line RWS. The drain of the transistor M1a is connected to the wiring VDD, and the source is connected to the wiring OUT. The gate of the transistor M5a is connected to the reset line RSTa, the drain is connected to the wiring REF, and the source is connected to the drain of the transistor T1a. The wiring REF supplies the reset-level potential V_{REF}. The anode of the photodiode D1a is connected to the constant voltage source COM.

In the light sensor of this embodiment, the waveform of the reset signal supplied from the reset line RST and the waveform of the read-out signal supplied from the read-out signal wiring RWS are the same as those shown in FIG. 20, which figure is referenced in the description of Embodiment 2. Also, the display device of this modification includes the compensating circuit 60 shown in FIG. 21 referenced in the description of Embodiment 2. Similar to Embodiment 2, the compensating circuit 60 may be disposed outside the display panel 2 (in the signal-processing circuit 20, for example) or in the sensor row driver circuit 7.

Also in this modification, the compensating circuit 60 adjusts the amplitude of the read-out signal in accordance with the discrepancy level between the value obtained through A/D conversion of the output signal voltage OUTc from the light-shielded reference pixel circuit (gradation data) and the standard offset value. That is, as in Embodiment 2 described with reference to FIG. 22, the RWS generating circuit 62 of the compensating circuit 60 increases the amplitude of the read-out signal (V_{RWS}−V_{RWS.L}) by α by increasing the high-level V_{RWS.H} potential of the read-out signal by just α over V_{DDD}, the potential before correction (see FIG. 20).

Thus, as in Embodiment 2 described above with reference to FIG. 23, by setting the high-level V_{RWS.H} potential of the read-out signal to (V_{DDD}+α), the V_{INT} potential increases by voltage ΔV, which corresponds to the offset α.

As described above, by setting the high-level V_{RWS.H} potential of the read-out signal to (V_{DDD}+α) in accordance with the discrepancy level between the gradation data of the output signal voltage OUTc from the light-shielded reference pixel circuit and the standard offset value, signals whose offset has been cleared, where the offset is caused by dark current and the like, can be obtained as the output signal voltage Outa from the first pixel circuit 410a and the output signal voltage Outb from the second pixel circuit.

This modification also does not cause the problem of narrowed dynamic range of the sensor output, because there is no need to subtract the output of the light-shielded reference pixel circuit from the outputs from the first pixel circuit 410a and the second pixel circuit. As a result, a display device equipped with light sensors that can accurately detect the external light intensity without being influenced by the environmental temperature and that retain a wide dynamic range can be realized.

Here, the amplitude of the read-out signal is increased by α by changing the high-level V_{RWS.H} potential of the read-out signal from V_{DDD} to (V_{DDD}+α). However, the same effect can also be obtained by changing the low-level V_{RWS.L} potential from V_{SSR} to (V_{SSR}−α), because this too increases the amplitude of the read-out signal by α.

An alternative configuration is that, as in Modification 4, the reset level potential V_{REF}, instead of the amplitude of the read-out, is adjusted in accordance with the discrepancy level between the gradation data of the output signal voltage OUTc from the light-shielded reference pixel circuit and the standard offset value. In that case, instead of the compensating circuit 60, the compensating circuit 90 shown in FIG. 38 referenced in the description of Modification 4 is provided. With the compensating circuit 90, as shown in FIG. 41, by increasing the setting of the reset-level potential V_{REF} by α, the V_{INT} potential at the time of resetting increases by the voltage that corresponds to the offset α. As a result, at the time of reading out, the value whose offset has been cancelled is outputted. In FIG. 41, the broken line indicates the V_{INT} potential change before the correction of the reset-level potential V_{REF}, and the solid line indicates the V_{INT} potential change after the correction.

### Embodiment 3

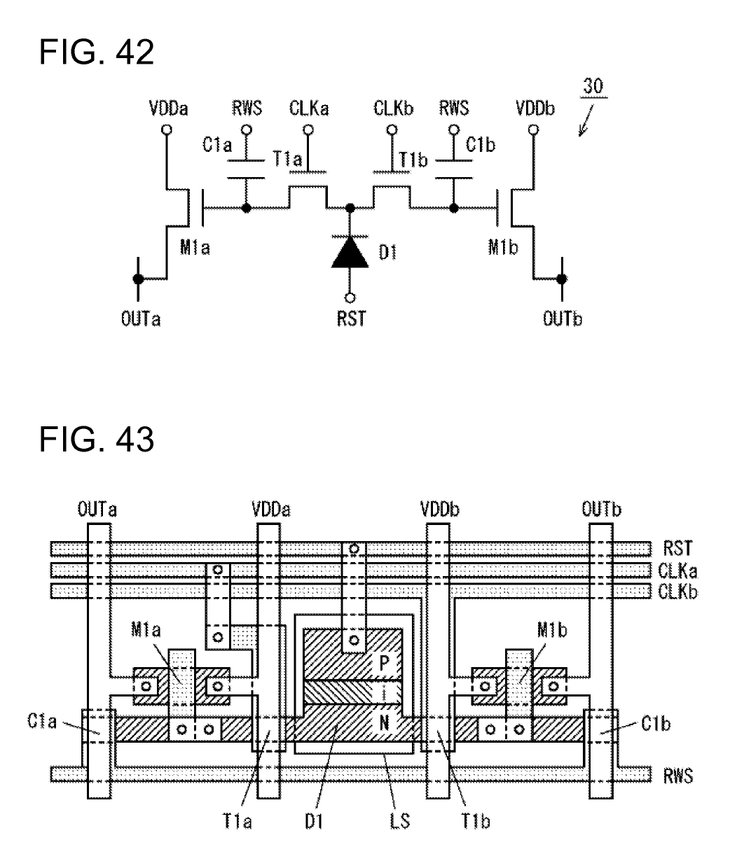

FIG. 42 is a pixel circuit diagram according to Embodiment 3 of the present invention. The pixel circuit 30 shown in FIG. 42 includes transistors T1a, T1b, M1a, and M1b, a photodiode D1, and capacitors C1a and C1b. The transistors T1a, T1b, M1a, and M1b are N-type TFTs. In FIG. 42, the left half is the first pixel circuit, and the right half is the second pixel circuit. The pixel circuit 30 is connected to the clock lines CLKa and CLKb, the reset line RST, the read-out line RWS, the power supply lines VDDa and VDDb, and the output lines OUTa and OUTb.

As shown in FIG. 42, the anode of the photodiode D1 is connected to the reset line RST, and the cathode is connected to the sources of the transistors T1a and T1b. The gate of the transistor T1a is connected to the clock line CLKa, and the drain is connected to the gate of the transistor M1a. The drain of the transistor M1a is connected to the power supply lines VDDa, and the source is connected to the output line OUTa. The capacitor C1a is disposed between the gate of the transistor M1a and the read-out line RWS. The gate of the transistor T1b is connected to the clock line CLKb, and the drain is connected to the gate of the transistor M1b. The drain of the transistor M1b is connected to the power supply lines VDDb, and the source is connected to the output line OUTb. The capacitor C1b is disposed between the gate of the transistor M1b and the read-out line RWS. In the pixel circuit 30, the node connected to the gate of the transistor M1a becomes the first accumulation node, and the node connected to the gate of the transistor M1b becomes the second accumulation node. Also, the transistors M1a and M1b function as read-out transistors. FIG. 43 is a layout diagram of the pixel circuit 30. Description of FIG. 43 is the same as Embodiment 1.

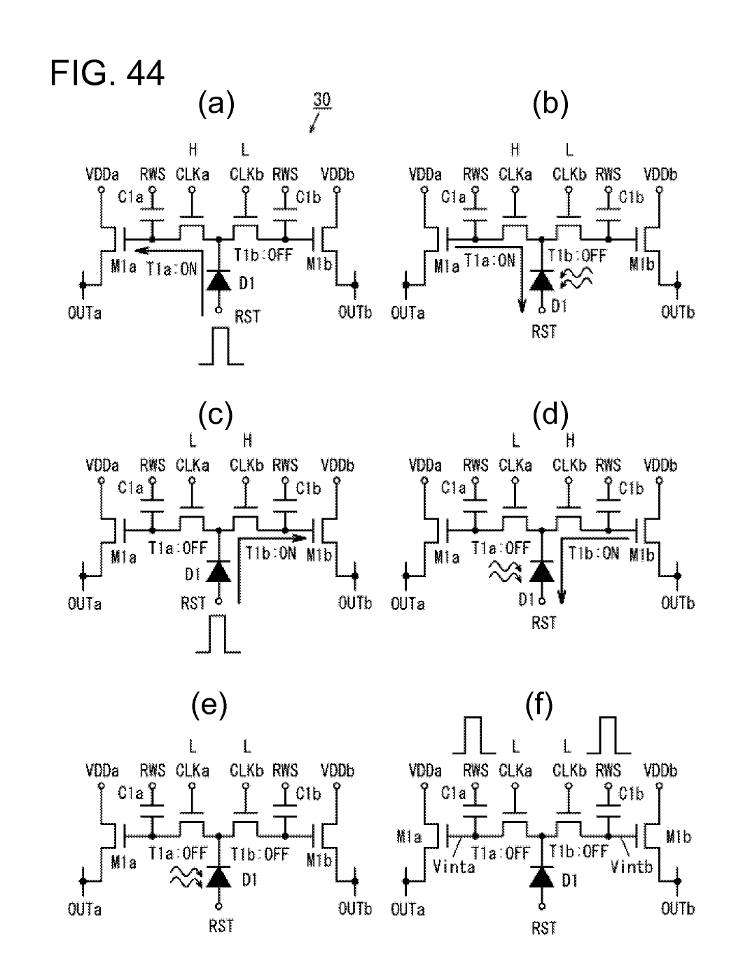

FIG. 44 shows the operation of the pixel circuit 30 in the sensor driving mode. During one frame period in the sensor driving mode, the pixel circuit 30 conducts: (a) resetting when the backlight is ON; (b) accumulating when the backlight is ON; (c) resetting when the backlight is OFF; (d) accumulating when the backlight is OFF; (e) holding; and (f) reading out.

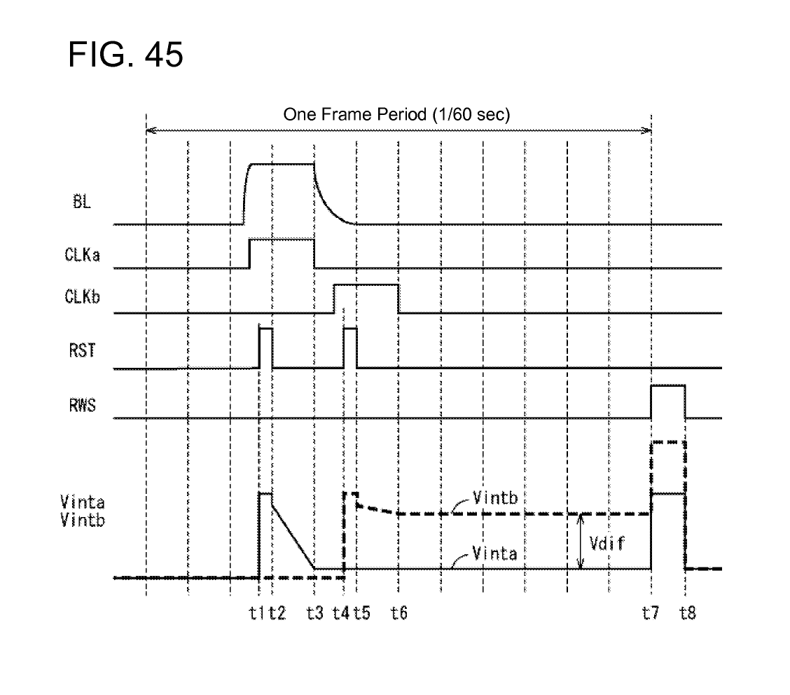

FIG. 45 is a signal waveform diagram of the pixel circuit 30 in the sensor driving mode. In FIG. 45, “Vinta” denotes the potential of the first accumulation node (gate potential of the transistor M1a), and “Vintb” denotes the potential of the second accumulation node (gate potential of the transistor M1b). In FIG. 45, time t1 to time t2 is the resetting period when the backlight is ON, time t2 to time t3 is the accumulation period when the backlight is ON, time t4 to time t5 is the resetting period when the backlight is OFF, time t5 to time t6 is the accumulation period when the backlight is OFF, time t3 to time t4 and time t6 to time t7 are holding periods, and time t7 to time t8 is the reading-out period.

During the resetting period when the backlight is ON, the clock signal CLKa becomes high level, the clock signal CLKb and the read-out signal RWS become low level, the reset signal RST becomes high level for resetting. At this time, the transistor T1a turns ON, and the transistor T1b turns OFF. Therefore, current (forward-biased current of the photodiode D1) flows from the reset RST to the first accumulation node through the photodiode D1 and the transistor T1a (FIG. 44(a)), and the potential Vinta is reset to a prescribed level.

In the accumulation period when the backlight is ON, the clock signal CLKa becomes high level, and the clock signal CLKb, the reset signal RST, and the read-out signal RWS become low level. At this time, the transistor T1a turns OFF, and the transistor T1a turns OFF. If light enters the photodiode D1 at this time, current (photo current of the photodiode D1) flows from the first accumulation node to the reset line RST through the transistor T1a and the photodiode D1, and the electrical charges are drawn from the first accumulation node (FIG. 44(b)). Consequently, the potential Vinta decreases in accordance with the amount of the light that enters during this period (while the backlight 3 is ON). During this period, the potential Vintb does not change.

During the resetting period when the backlight is OFF, the clock signal CLKb becomes high level, the clock signal CLKa and the read-out signal RWS become low level, and the reset signal RST becomes high level for resetting. At this time, the transistor T1a turns OFF, and the transistor T1b turns ON. Consequently, current (forward-biased current of the photodiode D1) flows from the reset line RST to the second accumulation node through the photodiode D1 and the transistor T1b (FIG. 44(c)), and the potential Vintb is reset to a prescribed level.

During the accumulation period when the backlight is OFF, the clock signal CLKb becomes high level, the clock signal CLKa, the reset signal RST, and read-out signal RWS become low level. At this time, the transistor T1a turns OFF, and the transistor T1b turns ON. If light enters the photodiode D1 at this time, current (photo current of the photodiode D1) flows from the second accumulation node to the reset line RST through the transistor T1b and the photodiode D1, and the electrical charge is drawn from the second accumulation node (FIG. 44(d)). As a result, potential Vintb decreases in accordance with the amount of light that enters during this period (while the backlight 3 is OFF). During this period, the potential Vinta does not change.

During the holding period, the clock signals CLKa and CLKb, the reset signal RST, and the read-out signal RWS becomes low level. At this time, the transistors T1a and T1b turn OFF. Even if light enters the photodiode D1 at this time, the potentials Vinta and Vintb do not change, because transistors T1a and T1b turn OFF, and the photodiode D1 is electrically disconnected from the gates of the transistors M1a and M1b (FIG. 44(e)).

During the reading-out period, the clock signals CLKa and CLKb and the reset signal RST become low level, and read-out signal RWS becomes high level for reading-out. At this time, the transistors T1a and T1b turn OFF. At this time, the potentials Vinta and Vintb increase by the increase amount of the potential of the read-out signal RWS, current Ia representing the potential Vinta flows across the drain and the source of the transistor M1a, and current Ib representing the potential Vintb flows across the drain and the source of the transistor M1b (FIG. 44(f)). The current Ia is inputted to the source driver circuit 6 through the output line OUTa, and the current Ib is inputted to the source driver circuit 6 through the output line OUTb.

As described above, the pixel circuit 30 of this embodiment is configured such that one photodiode D1 (light sensor) is shared by the first and second pixel circuits 10a and 10b of Embodiment 1. The cathode of the shared photodiode D1 is connected to the source of the transistor T1a included in a section corresponding to the first pixel circuit, and also to the source of the transistor T1b included in a section corresponding to second pixel circuit.

Similar to the first and second pixel circuits 10a and 10b of Embodiment 1, the pixel circuit 30 allows detection of the light amount when the backlight is ON and the light amount when the backlight is OFF. Consequently, a similar effect as Embodiment 1 can be obtained. Also, because one photodiode D1 is shared by two kinds of pixel circuits, influence of the variation in the sensitivity characteristics of photodiodes can be canceled and the difference in the light amount between when the backlight is ON and when the backlight is OFF can accurately be obtained. Also, the number of photodiodes may be reduced to improve the aperture ratio and to increase the sensitivity of the sensor pixel circuit.

Also, in the pixel circuit 30, as stated in the description of Embodiment 1, at least either the offset or gain of the sensor output obtained in the sensor driving mode can be corrected using the first correction data ofst_on and the second correction data Ofst_off obtained in the first correction data acquisition mode and in the second correction data acquisition mode, respectively. Thus, as in Embodiment 1, accurate sensor outputs with a wide dynamic range can be obtained.

### <Modifications of Circuit Configuration>

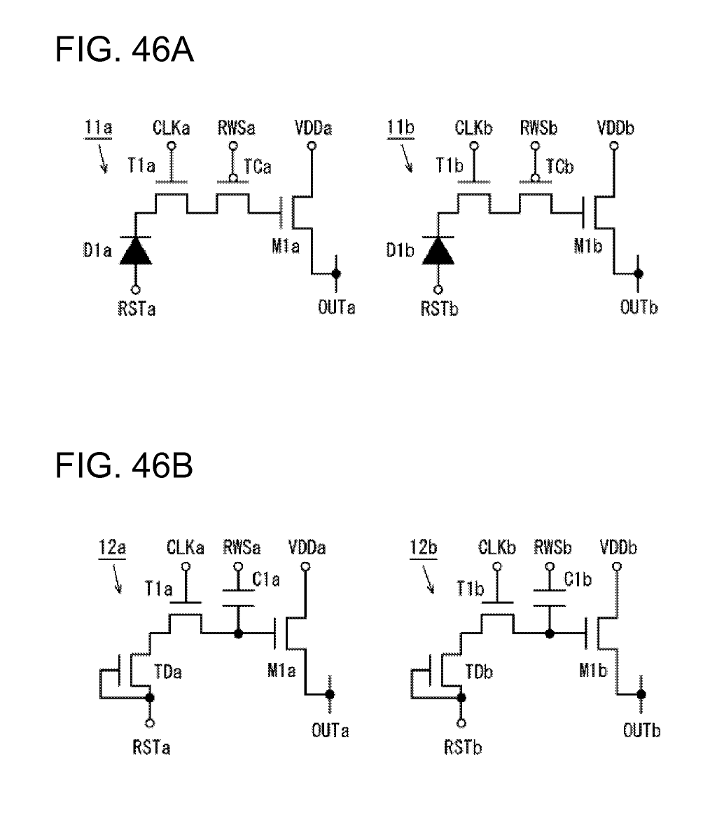

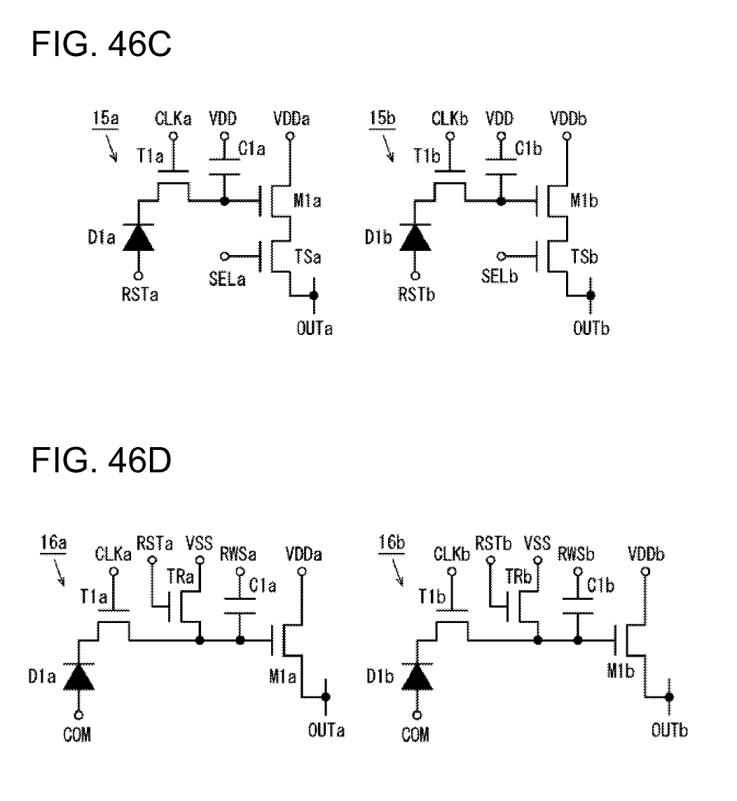

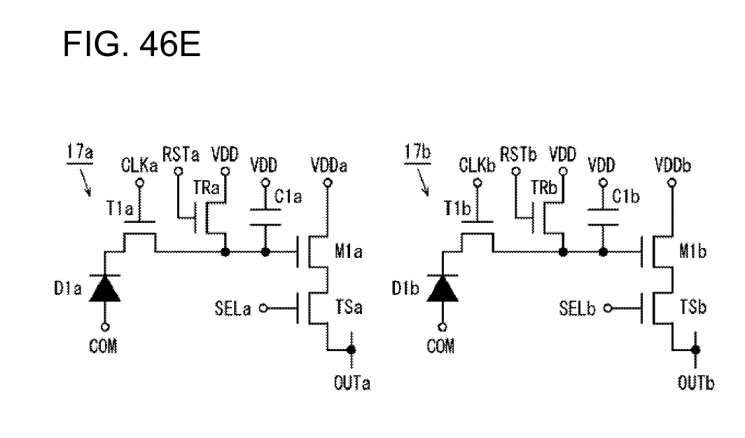

The circuit configuration of Embodiments 1 and 2 described with reference to FIG. 6 may be modified as described below. FIG. 46A to FIG. 46E are pixel circuit diagrams of Modification 1 to Modification 5 of the circuit configuration shown in FIG. 6. First pixel circuits 11a to 17a shown in FIG. 46A to FIG. 46E can be obtained through modifications of the first pixel circuit 10a of Embodiment 1, which is described below. Second pixel circuits 11b to 17b can be obtained by conducting the same modification on the second pixel circuit 10b of Embodiment 1.

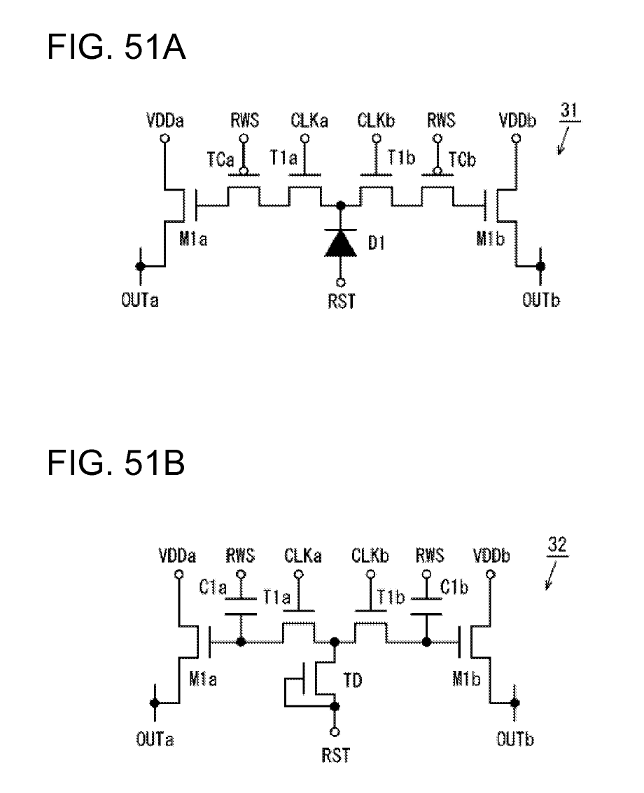

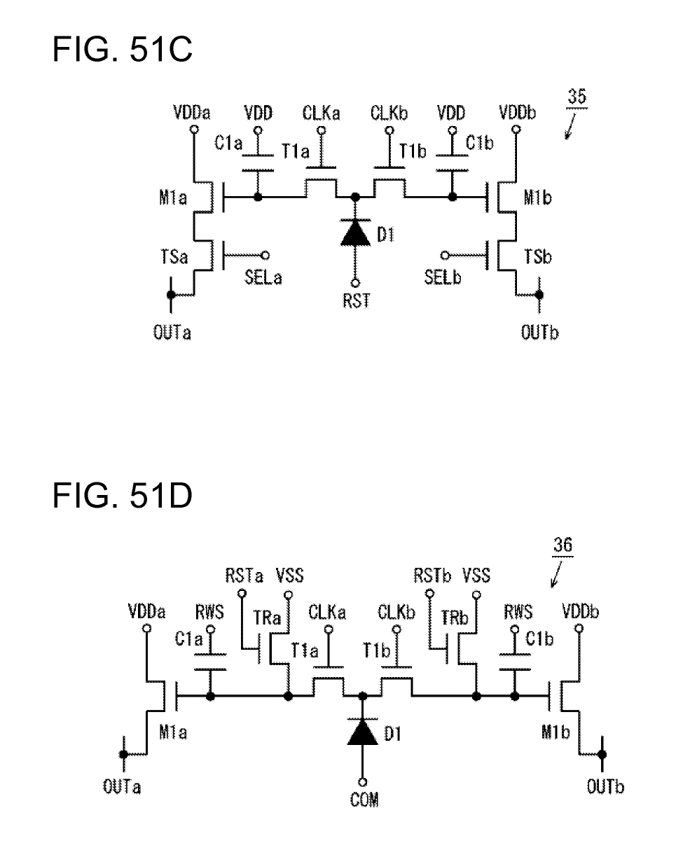

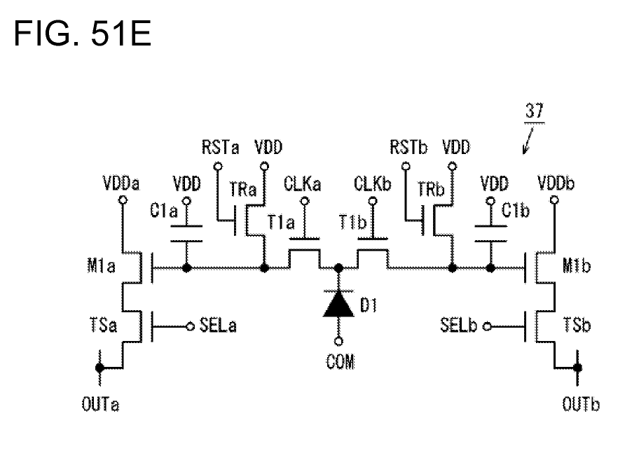

The first pixel circuit 11a shown in FIG. 46A is obtained by replacing the capacitor C1a included in the first pixel circuit 10a with a transistor TCa, which is a P-type TFT. In the first pixel circuit 11a, the drain of the transistor TCa is connected to the drain of the transistor T1a, the source is connected to the gate of the transistor M1a, and the gate is connected to the read-out line RWSa. With the transistor TCa connected this way, when a high-level potential for reading-out is applied to the read-out line RWSa, the potential at the accumulation node shifts more widely than in the original pixel circuit. As a result, the difference between the accumulation node potential when high-intensity light is projected and the accumulation node potential when low-intensity light is projected can be amplified to improve the sensitivity of the pixel circuit 11a. A similar modification on Embodiment 3 can produce a pixel circuit 31 shown in FIG. 51A.

A first pixel circuit 12a shown in FIG. 46B is the same as the first pixel circuit 10a except that the photodiode D1 included in the first pixel circuit 10a is replaced with the transistor TDa. Thus, all transistors included in the first pixel circuit 12a become N-type. As a result, mono-channel process that can manufacture N-type transistors only can be used to manufacture the first pixel circuit 12a. A similar modification on Embodiment 3 can produce a pixel circuit 32 shown in FIG. 51B.

A first pixel circuit 15a shown in FIG. 46C is the same as the first pixel circuit 10a except that a transistor TSa is also included. The transistor TSa is an N-type TFT, and functions as switching element for selection. In the first pixel circuit 15a, the source of the transistor M1a is connected to the drain of the transistor TSa. The source of the transistor TSa is connected to the output line OUTa, and the gate is connected to the selection line SELa. Selection signal SELa becomes high level when reading out is conducted from the first pixel circuit 15a. Although the capacitor C1a is connected to the read-out line RSWa in the first pixel circuit 10a, it is connected to the power supply lines VDD in the first pixel circuit 15a. Thus, variations of the pixel circuit can be obtained. A similar modification on Embodiment 3 can produce a pixel circuit 35 shown in FIG. 51C.

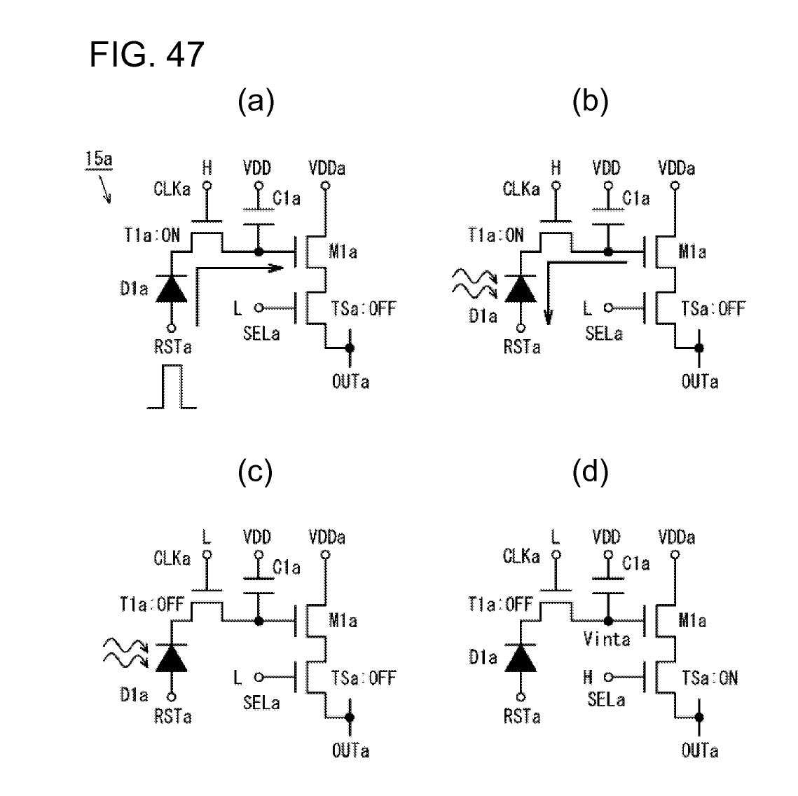

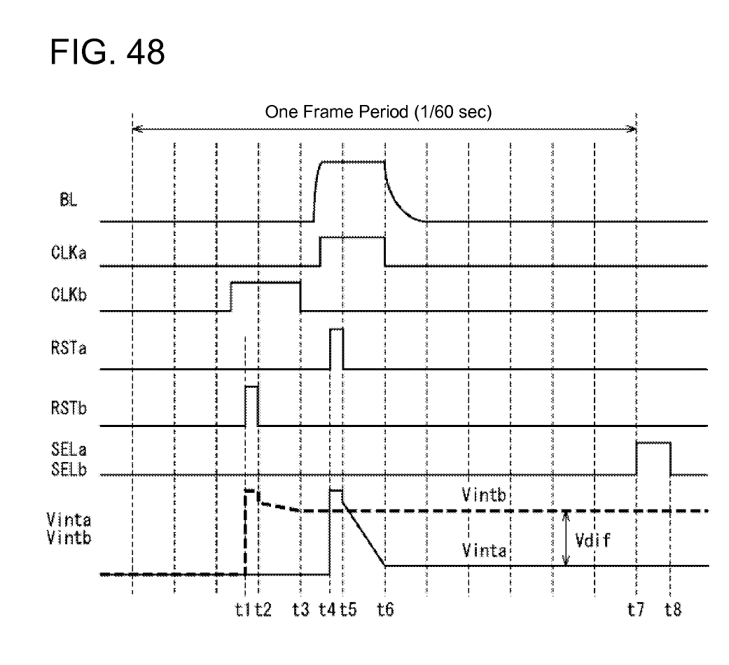

FIG. 47 shows the operation of the first pixel circuit 15a in the sensor driving mode. FIG. 48 is the signal waveform diagram of the first pixel circuit 15a. Except for the reading-out, the selection signal SELa stays low level, the transistor TSa is OFF, and the first pixel circuit 15a operates in a similar manner as the first pixel circuit 10a (FIG. 47(a) to FIG. 47(c)). For reading-out, the selection signal SELa becomes high level, and the transistor TSa turns ON. At this time, current Ia representing the potential Vinta flows across the drain and the source of the transistor M1a (FIG. 47(d)).

A first pixel circuit 16a shown in FIG. 46D is the first pixel circuit 10a plus a transistor TRa. The transistor TRa is an N-type TFT, and functions as a switching element for resetting. In the first pixel circuit 16a, a low-level potential VSS is applied to the source of the transistor TRa. The drain of the transistor TRa is connected to the gate of the transistor M1a, and the gate is connected to the reset line RSTa. Also, a low-level potential COM is applied to the anode of the photodiode D1a. Thus, variations of the pixel circuit can be obtained. A similar modification on Embodiment 3 can produce a pixel circuit 36 shown in FIG. 51D.

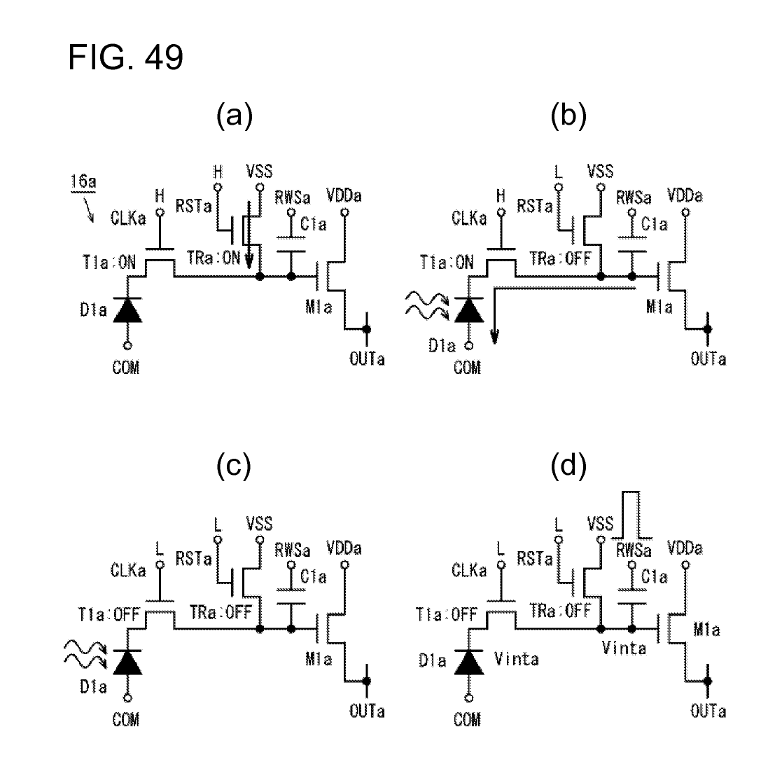

FIG. 49 shows the operation of the first pixel circuit 16a in the sensor driving mode. At the time of resetting, the reset signal RSTa becomes high level, the transistor TRa turns ON, and the potential at the accumulation node (the gate potential of the transistor M1a) is reset to low-level potential VSS (FIG. 49(a)). During the time other than the resetting time, the reset signal RSTa becomes low level, and the transistor TRb turns OFF (FIG. 49(b) to FIG. 49(d)).

A first pixel circuit 17a shown in FIG. 46E is the first pixel circuit 10a plus the transistors TSa and TRa. The transistors TSa and TRa are connected in the same manner as the first pixel circuits 15a and 16a. Thus, variations of the pixel circuit can be obtained. A similar modification on Embodiment 3 can produce a pixel circuit 37 shown in FIG. 51E.

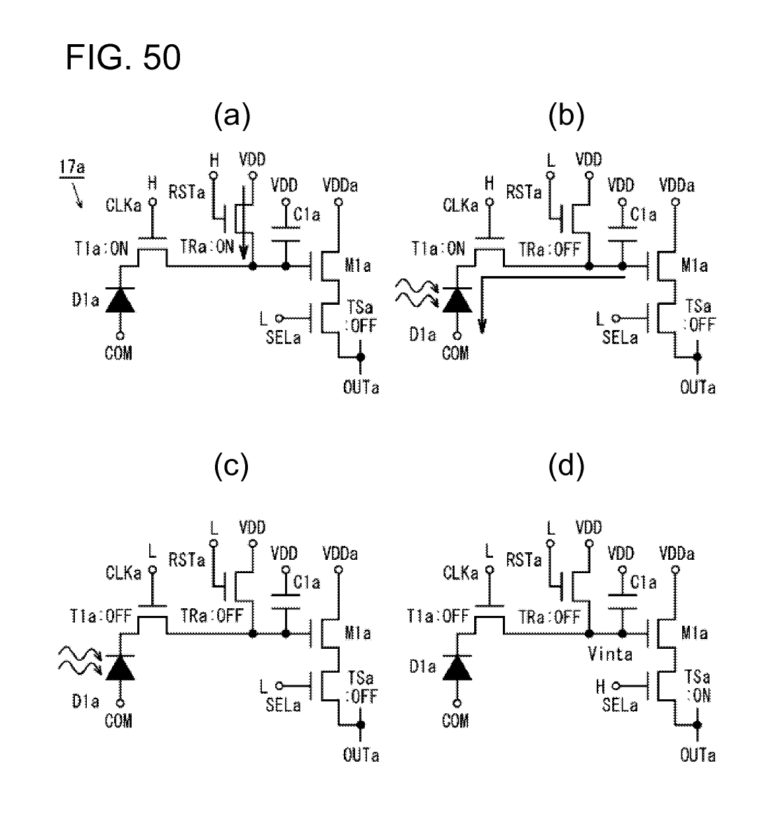

FIG. 50 shows the operation of the first pixel circuit 17a in the sensor driving mode. At the time of resetting, the reset signal RSTa becomes high level, the transistor TRa turns ON, and the potential at the accumulation node (the gate potential of the transistor M1a) is reset to high-level potential VDD (FIG. 50(a)). During the reading-out time, the selection signal SELa becomes high level, and the transistor TSa turns ON. At this time, current Ia representing the potential Vinta flows across the drain and the source of the transistor M1a (FIG. 50(d)). Except for the resetting and reading-out, the reset signal RSTa and the selection signal SELa become low level (FIG. 50(b) and FIG. 50(c)).

As described above, display devices according to above-mentioned embodiments and their modifications include the first sensor pixel circuit that detects light during the detection period when the backlight is ON and holds the light amount at other time, and also include, separate from the first sensor pixel circuit, the second sensor pixel circuit that detects light during the detection period when the backlight is OFF and holds the light amount at other time. Thus, the display devices according to the above-mentioned embodiments and their modifications can obtain the difference between two kinds of light amount outside the sensor pixel circuit to determine the difference between the light amount when the backlight is ON and the light amount when the backlight is OFF. As a result, problems with conventional technologies can be solved, and the input function independent of the optical environment can be realized.

Also, accurate sensor outputs with a wide dynamic range can be obtained by correcting the sensor outputs using the correction data obtained in the first and the second correction data acquisition modes.

In the present invention, there is no particular limitation to the kinds of light source provided in the display device. Therefore, a visible light backlight for display may be turned ON and OFF, for example. Alternatively, separate from the visible light backlight for display, an infrared light backlight for light detection may be disposed in the display device. For such a display device, the visible light backlight may be ON all the time and only the infrared light backlight may be turned ON and OFF once during a frame period.

### Other modifications of Embodiments 1 to 3

Embodiments 1 to 3 of the present invention are described above. However, the present invention is not limited to the above-mentioned embodiments. Various modifications can be made within the scope of the invention.

For example, the configuration according to Embodiments 1 to 3, in which the wirings VDD and OUT connected to the light sensors are also used as the source wiring COL, is described above as an example. The advantage of this configuration is a high pixel aperture ratio. However, the configuration in which the wirings VDD and OUT for light sensors are provided separate from the source wiring COL can also provide a similar effect of the embodiments described above.

### INDUSTRIAL APPLICABILITY

The present invention can be used for industrial purposes as a display device having a light sensor function.

1. A display device equipped with an active matrix substrate, comprising:
light sensors provided in a pixel region of said active matrix substrate;
a sensor driving wiring connected to said light sensors;
a sensor driver circuit that supplies a sensor driver signal to said light sensors through said sensor driving wiring;
an amplifier circuit that, when instructed by said sensor driving signal, amplifies a signal read out from said light sensors and outputs said signal as a light sensor signal;
a signal-processing circuit that processes the light sensor signal outputted from said amplifier circuit; and
a light source for said light sensors,
wherein said light sensors each has:
a first sensor pixel circuit that, when instructed by said sensor driving signal, accumulates an electrical charge in accordance with the amount of light received during an accumulation period when said light source is ON, and outputs a sensor signal representing the accumulated charge when a reading-out period arrives; and
a second sensor pixel circuit that, when instructed by the sensor driving signal, accumulates an electrical charge in accordance with the amount of light received during an accumulation period when said light source is OFF, and outputs a sensor signal representing the accumulated charge when the reading-out period arrives,
wherein operation modes of said sensor driver circuit during a single frame period are:
a sensor driving mode for obtaining said sensor signals from said first sensor pixel circuit and from said second sensor pixel circuit of said light sensor;
a first correction data acquisition mode for obtaining a first correction data for correcting the sensor signal obtained from said first sensor pixel circuit, where a sensor driving signal that is different from the one used in said sensor driving mode is used; and
a second correction data acquisition mode for obtaining a second correction data for correcting the sensor signal obtained from said second sensor pixel circuit, where a sensor driving signal that is different from the one used in the sensor driving mode is used,
wherein the accumulation period when said light source is ON in said first correction data acquisition mode is shorter than the accumulation period when said light source is ON in said sensor driving mode,
wherein the accumulation period when said light source is OFF in said second correction data acquisition mode is shorter than the accumulation period when said light source is OFF in said sensor driving mode,
wherein the display device further comprises a memory that stores light sensor signal levels obtained, under a controlled ambient environmental condition, by driving the light sensor in said sensor driving mode, in said first correction data acquisition mode, and in said second correction data acquisition mode as offset elimination data for light sensor signal level subjected to correction, and
wherein said signal-processing circuit uses the first correction data and the second correction data, and said light sensor signal level subjected to correction, which was corrected with said offset elimination data read out from said memory, to correct the light sensor signal obtained in said sensor driving mode.

2. The display device according to claim 1, wherein said light sensor further includes a reference sensor having a light-shielding film added to said first sensor pixel circuit,
wherein said display device further comprises:
an offset comparison circuit that determines a discrepancy level between a sensor signal outputted from said reference sensor and a standard offset value; and
a driving signal generating circuit that adjusts the potential of the driving signal of said light sensor in accordance with the discrepancy level determined by said offset comparison circuit.

3. The display device according to claim 1, further comprising a memory that temporarily stores said first correction data and said second correction data,
wherein said first correction data and said second correction data stored in said memory are updated in said first correction data acquisition mode and in said second correction data acquisition mode at least when the display device is turned ON, when a cycle of reading-out from said light sensor is changed, or when the ambient environment changes beyond a prescribed range.

4. The display device according to claim 2, further comprising a memory that temporarily stores said first correction data and said second correction data,
wherein, at least when the display device is turned ON, when the cycle of reading-out from said light sensor is changed, or when the ambient environment changes beyond a prescribed range, said first correction data and said second correction data stored in said memory may be updated in said first correction data acquisition mode and in said second correction data acquisition mode after the potential of said driving signal is adjusted by said offset comparison circuit and said driving signal generating circuit.

5. The display device according to claim 2, wherein said light sensor includes:
a light-receiving element;
a capacitance that charges and discharges an output current from said light-receiving element;
a switching element connected between one end of said light-receiving element and one end of said capacitance;
a reset signal wiring that is connected to the other end of said light-receiving element and that supplies a reset signal; and
a read-out signal wiring that is connected to the other end of said capacitance and that supplies a read-out signal,
wherein said driving signal generating circuit adjusts at least either a high-level potential or a low-level potential of said read-out signal.

6. The display device according to claim 2, wherein said light sensor includes:
a light-receiving element;
a capacitance that charges and discharges an output current from said light-receiving element;
a switching circuit connected between one end of said light-receiving element and one end of said capacitance;
a reset signal wiring that is connected to the other end of said light-receiving element and that supplies a reset signal; and
a read-out signal wiring that supplies a read-out signal to said light sensor,
wherein said driving signal generating circuit adjusts a high-level potential of said reset signal.

7. The display device according to claim 6, wherein said switching circuit includes one transistor, and said read-out signal wiring is connected to the other end of said capacitance.

8. The display device according to claim 6,
wherein said switching circuit includes a first transistor and a second transistor,
wherein a control electrode of said first transistor is connected between one end of said light-receiving element and one end of said capacitance,
wherein one of two electrodes other than said control electrode of said first transistor is connected to a wiring that supplies a constant voltage,
wherein the other of the two electrodes other than said control electrode of said first transistor is connected to one of two electrodes other than a control electrode of a second transistor,
wherein the other of the two electrodes other than the control electrode of the second transistor is connected to an output wiring of said sensor signal,
wherein said read-out signal wiring is connected to the control electrode of said second transistor, and
wherein the other end of said capacitance is connected to a wiring that supplies a constant voltage.

9. The display device according to claim 1,
wherein said light sensor includes:
a light-receiving element;
a capacitance that charges and discharges an output current from said light-receiving element;
a switching circuit connected between one end of said light-receiving element and one end of said capacitance;
a reset signal wiring that is connected to the other end of said light-receiving element and that supplies a reset signal; and
a read-out signal wiring that supplies a read-out signal to said light sensor,
wherein said switching circuit includes a first transistor, a second transistor, and a third transistor,
wherein a control electrode of said first transistor is connected between one end of said light-receiving element and one end of said capacitance,
wherein one of two electrodes other than said control electrode of said first transistor is connected to a wiring that supplies a constant voltage,
wherein the other of the two electrodes other than said control electrode of said first transistor is connected to one of two electrodes other than a control electrode of a second transistor,
wherein the other of the two electrodes other than the control electrode of the second transistor is connected to an output wiring of said sensor signal,
wherein the other end of said capacitance is connected to a wiring that supplies a constant voltage,
wherein said read-out signal wiring is connected to the control electrode of said second transistor,
wherein said reset signal wiring is connected to a control electrode of said third transistor,
wherein one of two electrodes other than the control electrode of the third transistor is connected to one end of said light-receiving element,
wherein the other of the two electrodes other than the control electrode of said third transistor is connected to a wiring that supplies a reference voltage, and
wherein said driving signal generating circuit adjusts the potential of said reference voltage of said third transistor.

10. The display device according to claim 1, wherein said light sensor includes:
a light-receiving element;
a capacitance that charges and discharges an output current from said light-receiving element;
a switching circuit connected between one end of said light-receiving element and one end of said capacitance;
a reset signal wiring that is connected to the other end of said light-receiving element and that supplies a reset signal; and
a read-out signal wiring that supplies a read-out signal to said light sensor,
wherein said switching circuit includes a first transistor and a second transistor,
wherein a control electrode of said first transistor is connected between one end of said light-receiving element and one end of said capacitance,
wherein one of two electrodes other than said control electrode of said first transistor is connected to a wiring that supplies a constant voltage,
wherein the other of the two electrodes other than said control electrode of said first transistor is connected to an output wiring of said sensor signal,
wherein the other end of said capacitance is connected to said read-out signal wiring,
wherein said reset signal wiring is connected to a control electrode of said second transistor,
wherein one of two electrodes other than said control electrode of said second transistor is connected to one end of said light-receiving element,
wherein the other of the two electrodes other than said control electrode of said second transistor is connected to a wiring that supplies a reference voltage, and
wherein said driving signal generating circuit adjusts at least either a high-level potential or a low-level potential of said read-out signal.

11. The display device according to claim 1, wherein said light sensor includes:
a light-receiving element;
a capacitance that charges and discharges an output current from said light-receiving element;
a switching circuit connected between one end of said light-receiving element and one end of said capacitance;
a reset signal wiring that is connected to the other end of said light-receiving element and that supplies a reset signal; and
a read-out signal wiring that supplies a read-out signal to said light sensor,
wherein said switching circuit includes a first transistor and a second transistor,
wherein a control electrode of said first transistor is connected between one end of said light-receiving element and one end of said capacitance,
wherein one of two electrodes other than said control electrode of said first transistor is connected to a wiring that supplies a constant voltage,
wherein the other of the two electrodes other than the control electrode of the first transistor is connected to an output wiring of said sensor signal,
wherein the other end of said capacitance is connected to said read-out signal wiring,
wherein said reset signal wiring is connected to a control electrode of said second transistor,
wherein one of two electrodes other than the control electrode of said second transistor is connected to one end of said light-receiving element,
wherein the other of the two electrodes other than the control electrode of said second transistor is connected to a wiring that supplies a reference voltage, and
wherein said driving signal generating circuit adjusts the potential of said reference voltage.

12. The display device according to claim 1, wherein the light source ON period in said first correction data acquisition mode is shorter than the light source ON period in said sensor driving mode.

13. The display device according to claim 12, wherein said light source ON start timing in a frame period in said first correction data acquisition mode is the same as the timing in said sensor driving mode.

14. The display device according to claim 13, wherein a period from the start of said accumulation period to the end of said light source ON period in said first correction data acquisition mode is shorter than a period from the start of said accumulation period to the end of said light source ON period in said sensor driving mode.

15. The display device according to claim 14, wherein a period from the end of said accumulation period to the end of said light source ON period in said first correction data acquisition mode is equal to a period from the end of said accumulation period to the end of said light source ON period in said sensor driving mode.

16. The display device according to claim 1, wherein said light source ON period in said second correction data acquisition mode is longer than said light source ON period in said first correction data acquisition mode.

17. The display device according to claim 16, wherein start and end timings of said light source ON period in a frame period in said second correction data acquisition mode is equal to start and end timings of said light source ON period in a frame period in said sensor driving mode.

18. The display device according to claim 1, wherein when:
a light sensor signal level obtained from said second sensor pixel circuit in said sensor driving mode is noted as B;
a light sensor signal level obtained from said first sensor pixel circuit in said first correction data acquisition mode is noted as B₁ₛₜ; and
a light sensor signal level obtained from said second sensor pixel circuit in said second correction data acquisition mode is noted as B_{2nd},
said signal-processing circuit derives a corrected light sensor signal level R′ from a light sensor signal level R obtained from said first sensor pixel circuit in said sensor driving mode as follows:
R′=(R−B₁ₛₜ)−(B−B_{2nd}).

19. The display device according to claim 1, wherein when:
a light sensor signal level obtained from said second sensor pixel circuit in said sensor driving mode is noted as B;
a light sensor signal level obtained from said first sensor pixel circuit in said first correction data acquisition mode is noted as B₁ₛₜ; and
a light sensor signal level obtained from said second sensor pixel circuit in said second correction data acquisition mode is noted as B_{2nd};
a gain correction light sensor signal level W₁ₛₜ is obtained by said sensor driver circuit supplying a read-out signal with zero amplitude in said first correction data acquisition mode;
a gain correction light sensor signal level W_{2nd} is obtained by said sensor driver circuit supplying a read-out signal with zero amplitude in said second correction data acquisition mode; and
the number of gradations of a light sensor signal is noted as L,
said signal-processing circuit derives a corrected light sensor signal level R′ from a light sensor signal level R obtained from said first sensor pixel circuit in said sensor driving mode as follows:
R′=L×{R/(W₁ₛₜ−B₁ₛₜ)−B/(W_{2nd}−B_{2nd})}.

20. The display device according to claim 1, wherein when:
a light sensor signal level obtained from said second sensor pixel circuit in said sensor driving mode is noted as B;
a light sensor signal level obtained from said first sensor pixel circuit in said first correction data acquisition mode is noted as B₁ₛₜ;
a light sensor signal level obtained from said second sensor pixel circuit in said second correction data acquisition mode is noted B_{2nd};
a gain correction light sensor signal level W₁ₛₜ is obtained by said sensor driver circuit supplying a read-out signal with zero amplitude in said first correction data acquisition mode;
a gain correction light sensor signal level W_{2nd} is obtained by said sensor driver circuit supplying a read-out signal with zero amplitude in said second correction data acquisition mode; and
the number of gradations of a light sensor signal is noted as L,
said signal-processing circuit derives a corrected light sensor signal level R′ from a light sensor signal level R obtained from said first sensor pixel circuit in said sensor driving mode as follows:
R′=L×{(R−B₁ₛₜ)/(W₁ₛₜ−B₁ₛₜ)−(B−B_{2nd})/(W_{2nd}−B_{2nd})}.

21. The display device according to claim 1, wherein said first and second sensor pixel circuits include:
one light-receiving element;
one accumulation node that accumulates electrical charge in accordance with a detected light amount;
a read-out transistor having a control terminal electrically connectable to said accumulation node; and
a holding switching element that is disposed on a path of a current that flows through said light-receiving element and that turns ON/OFF in accordance with said control signal.

22. The display device according to claim 21, wherein said first and second sensor pixel circuits is configured such that:
said holding switching element is disposed between said accumulation node and one end of said light-receiving element, and
the other end of said light-receiving element is connected to a reset line.

23. The display device according to claim 1,
wherein said first and second sensor pixel circuits share one light-receiving element, and
wherein one end of said light-receiving element is connected to one end of the holding switching element included in said first and second sensor pixel circuits and the other end is connected to said reset line.

24. The display device according to claim 1, further comprising:
an opposite substrate facing said active matrix substrate; and
liquid crystals held between said active matrix substrate and said opposite substrate.
